(19) United States
(12) Patent Application Publication
(10) Pub. No.: US 2026/0109231 A1
(43) Pub. Date: Apr. 23, 2026

(54) COMPACT LIFT DEVICE

(71) Applicant: Oshkosh Corporation, Oshkosh, WI (US)

(72) Inventors: Steve Aulton, Oshkosh, WI (US); Davide Boroni, Oshkosh, WI (US); Phillip Godding, Oshkosh, WI (US); Barrie Lindsay, Oshkosh, WI (US); Nicola Sacchet, Oshkosh, WI (US); Simon Thompson, Oshkosh, WI (US)

(73) Assignee: Oshkosh Corporation, Oshkosh, WI (US)

(21) Appl. No.: 19/365,021

(22) Filed: Oct. 21, 2025

Related U.S. Application Data
(60) Provisional application No. 63/787,512, filed on Apr. 11, 2025.
(60) Provisional application No. 63/787,540, filed on Apr. 11, 2025.
(60) Provisional application No. 63/787,577, filed on Apr. 11, 2025.
(60) Provisional application No. 63/787,555, filed on Apr. 11, 2025.
(60) Provisional application No. 63/787,558, filed on Apr. 11, 2025.

(30) Foreign Application Priority Data
Oct. 22, 2024 (IT) 102024000023553

(51) Int. Cl. B60L 1/00; B60L 50/53; B60L 53/16; B66F 11/04

(52) U.S. Cl. CPC B60L 1/003; B60L 50/53; B60L 53/16; B66F 11/044; B60L 2200/40

(57) ABSTRACT

A lift device includes a chassis defining a first side, a second side, and a central area between the first and second sides. The lift includes a turntable and a lift apparatus to raise and lower a platform. The first side area may include at least one of: an electric motor; a hydraulic pump; a hydraulic reservoir; an auxiliary motor; an auxiliary hydraulic pump; or a low-voltage battery. The second side area may include at least one of: a first charging port and a first charger configured to receive power at a first voltage range; a second charging port and a second charger configured to receive power at a second voltage range, a third charging port to provide power directly to a component of the lift device; a filter; or a breaker. The central area may include at least one of: a high-voltage battery, a hydraulic valve, or an inverter.

### CROSS-REFERENCE TO RELATED PATENT APPLICATIONS

This application claims the benefit and priority of (i) Italian Patent Application 102024000023553, filed Oct. 22, 2024, (ii) U.S. Provisional Application No. 63/787,512, filed Apr. 11, 2025, (iii) U.S. Provisional Application No. 63/787,555, filed Apr. 11, 2025, (iv) U.S. Provisional Application No. 63/787,577, filed Apr. 11, 2025, (v) U.S. Provisional Application No. 63/787,558, filed Apr. 11, 2025, and (vi) U.S. Provisional Application No. 63/787,540, filed Apr. 11, 2025.

### BACKGROUND

The present disclosure relates to lift devices. More specifically, the present disclosure relates to boom lifts.

### SUMMARY

According to one embodiment, a vehicle includes a chassis defining a first side area, a second side area, and a central area between the first side area and the second side area; a turntable supported by the chassis and configured to rotate relative to the chassis; a lift apparatus supported by the turntable and configured to raise and lower a platform; wherein the first side area includes: an electric motor coupled to the chassis; one or more hydraulic pumps, wherein the one or more hydraulic pumps are configured to be driven by the electric motor; and a hydraulic reservoir fluidly coupled to the one or more hydraulic pumps; wherein the second side area includes; a first charging port coupled to a first charger configured to receive power at a first voltage range; a second charging port configured to provide power to at least one of the platform or the electric motor; wherein the central area includes: a high-voltage battery, wherein the high-voltage battery is configured to provide power to the electric motor.

According to another embodiment, a vehicle includes a base including a center frame member defining a central area; a right side pod coupled to a right side of the center frame member; and a left side pod coupled to a left side of the center frame member; a plurality of tractive elements coupled to the base; a turntable supported by the base and configured to rotate relative to the base; and a lift apparatus supported by the turntable and configured to raise and lower a platform; wherein the right side pod includes: a first motor; a first hydraulic pump, wherein the first hydraulic pump is configured to be driven by the first motor; and a hydraulic reservoir fluidly coupled to the first hydraulic pump; an second motor; and a second hydraulic pump, wherein the second hydraulic pump is configured to be driven by the second motor; wherein the left side pod includes; a first charging port coupled to a first charger configured to receive power at a first voltage range; a second charging port coupled to a second charger configured to receive power at a second voltage range different than the first voltage range; a second charging port configured to provide power to at least one of the platform, the first motor, or the second motor; wherein the central area includes: a plurality of hydraulic valves coupled to at least one of the first hydraulic pump or the second hydraulic pump.

According to another embodiment, a vehicle includes a chassis defining a first side area, a second side area, and a central area between the first side area and the second side area, wherein the chassis further includes: a first aperture connecting the first side area to the central area; and a second aperture connecting the second side area to the central area; a turntable supported by the chassis and configured to rotate relative to the chassis; a lift apparatus supported by the turntable and configured to raise and lower a platform, wherein the lift apparatus includes: a tower boom coupled to the turntable; a boom arm coupled to the tower boom and the platform; and a plurality of actuators configured to adjust a positioned of at least one of the tower boom or the boom arm; wherein the first side area includes: an electric motor coupled to the chassis; one or more hydraulic pumps, wherein the one or more hydraulic pumps are configured to be driven by the electric motor; a hydraulic reservoir fluidly coupled to the one or more hydraulic pumps; an auxiliary motor coupled to the chassis; an auxiliary hydraulic pump, wherein the auxiliary hydraulic pump is configured to be driven by the auxiliary motor; and a low-voltage battery, wherein the low-voltage battery is configured to power the auxiliary motor; wherein the second side area includes; a first charging part coupled to a first charger configured to receive power at a first voltage range; a second charging port coupled to a second charger configured to receive power at a second voltage range, wherein the first voltage range is different than the second voltage range; a third charging port configured to provide power via the second aperture to at least one of the platform, the electric motor, or the auxiliary motor; a filter coupled between at least one of the first charging port and the first charger or the second charging port and the second charger; and a plurality of breakers configured to trip at a predetermined threshold; wherein the central area includes: a high-voltage battery, wherein the high-voltage battery is configured to provide power via the first aperture to the electric motor; a plurality of hydraulic valves coupled to at least one of the one or more hydraulic pumps or the auxiliary pumps through the first aperture; and one or more inverters electrically coupled to the batteries.

According to another embodiment, a vehicle includes a frame; and a boom assembly coupled to the frame, the boom assembly including a first upright; a second upright; a first lift arm having a first end portion pivotably coupled to the frame and a second end portion pivotably coupled to the first upright; a second lift arm having a first end portion pivotably coupled to the frame and a second end portion pivotably coupled to the first upright; a third lift arm having a first end portion pivotably coupled to the first upright and a second end portion pivotably coupled to the second upright; a fourth lift arm having a first end portion pivotably coupled to the first upright and a second end portion pivotably coupled to the second upright; and a linear actuator coupled to the frame and the first lift arm and configured to extend to raise the first upright relative to the frame.

According to another embodiment, a vehicle includes a frame; and a boom assembly coupled to the frame, the boom assembly including an upright; a first lift arm having a first end portion pivotably coupled to the frame and a second end portion pivotably coupled to the upright; a second lift arm pivotably coupled to the upright and extending away from the upright; a timing link pivotably coupled to the first lift arm and the second lift arm; and an actuator configured to raise the first lift arm relative to the frame, wherein the timing link is configured to cause rotation of the second lift arm relative to the upright in response to the actuator raising the first lift arm.

According to another embodiment, a vehicle includes a frame; and a boom assembly coupled to the frame, the boom assembly including a first upright; a second upright; a first lift arm having a first end portion pivotably coupled to the frame and a second end portion pivotably coupled to the first upright, the first lift arm including a pair of plates and a first tubular member extending between the plates, wherein the first tubular member has a first height; a second lift arm having a first end portion pivotably coupled to the frame and a second end portion pivotably coupled to the first upright, the second lift arm including a second tubular member having a second height less than the first height; a third lift arm having a first end portion pivotably coupled to the first upright and a second end portion pivotably coupled to the second upright, the third lift arm including a third tubular member having a third height, wherein the first height and the third height are substantially equal; a fourth lift arm having a first end portion pivotably coupled to the first upright and a second end portion pivotably coupled to the second upright, the fourth lift arm including a fourth tubular member having a fourth height, wherein the second height and the fourth height are substantially equal; a linear actuator coupled to the frame and the first lift arm and configured to extend to raise the first upright relative to the frame, wherein the plates of the first lift arm pivotably couple the linear actuator to the tubular member, and wherein an end portion the linear actuator extends between the plates; and a timing link pivotably coupled to the first lift arm and the third lift arm and configured to cause rotation of the third lift arm relative to the first upright in response to the linear actuator raising the first upright.

According to another embodiment, a vehicle includes a chassis; a platform assembly configured to support a load; and a lift assembly configured to move the platform assembly relative to the chassis, the lift assembly including a tower boom including a plurality of support arms and a plurality of actuators configured to drive the plurality of support arms; a jib assembly coupled to the platform assembly and configured to support the platform assembly; and a telescoping boom assembly including a base boom coupled to the tower boom; a fly boom slidably coupled to the base boom, the fly boom extending at least partially into an inner volume of the base boom; and one or more doubling plates positioned within an internal volume of the fly boom, such that the fly boom is receivable by the base boom within the inner volume of the base boom.

According to another embodiment, a fly boom of a vehicle including; a top component fixedly coupled to a bottom component, the top component and the bottom component extending from a proximal end of the fly boom to a distal end of the fly boom; a first opening at the proximal end of the fly boom providing access to an internal volume of the fly boom; a second opening near the distal end of the fly boom providing access to the internal volume of the fly boom; a neutral axis extending along the fly boom from the proximal end of the fly boom to the distal end of the fly boom, the neutral axis positioned at a vertical midpoint of the fly boom; and a pair of doubling plates fixedly coupled to an internal surface of the top component along the neutral axis, each of the doubling plates including a first actuator aperture configured to receive a first fastener to pivotably couple an extension actuator to the doubling plate; and a second actuator aperture configured to receive a second fastener to pivotably couple a jib actuator to the doubling plate.

According to another embodiment, a method of operating a telescoping boom assembly, including providing a base boom with an inner volume; providing a fly boom with an internal volume; slidably receiving the fly boom within the inner volume of the base boom; receiving an extension actuator within the inner volume of the base boom and the internal volume of the fly boom; receiving a jib actuator within the internal volume of the fly boom; extending the extension actuator outwards from the inner volume of the base boom, thereby extending the fly boom outwards from the base boom; and extending the jib actuator outwards from the internal volume of the fly boom, thereby adjusting an angle of a jib assembly.

According to another embodiment, a substructure for a platform assembly of a vehicle includes a load cell brace configured to couple to a load cell of the vehicle; a plurality of longitudinal members coupled to the load cell brace; one or more tapered support beams coupled to the load cell brace and one or more of the plurality of longitudinal members; and a controls support structure cantilevered upwards from one or more of the plurality of longitudinal members, the controls support structure configured to support a control system of the platform assembly.

According to another embodiment, a vehicle includes a lift assembly; a platform assembly coupled to the lift assembly and including a substructure, the substructure including one or more lateral members; a plurality of longitudinal members coupled to the one or more lateral members; one or more tapered support beams coupled to the one or more lateral members and the plurality of longitudinal members; and a controls support structure cantilevered upwards from one or more of the plurality of longitudinal members; and a load cell positioned between the lift assembly and the platform assembly, the load cell coupled to the substructure.

According to another embodiment, a lift device includes a chassis; a turntable supported by the chassis and configured to rotate relative to the chassis; a lift assembly coupled to the turntable, wherein the lift assembly including a first end coupled to the turntable a second end couple to a platform via a load sensing mount, wherein the load sensing mount including: a first bracket coupled to the lift assembly; a load cell bracket coupled to the first bracket; a load cell coupled to the first bracket, wherein the load cell is positioned at least partially within the load cell bracket; and a load cell brace coupled to both the load cell bracket and the load cell, wherein the load cell brace is further coupled to the platform, wherein, in normal operation, a weight of the platform is transferred to the lift assembly entirely through the load cell.

According to another embodiment, a vehicle includes a chassis; a turntable coupled to the chassis, wherein the turntable is configured to rotate relative to the chassis; a lift assembly; and a platform assembly removably coupled to the lift assembly, the platform assembly including a plurality of rails forming a perimeter around the platform assembly; a substructure coupled to the lift assembly via a load cell, wherein the substructure is configured to support a user interface of the vehicle and including a first subset of rails of the plurality of rails to form at least a portion of the perimeter; and a platform removably coupled to the substructure, wherein the platform including a second subset of rails of the plurality of rails, the first subset of rails and the second subset of rails together forming the plurality of rails around the perimeter of the platform assembly.

According to another embodiment, a method of manufacturing a vehicle includes providing a lift assembly; providing a platform assembly including a user interface; one or more electrical components; one or more hydraulic components; and a platform configured to be removable from the platform assembly and separated from the user interface, the one or more electrical components, and the one or more hydraulic components; and coupling the platform assembly to the lift assembly.

According to another embodiment, a platform assembly includes a deck configured to be removably coupled to a substructure of a vehicle; a plurality of rails coupled to the deck and extending around a perimeter of the deck, an upper railing coupled to each of the plurality of rails and extending around a portion of the perimeter of the deck; a lower railing coupled to each of the plurality of rails and extending around a portion of the perimeter of the deck; a first interface coupled a first end of each of the upper railing and the lower railing; and a second interface coupled to a second end of each of the upper railing and the lower railing, each the first interface and the second interface configured to be removably coupled to a substructure including at least one of a user interface, one or more electronic components, and one or more hydraulic components.

### BRIEF DESCRIPTION OF THE DRAWINGS

FIG. 1 is a perspective view of a lift device, according to some embodiments.

FIG. 2 is a side view of the lift device of FIG. 1, according to some embodiments.

FIG. 3 is a side view of the lift device of FIG. 1, according to some embodiments.

FIG. 4 is a perspective view of a portion of a base assembly of the lift device of FIG. 1, according to an exemplary embodiment.

FIG. 5 is a perspective view of a platform assembly of the lift device of FIG. 1, according to some embodiments.

FIG. 6 is a block diagram of the lift device of FIG. 1, according to some embodiments.

FIG. 7 is a top perspective view of the chassis of the lift device of FIG. 1, according to some embodiments.

FIG. 8 is a top perspective view of a first side area of a base assembly of the lift device of FIG. 1, according to some embodiments.

FIG. 9 is a top perspective view of a second side area of the base assembly of the lift device of FIG. 1, according to some embodiments.

FIG. 10 a bottom perspective view of a central area of the base assembly of the lift device of FIG. 1, according to some embodiments.

FIG. 11 is a top perspective view of the central area of the base assembly of the lift device of FIG. 1, according to some embodiments.

FIG. 12 is a top perspective view of the central area of the base assembly of the lift device of FIG. 1, according to some embodiments.

FIG. 13 is a rear perspective view of the lift device of FIG. 1, according to some embodiments.

FIG. 14 is a left side view of the lift device of FIG. 1, according to some embodiments.

FIG. 15 is a top left side view of the lift device of FIG. 1 with a hood in an open position, according to some embodiments.

FIG. 16 is a top perspective view of a turntable of the lift device of FIG. 1, according to some embodiments.

FIG. 17 is a left perspective view of the turntable of the lift device of FIG. 1, according to some embodiments.

FIG. 18 is a perspective view of the lift device of FIG. 1, according to some embodiments.

FIG. 19 is a side view of a tower boom of the lift device of FIG. 1, according to some embodiments.

FIG. 20 is a side view of the lift device of FIG. 1 with the tower boom of FIG. 19 in a raised configuration and a lowered configuration, according to some embodiments.

FIG. 21 is a front perspective view of the tower boom of FIG. 19, according to some embodiments.

FIG. 22 is a rear perspective view of the tower boom of FIG. 19, according to some embodiments.

FIG. 23 is a side view of the tower boom of FIG. 19, according to some embodiments.

FIG. 24 is a side view of the tower boom of FIG. 19, according to some embodiments.

FIG. 25 is a perspective view of a first lift arm of the tower boom of FIG. 19, according to some embodiments.

FIG. 26 is a perspective view of a second lift arm of the tower boom of FIG. 19, according to some embodiments.

FIG. 27 is a perspective view of a third lift arm of the tower boom of FIG. 19, according to some embodiments.

FIG. 28 is a section view of various lift arms of the tower boom of FIG. 19, according to some embodiments.

FIG. 29 is a top view a partial assembly of the second lift arm of FIG. 26, according to some embodiments.

FIGS. 30, 31, and 32 are perspective views of a fly boom of the lift device of FIG. 1, according to some embodiments.

FIG. 33 is a front section view of the fly boom of FIG. 30, according to some embodiments.

FIGS. 34 and 35 are side views of the lift device of FIG. 1 including the fly boom of FIG. 30, according to some embodiments.

FIGS. 36 and 37 are perspective views of the lift device of FIG. 1 including the fly boom of FIG. 30, according to some embodiments.

FIG. 38 is a perspective view of the platform assembly of FIG. 5 and a portion of a lift assembly of the lift device of FIG. 1, according to some embodiments.

FIG. 39 is a perspective view of a substructure of the platform assembly of FIG. 38, according to some embodiments.

FIG. 40 is a perspective view of the substructure of the platform assembly of FIG. 38, according to some embodiments.

FIG. 41 is a side view of the platform assembly of FIG. 5 coupled to the lift device of FIG. 1, according to some embodiments.

FIG. 42 is a perspective view of the platform assembly of FIG. 5 coupled to the lift device of FIG. 1, according to some embodiments.

FIG. 43 is a perspective view of the platform assembly of FIG. 5 coupled to the lift device of FIG. 1, according to some embodiments.

FIG. 44 is an exploded view of a portion of the lift device of FIG. 1 including a compact platform mount, according to some embodiments.

FIG. 45 is a perspective view of a load cell mount for coupling the platform assembly to the lift device of FIG. 1, according to some embodiments.

FIG. 46 is a perspective view of the platform assembly of FIG. 5 coupled to the lift device of FIG. 1, according to some embodiments.

FIG. 47 is a perspective view of the platform assembly of FIG. 5 and a portion of a lift assembly of the lift device of FIG. 1, according to some embodiments.

FIG. 48 is a perspective view of a substructure of the platform assembly of FIG. 47, according to some embodiments.

FIG. 49 is a perspective view of a platform of the platform assembly of FIG. 47, according to some embodiments.

FIG. 50 is a perspective view of the substructure of FIG. 48 and a portion of a lift assembly of the lift device of FIG. 1, according to some embodiments.

FIG. 51 perspective view of the substructure of FIG. 48 coupled to the lift device, according to some embodiments.

FIG. 52 is a rear perspective view of the substructure of FIG. 48 coupled to the lift device, according to some embodiments.

FIG. 53 is a rear perspective view of the vehicle of FIG. 1, according to some embodiments.

FIG. 54 is a bottom perspective view of a portion of the vehicle of FIG. 1, according to some embodiments.

### DETAILED DESCRIPTION

Before turning to the FIGURES, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the FIGURES, a lift device such as a boom lift includes a base assembly dividing the boom lift into a first side area, a second side area, and a central area between the first side area and the second side area. The first side area includes hydraulic components including an electric motor, one or more hydraulic pumps, a hydraulic reservoir, an auxiliary electric motor, and an auxiliary hydraulic pump, amongst other components. The second side area includes electric components including one or more charging ports, a first charger, a second charger, a current filter, a cutoff switch, and one or more breakers, amongst other components. The central area includes a plurality of hydraulic valves, one or more inverters for supplying power to the traction system, and a high-voltage battery, amongst other components.

### Lift Device

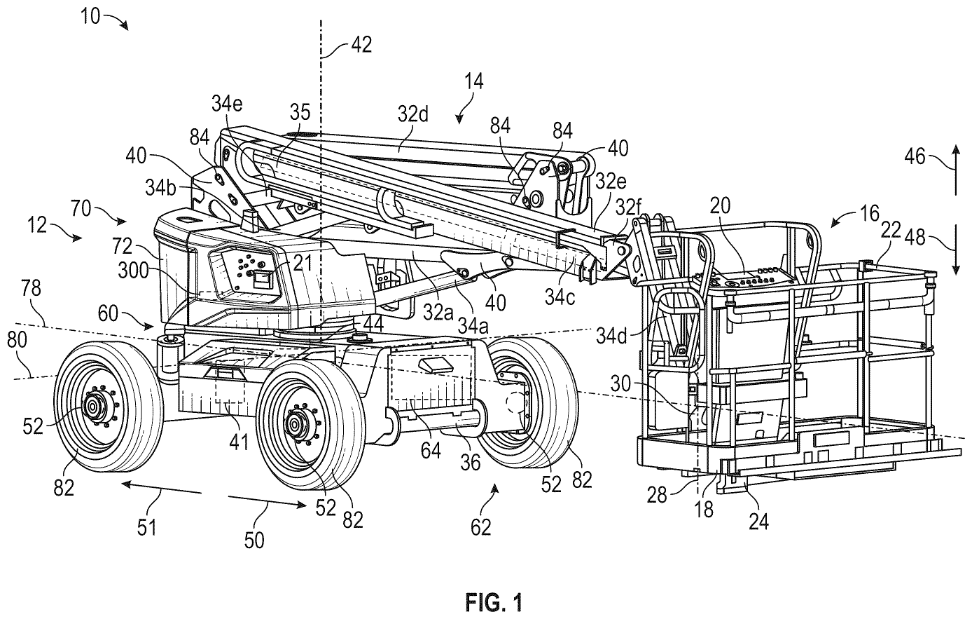

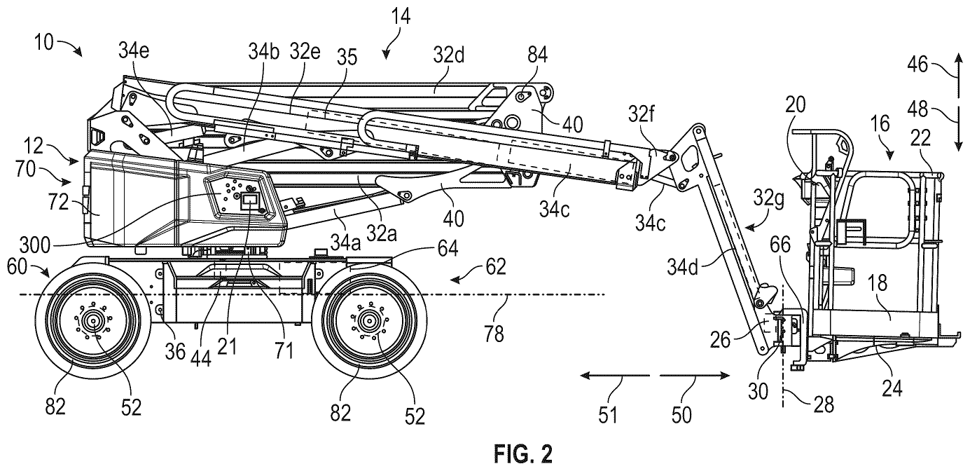

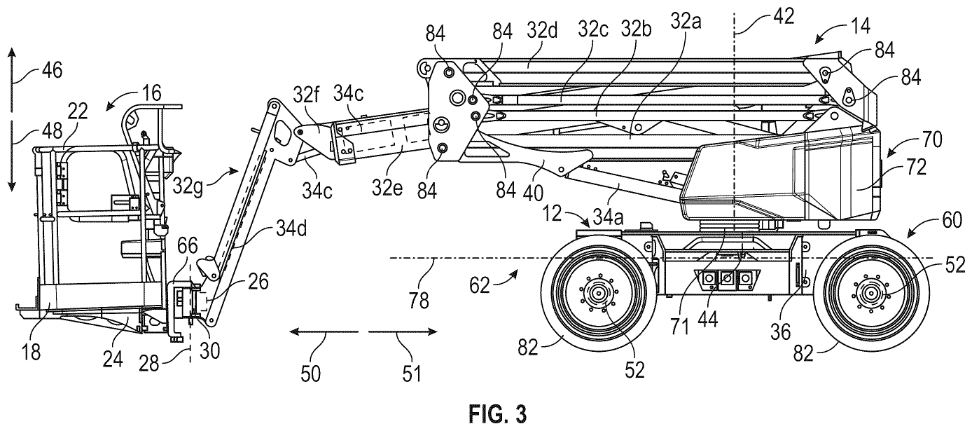

Referring to FIGS. 1-3, a work machine, a lifting apparatus, a lift device, or a mobile elevating work platform (MEWP) (e.g., a telehandler, an electric boom lift, a towable boom lift, a lift device, a fully electric boom lift, a scissor lift, a compact crawler boom, etc.) is shown as lift device 10 according to an exemplary embodiments. In other embodiments, the lift device 10 is another type of vehicle or work machine, such as a military vehicle, a cement truck, a refuse vehicle, a fire apparatus (e.g., a fire truck including a deployable ladder, an aircraft rescue and firefighting truck, etc.), a tow truck, or another type of vehicle or work machine.

The lift device 10 includes a base assembly 12 (e.g., a base, a support assembly, a drivable support assembly, a support structure, a chassis, etc.), a platform assembly 16 (e.g., a platform, a terrace, etc.), and a lift assembly 14 (e.g., a boom, a boom lift assembly, a lifting apparatus, an articulated arm, a scissors lift, etc.). The lift device 10 includes a front end (e.g., a forward facing end, a front portion, a front, etc.), shown as front 62, and a rear end (e.g., a rearward facing end, a back portion, a back, a rear, etc. ,) shown as rear 60. The lift assembly 14 is configured to elevate the platform assembly 16 in an upward direction 46 (e.g., an upward vertical direction) relative to the base assembly 12. The lift assembly 14 is also configured to translate the platform assembly 16 in a downward direction 48 (e.g., a downward vertical direction). The lift assembly 14 is also configured to translate the platform assembly 16 in either a forward direction 50 (e.g., a forward longitudinal direction) or a rearward direction 51 (e.g., a rearward longitudinal direction). The lift assembly 14 generally facilitates performing a lifting function to raise and lower the platform assembly 16, as well as movement of the platform assembly 16 in various directions.

The base assembly 12 defines a longitudinal axis 78 and a lateral axis 80. The longitudinal axis 78 defines the forward direction 50 of lift device 10 and the rearward direction 51. The lift device 10 is configured to translate in the forward direction 50 and to translate backwards in the rearward direction 51. The base assembly 12 includes one or more wheels, tires, wheel assemblies, tractive elements, rotary elements, treads, etc., shown as tractive elements 82. The tractive elements 82 are configured to rotate to drive (e.g., propel, translate, steer, move, etc.) the lift device 10. The tractive elements 82 can each include an electric motor 52 (e.g., electric wheel motors) configured to drive the tractive elements 82 (e.g., to rotate tractive elements 82 to facilitate motion of the lift device 10). In other embodiments, the tractive elements 82 are configured to receive power (e.g., rotational mechanical energy) from electric motors 52 or through a drive train (e.g., a combination of any number and configuration of a shaft, an axle, a gear reduction, a gear train, a transmission, etc.). In some embodiments, one or more tractive elements 82 are driven by a prime mover 41 (e.g., electric motor, internal combustion engine, etc.) through a transmission. In some embodiments, a hydraulic system (e.g., one or more pumps, hydraulic motors, conduits, valves, etc.) transfers power (e.g., mechanical energy) from one or more electric motors 52 and/or the prime mover 41 to the tractive elements 82, the lift assembly 14, or the platform assembly 16. The tractive elements 82 and electric motors 52 (or prime mover 41) can facilitate a driving and/or steering function of the lift device 10. In some embodiments, the electric motors 52 are optional, and the tractive elements 82 are powered or driven by an internal combustion engine.

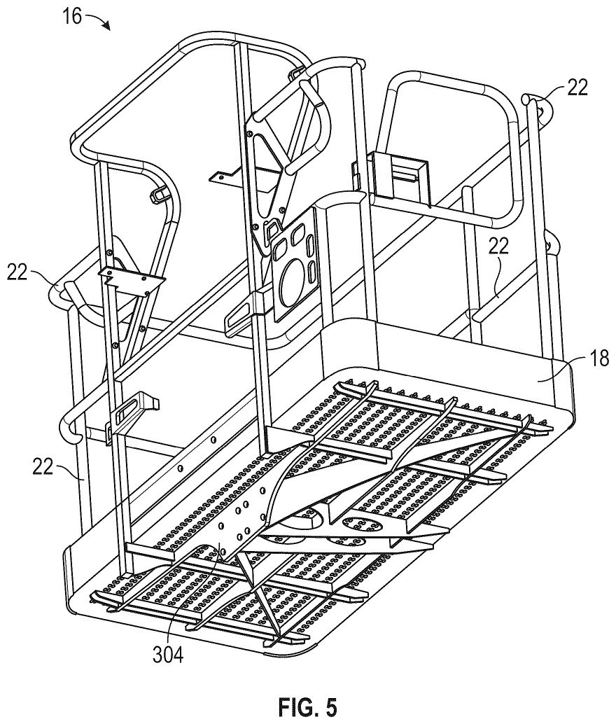

With additional reference to FIG. 5, the platform assembly 16 is shown in further detail. The platform assembly 16 is configured to provide a work area for an operator of the lift device 10 to stand/rest upon. The platform assembly 16 can be pivotally coupled to an upper end of the lift assembly 14 via a platform mount 66. The lift device 10 is configured to facilitate the operator accessing various elevated areas (e.g., lights, platforms, the sides of buildings, building scaffolding, trees, power lines, etc.). The lift device 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the base assembly 12, or to a ground surface that the base assembly 12 rests upon). In some embodiments, the lift device 10 uses internal combustion engines, hydraulics, a hydraulic system, pneumatic cylinders, etc.

The platform assembly 16 includes a base member, a base portion, a platform, a standing surface, a shelf, a work platform, a floor, a deck, etc., shown as a deck 18. The deck 18 provides a space (e.g., a floor surface) for a worker to stand upon as the platform assembly 16 is raised and lowered.

The platform assembly 16 includes a railing assembly including various members, beams, bars, guard rails, rails, railings, etc., shown as rails 22. The rails 22 extend along substantially an entire perimeter of the deck 18. The rails 22 provide one or more members for the operator of the lift device 10 to grasp while using the lift device 10 (e.g., to grasp while operating the lift device 10 to elevate the platform assembly 16). The rails 22 can include members that are substantially horizontal to the deck 18. The rails 22 can also include vertical structural members that couple with the substantially horizontal members. The vertical structural members can extend upwards from the deck 18.

The platform assembly 16 can include a human machine interface (HMI) (e.g., a user interface, an operator interface, etc.), shown as the user interface 20. The user interface 20 is configured to receive user inputs from the operator at or upon the platform assembly 16 to facilitate operation of the lift device 10. The user interface 20 can include any number of buttons, levers, switches, keys, etc., or any other user input device configured to receive a user input to operate the lift device 10. The user interface 20 may also provide information to the user (e.g., through one or more displays, lights, speakers, haptic feedback devices, etc.). The user interface 20 can be supported by one or more of the rails 22.

Referring to FIGS. 1-3 and 5, the platform assembly 16 includes a frame 24 (e.g., structural members, support beams, a body, a structure, etc.) that extends at least partially below the deck 18. The frame 24 can be integrally formed with the deck 18. The frame 24 is configured to provide structural support for the deck 18 of the platform assembly 16. The frame 24 can include any number of structural members (e.g., beams, bars, I-beams, etc.) to support the deck 18. The frame 24 couples the platform assembly 16 with the lift assembly 14. The frame 24 may be rotatably or pivotally coupled with the lift assembly 14 via the platform mount 66 to facilitate rotation of the platform assembly 16 about an axis 28 (e.g., a vertical axis). The frame 24 can also rotatably/pivotally couple with the lift assembly 14 such that the frame 24 and the platform assembly 16 can pivot about an axis 28.

The lift assembly 14 includes one or more beams, articulated arms, bars, booms, arms, support members, boom sections, links, cantilever beams, etc., shown as lift arms 32a, 32b, 32c, 32d, 32e, 32f, and 32g. The lift arms are hingedly (e.g., pivotably) or rotatably coupled with other lift arms at their ends. The lift arms can be hingedly or rotatably coupled to facilitate articulation of the lift assembly 14 and raising/lowering and/or horizontal movement of the platform assembly 16. The lift device 10 includes a lower lift arm 32a, a lower middle lift arm 32b, an upper middle lift arm 32c, an upper lift arm 32d, and a boom lift arm 32e. The lower lift arm 32a and lower middle lift arm 32b are configured to hingedly or rotatably couple at one end with the base assembly 12 to facilitate lifting (e.g., elevation) of the platform assembly 16. The lower lift arm 32a is constrained to have a fixed range of motion relative to the lower middle lift arm 32b, such that each position of the lower lift arm 32a has a corresponding position of the lower middle lift arm 32b. The lower lift arm 32a and lower middle lift arm 32b are configured to hingedly or rotatably couple at an opposite end with the upper middle lift arm 32c and the upper lift arm 32d. Likewise, the upper middle lift arm 32c and the upper lift arm 32d are configured to hingedly or rotatably couple with the boom lift arm 32e. The boom lift arm 32e is slidably coupled with an intermediate lift arm 32f, such that the intermediate lift arm 32f telescopes relative to the boom lift arm 32e. The intermediate lift arm 32f may extend into an inner volume of the boom lift arm 32e and extend and/or retract. The intermediate lift arm 32f is configured to hingedly or rotatably couple with a series of lift arms that form a jib assembly 32g. The jib assembly 32g can be configured to couple (e.g., rotatably, hingedly, etc.), with the platform assembly 16 to facilitate levelling of the platform assembly 16. The jib assembly 32g may form a four-bar linkage. The jib assembly 32g may facilitate raising and lowering the platform assembly 16 relative to the boom lift arm 32e. The jib assembly 32g can be referred to as “the jib” of the lift device 10. Together, the boom lift arm 32e and the intermediate lift arm 32f can be referred to as a “telescoping boom” of the lift device 10. The intermediate lift arm 32f can be referred to as the “fly boom” of the telescoping boom. The boom lift arm 32e can be referred to as the “base boom” of the telescoping boom. The lower lift arm 32a, lower middle lift arm 32b, upper middle lift arm 32c, and upper lift arm 32d can be referred to as “the tower boom” of the overall lift device 10 assembly.

The lift arms 32 are driven to hinge or rotate relative to each other by actuators 34a, 34b, 34c, and 34d (e.g., electric linear actuators, linear electric arm actuators, hydraulic cylinders, etc.). The actuators 34 may be hydraulic actuators, electric actuators, pneumatic actuators, etc. The actuators 34a, 34b, 34c, and 34d can be mounted between adjacent lift arms to drive adjacent lift arms to hinge or pivot (e.g., rotate some angular amount) or telescope (e.g., extend and retract) relative to each other about pivot points 84 or between lift arms 32 and the turntable member 72 or the platform assembly 16 to hinge or pivot relative to the other component. The actuators 34a, 34b, 34c, and 34d can be mounted using any of a foot bracket, a flange bracket, a clevis bracket, a trunnion bracket, etc. The actuators 34a, 34b, 34c, and 34d may be configured to extend or retract (e.g., increase in overall length, or decrease in overall length) to facilitate pivoting adjacent lift arms to pivot/hinge relative to each other, thereby articulating the lift arms and raising or lowering the platform assembly 16.

The actuators 34a, 34b, 34c, and 34d can be configured to extend (e.g., increase in length) to increase a value of an angle formed between adjacent lift arms 32. The angle can be defined between centerlines of adjacent lift arms 32 (e.g., centerlines that extend substantially through a center of the lift arms 32). For example, the actuator 34a is configured to extend/retract to increase/decrease the angle defined between the lower lift arm 32a and the longitudinal axis 78 and facilitate lifting/lowering of the platform assembly 16 (e.g., moving the platform assembly 16 at least partially along the upward direction 46 or the downward direction 48). The lower middle lift arm 32b moves with the lower lift arm 32a. Extension of the actuator 34a also causes the upper lift arm 32d to rotate and increase the angle between the upper lift arm 32d and the lower lift arm 32a and the angle between the upper lift arm 32d and a horizontal plane. The upper middle lift arm 32c moves with the upper lift arm 32d. Likewise, the actuator 34b can be configured to extend or retract to adjust the angle between the boom lift arm 32e and the tower boom lift arms (e.g., lower lift arm 32a, lower middle lift arm 32b, upper middle lift arm 32c, and upper lift arm 32d) and the angle between the boom lift arm 32e and a horizontal plane.

The actuator 34c can be configured to extend or retract to adjust the angle of the jib assembly 32g relative to the intermediate lift arm 32f, and to thereby adjust the plane of the deck 18 relative to gravity to level the platform assembly 16 (e.g., moving the platform assembly 16 at least partially along the downward direction 48). A level control actuator or level feedback actuator, shown as cylinder 34e, is coupled to the tower boom and the boom lift arm 32e. The cylinder 34e may be fluidly coupled to the actuator 34c. As the boom lift arm 32e is raised and lowered, the cylinder 34e may be extended to draw fluid into the cylinder 34e and compressed to expel fluid from the cylinder 34e, respectively. By fluidly coupling the cylinder 34e to the actuator 34c, fluid may automatically pass between the cylinder 34e and the actuator 34c to control operation of the actuator 34c. Accordingly, the cylinder 34e may automatically control the actuator 34c to adjust the orientation of the platform assembly 16 to compensate for rotation of the boom lift arm 32e.

The actuator 34d is configured to extend or retract to facilitate elevating of the platform assembly 16. Specifically, the actuator 34d may expand and retract to expand and collapse the jib assembly 32g. Accordingly, the actuator 34d may control the jib assembly 32g to raise or lower the platform assembly 16.

The actuator 34a, 34b, 34c, and 34d can be mounted (e.g., rotatably coupled, pivotally coupled, etc.) to adjacent lift arms at mounts 40 (e.g., mounting members, mounting portions, attachment members, attachment portions, etc.). The mounts 40 can be positioned at any position along a length of each lift arm. For example, the mounts 40 can be positioned at a midpoint of each lift arm, and a lower end of each lift arm.

The jib assembly 32g and the platform mount 66 are configured to pivotally interface/couple at a platform rotator 30 (e.g., a rotary actuator, a rotational electric actuator, a gear box, etc.). The platform rotator 30 facilitates rotation of the platform assembly 16 about the axis 28 relative to the jib assembly 32g (e.g., rotate about axis 28 in either a clockwise or a counter-clockwise direction). The platform rotator 30 may be a hydraulic motor (e.g., a rotary electric actuator, a stepper motor, a platform rotator, a platform electric motor, an electric platform rotator motor, etc.). The platform rotator 30 can be configured to drive the platform mount 66, which is coupled to the frame 24 to pivot about the axis 28 relative to the jib assembly 32g (or relative to the intermediate lift arm 32f). The platform rotator 30 can be configured to drive a gear train to pivot the platform assembly 16 about the axis 28. The axis 28 extends through a central pivot point of the platform rotator 30. The jib assembly 32g can also be configured to articulate or bend such that a distal portion of the jib assembly 32g pivots/rotates about the horizontal axis. The jib assembly 32g can be driven to rotate/pivot about the horizontal axis by extension and retraction of the actuator 34d.

The intermediate lift arm 32f is also configured to extend/retract (e.g., telescope) along the boom lift arm 32e. In some embodiments, the lift assembly 14 includes a linear actuator (e.g., a hydraulic cylinder, an electric linear actuator, etc.), shown as extension actuator 35, that controls extension and retraction of the intermediate lift arm 32f relative to the boom lift arm 32e. In other embodiments, one more of the other arms of the lift assembly 14 include multiple telescoping sections that are configured to extend/retract relative to one another.

Referring to FIGS. 1-3, the lift assembly 14 is configured to pivotally or rotatably couple with the base assembly 12. The base assembly 12 includes a rotatable base member, a rotatable platform member, a fully electric turntable, etc., shown as a turntable 70. The lift assembly 14 is configured to rotatably/pivotally couple with the base assembly 12. The turntable 70 is rotatably coupled with a base, frame, structural support member, carriage, etc., of base assembly 12, shown as base 36. The turntable 70 is configured to rotate or pivot relative to the base 36. The turntable 70 can pivot/rotate about the central axis 42 relative to base 36, about a slew bearing 71 (e.g., the slew bearing 71 pivotally couples the turntable 70 to the base 36). The turntable 70 facilitates accessing various elevated and angularly offset locations at the platform assembly 16. The turntable 70 is configured to be driven to rotate or pivot relative to base 36 and about the slew bearing 71 by an electric motor, an electric turntable motor, an electric rotary actuator, a hydraulic motor, etc., shown as the turntable motor 44. The turntable motor 44 can be configured to drive a geared outer surface of the slew bearing 71 that is rotatably coupled to the base 36 about the slew bearing 71 to rotate the turntable 70 relative to the base 36. The lower lift arm 32a is pivotally coupled with the turntable 70 (or with a turntable member 72 of the turntable 70) such that the lift assembly 14 and the platform assembly 16 rotate as the turntable 70 rotates about the central axis 42. In some embodiments, the turntable 70 is configured to rotate a complete 360 degrees about the central axis 42 relative to the base 36. In other embodiments, the turntable 70 is configured to rotate an angular amount less than 360 degrees about the central axis 42 relative to the base 36 (e.g., 270 degrees, 120 degrees, etc.).

The base assembly 12 includes one or more energy storage devices or power sources (e.g., capacitors, batteries, Lithium-Ion batteries, Nickel Cadmium batteries, fuel tanks, etc.), shown as batteries 64. The batteries 64 are configured to store energy in a form (e.g., in the form of chemical energy) that can be converted into electrical energy for the various electric motors and actuators of the lift device 10. The batteries 64 can be stored within the base 36. The lift device 10 includes a controller 300 that is configured to operate any of the motors, actuators, etc., of the lift device 10. The controller 300 can be configured to receive sensory input information from various sensors of the lift device 10, user inputs from the user interface 20 (or any other user input device such as a key-start or a push-button start), etc. The controller 300 can be configured to generate control signals for the various motors, actuators, etc., of the lift device 10 to operate any of the motors, actuators, electrically powered movers, etc., of the lift device 10. The batteries 64 are configured to power any of the motors, sensors, actuators, electric linear actuators, electrical devices, electrical movers, stepper motors, etc., of the lift device 10. The base assembly 12 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the lift device 10.

The batteries 64 are configured to deliver power to the motors 52 to drive the tractive elements 82. A rear set of tractive elements 82 can be configured to pivot to steer the lift device 10. In other embodiments, a front set of tractive elements 82 are configured to pivot to steer the lift device 10. In still other embodiments, both the front and the rear set of tractive elements 82 are configured to pivot (e.g., independently) to steer the lift device 10. In some examples, the base assembly 12 includes a steering system 94. The steering system 94 is configured to drive tractive elements 82 to pivot for a turn of the lift device 10. The steering system 94 can be configured to pivot the tractive elements 82 in pairs (e.g., to pivot a front pair of tractive elements 82), or can be configured to pivot tractive elements 82 independently (e.g., four-wheel steering for tight-turns).

It should be understood that while the lift device 10 as described herein is described with reference to batteries, electric motors, etc., the lift device 10 can be powered (e.g., for transportation and/or lifting the platform assembly 16) using one or more internal combustion engines, electric motors or actuators, hydraulic motors or actuators, pneumatic actuators, or any combination thereof.

In some embodiments, the base assembly 12 also includes a user interface 21 (e.g., a HMI, a user interface, a user input device, a display screen, etc.). In some embodiments, the user interface 21 is coupled to the base 36. In other embodiments, the user interface 21 is positioned on the turntable 70. The user interface 21 can be positioned on any side or surface of the base assembly 12 (e.g., on the front 62 of the base 36, on the rear 60 of the base 36, etc.).

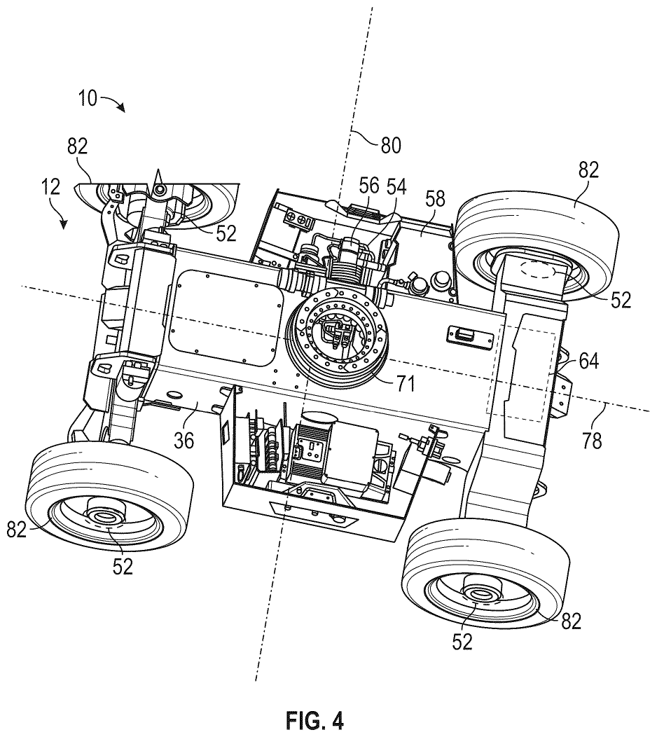

Referring now to FIG. 4, the base assembly 12 includes a hydraulic system including a motor 54. Motor 54 may be an electric motor. The motor 54 drives the hydraulic pump 56. The hydraulic pump 56 provides hydraulic fluid from the hydraulic reservoir 58 to one or more hydraulic actuators of the lift device 10 (e.g., actuators 34). The motor 54 may be configured to draw its power from the batteries 64.

### Overall Vehicle

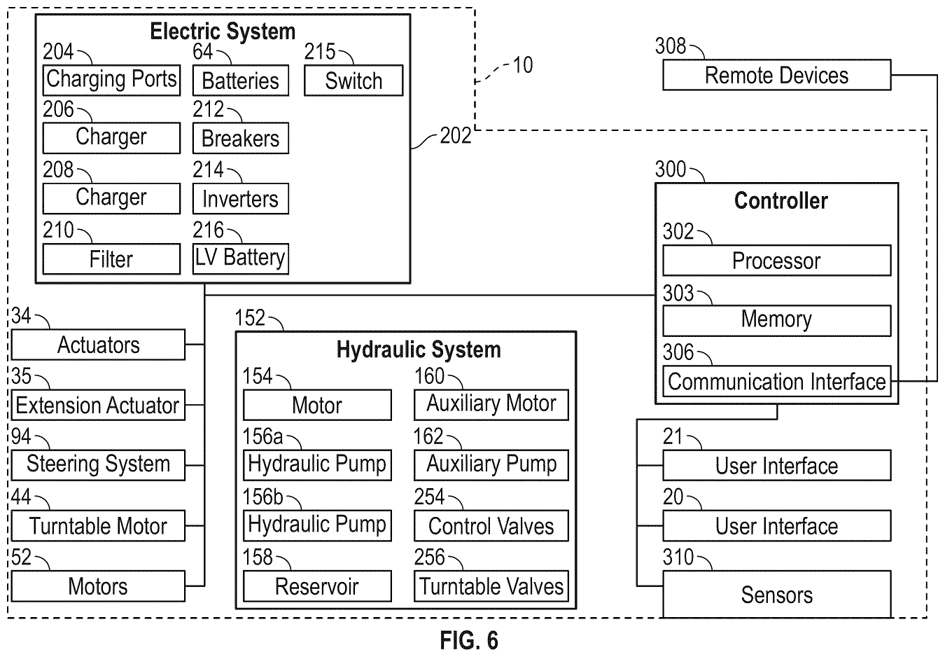

As Referring now to FIG. 6, the lift device 10 includes a control system configured to control the operation of the lift device 10. The control system includes the controller 300 including a processors 302 and a memory 303. The processor 302 may issue commands to and process information from other components. The processor 302 may be implemented as a specific purpose processor, an application specific integrated circuit (ASIC), one or more field programmable gate arrays (FPGAs), a group of processing components, or other suitable electronic processing components. The memory 303 may include one or more devices (e.g., RAM, ROM, flash memory, hard disk storage) for storing data and computer code for completing and facilitating the various user or client processes, layers, and modules described in the present disclosure. The memory 303 may be or include volatile memory or non-volatile memory and may include database components, object code components, script components, or any other type of information structure for supporting the various activities and information structures of the inventive concepts disclosed herein. The memory 303 may be communicably connected to the processor 302 and include computer code or instruction modules for executing one or more processes described herein.

As shown in FIG. 1, the controller 300 is coupled to the base assembly 12. As shown, the controller 300 is positioned within the turntable 70 of the base assembly 12. In some embodiments, the lift device 10 includes a single controller 300. In other embodiments, the lift device 10 includes multiple controllers 300. Any functions described as being performed by the controller 300 may be distributed across multiple controllers 300 and/or one or more devices outside of the lift device 10 (e.g., the remote devices 308). By way of example, one or more components of the lift device 10 (e.g., the motors 52, extension actuator 35, etc.) may include dedicated controllers 300 in communication with a primary controller 300.

Referring again to FIG. 5, the controller 300 further includes an interface (e.g., a network interface, a wireless connection, a wired connection, etc.), shown as communication interface 306. The communication interface 306 may facilitate communication between the controller 300 and one or more devices outside of the lift device 10, shown as remote devices 308. The communication interface 306 may facilitate communication over a wired connection and/or a wireless connection (e.g., a cellular connection, an Internet connection, a Bluetooth® connection, a Wi-Fi® connection, etc.). The remote devices 308 may include user devices (e.g., smartphones, tablets, laptop computers, desktop computers, wearable devices, etc.). The remote devices 308 may include servers (e.g., onsite or remote servers). The remote devices 308 may include other vehicles (e.g., another lift device 10) or other jobsite equipment.

As shown in FIG. 5, the controller 300 is operatively coupled to other components of the lift device 10 and the remote devices 308. The controller 300 may control operation of one or more components of the lift device 10 and/or the remote devices 308. By way of example, the controller 300 may (e.g., directly or indirectly, through the application of one or more control signals, etc.) control the operation of the user interface 21, the actuators 34, the extension actuator 35, the steering system 94, the turntable motor 44, the motors 52, all or part of the hydraulic system 152, and all or part of the electric system 202.

The controller 300 may receive information from various sources, and the controller 300 may vary operation of the lift device 10 based on the received information. The controller 300 may receive information (e.g., commands) from the user interface 20 or 21 in response to a user interaction. The controller 300 may receive information from the remote devices 308.

In some embodiments, the lift device 10 includes one or more sensors or transducers, shown as sensors 310, that provide information to the controller 300. By way of example, the sensors 310 may include temperature sensors, load cells, pressure sensors, inertial measurement units, gyroscopes, accelerometers, potentiometers, encoders, and/or other types of sensors.

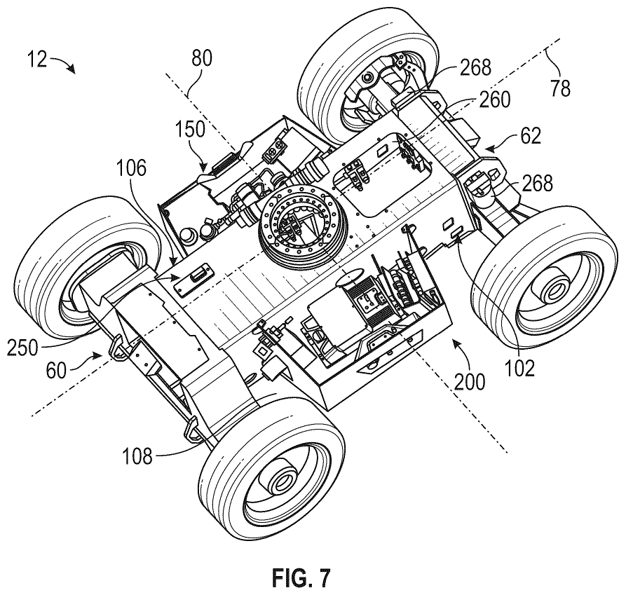

Referring now to FIG. 7, the base 36 of the base assembly 12 is divided into a series of volumes, areas, or sections by a center frame member 102. The center frame member 102 includes a top 104, a right side 106, a left side 108, and a bottom 110. The center frame member 102 is longitudinally bisected by the longitudinal axis 78 and laterally bisected by the lateral axis 80. A first volume, section or area, shown as right side area 150, extends laterally away from the right side 106 of the center frame member 102. A second volume, section, or area, shown as left side area 200, extends laterally away from the left side 108 of the center frame member 102. A third volume, section, or area, shown as the central area 250 extends in the lateral direction between the right side 106 and the left side 108 of the center frame member 102.

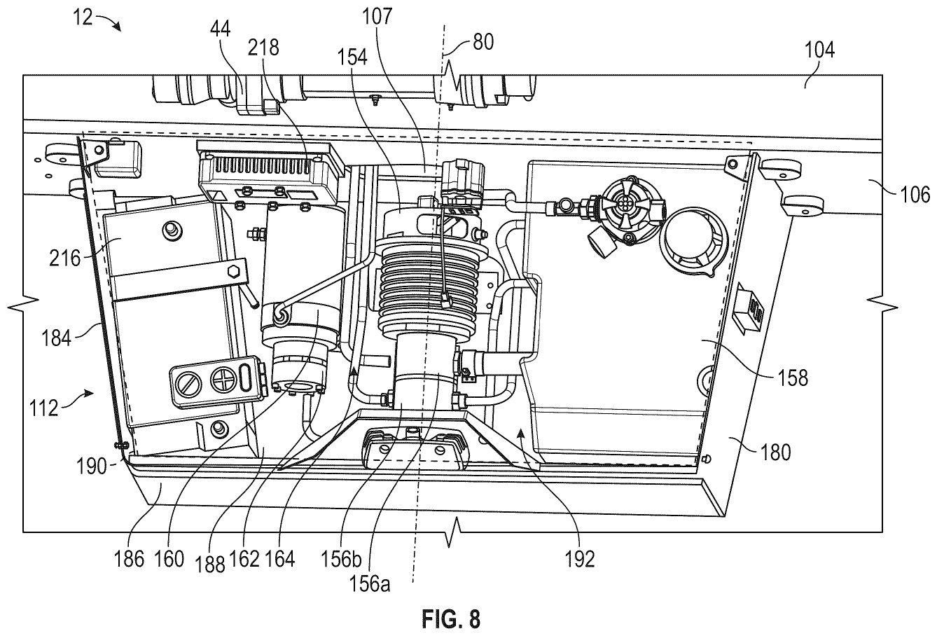

Referring now to FIG. 8, the right side area 150 is shown, according to an exemplary embodiment. The right side area 150 is defined by a right side pod 180. The right side pod 180 includes a front wall 182 extending laterally from the right side 106 between the lateral axis 80 and the front 62 of the lift device 10 and a rear wall 184 extending laterally from the right side 106 between the lateral axis 80 and the rear 60 of the lift device 10. Coupling the front wall 182 and the rear wall 184 is a right side wall 186. Extending between the right side 106, the front wall 182, the rear wall 184, and the right side wall 186 is a bottom wall 188 and a top wall 190, which together define the right side pod 180. The top wall 190 is shown by the schematic representation only to allow for seeing inside the right side pod 180. In some embodiments, the top wall 190 is removably coupled to the rest of the right side pod 180 to allow a user access to the components within the right side pod 180.

The right side 106 and the walls of the right side pod 180 (e.g., front wall 182, rear wall 184, right side wall 186, bottom wall 188, and top wall 190) define a void, cavity, or volume shown as right side pod interior 192 to house one or more components of the lift device 10. Specifically, the right side pod interior 192 includes one or more components of the hydraulic system 152 of the lift device 10. The hydraulic system 152 includes motors, pumps, tanks, and conduits configured to power one or more hydraulic actuators of the lift device 10 such as the actuators 34 or the extension actuator 35.

Within the right side pod 180 is a motor 154 of the hydraulic system 152. The motor 154 may be a permanent magnet electric motor or another type of electric motor. The motor 154 is configured to drive a first hydraulic pump 156a and a second hydraulic pump 156b. The first hydraulic pump 156a and the second hydraulic pump 156b may each be a stage of a dual-stage hydraulic pump 156. The first hydraulic pump 156a and the second hydraulic pump 156b are fluidly coupled to a tank or reservoir shown as reservoir for holding hydraulic fluid. The first hydraulic pump 156a and second hydraulic pump 156b are configured to draw hydraulic fluid from the reservoir 158 and provide it as pressurized hydraulic fluid to one or more hydraulic actuators of the lift device 10 (e.g., actuators 34, extension actuator 35, steering system 94, etc.). For example, in the right side 106 there is a hole or aperture shown as aperture 107 to allow a plurality of hydraulic lines 164 to pass from the right side area 150 into the central area 250 and on to other areas and components of the lift device 10.

The right side pod 180 also includes an auxiliary hydraulic motor and pump arrangement, shown as auxiliary motor 160 and auxiliary hydraulic pump 162. The auxiliary hydraulic pump 162 is fluidly coupled to the reservoir 158 and is driven by the auxiliary motor 160 to provide pressurized hydraulic fluid to one or more hydraulic components of the lift device 10 as needed (e.g., actuators 34, extension actuator 35, steering system 94, etc.). In some embodiments, the motor 154 is a high-voltage electric motor while the auxiliary motor 160 is a low-voltage electric motor. In some embodiments, the motor 154 and the auxiliary motor 160 are the same type of motor. In some embodiments, the motor 154 and the auxiliary motor 160 operate simultaneously, while in other embodiments one the motor 154 and the auxiliary motor 160 operate at separate times.

Within the right side pod 180, the motor 154, the first hydraulic pump 156a, and the second hydraulic pump 156b are positioned substantially along the lateral axis 80. The motor 154 is positioned nearest right side 106 and the first hydraulic pump 156a and the second hydraulic pump 156b extend laterally from the motor 154 away from the longitudinal axis 78. Forward (e.g., towards the front 62 of the lift device 10) of the motor 154, the first hydraulic pump 156a, and the second hydraulic pump 156b is the reservoir 158. Rearward (e.g., towards the rear 60 of the lift device 10) of the motor 154, the first hydraulic pump 156a, and the second hydraulic pump 156b is the auxiliary motor 160 and the auxiliary hydraulic pump 162. The auxiliary motor 160 is positioned adjacent the right side 106 and between the right side 106 and the auxiliary pump 162.

While the right side pod 180 includes one or more components of the hydraulic system 152, it may also include one or more components of the electric system 202. For example, the LV battery 216 is shown positioned in the right side pod 180 adjacent the front wall 182 of the right side pod 180. An additional inverter 218 is coupled to the right side 106 and provides power to and/or converts the power from the LV battery 216 for use by one or more components of the lift device 10 or for charging the LV battery 216.

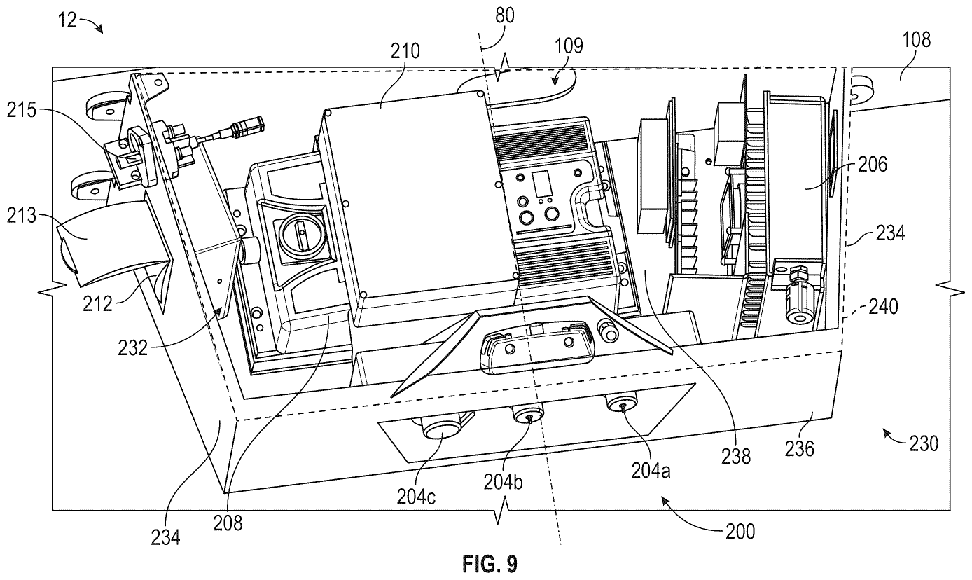

Referring now to FIG. 9, the left side area 200 is shown, according to exemplary embodiment. The left side area 200 is defined by a left side pod 230. The left side pod 230 includes a front wall 232 extending laterally from the left side 108 of the lift device 10 between the lateral axis 80 and the front 62 of the lift device 10 and a rear wall 234 extending laterally from the left side 108 between the lateral axis 80 and the rear 60 of the lift device 10. Coupling the front wall 232 and the rear wall 234 is a left side wall 236. Extending between the left side 108, front wall 232, rear wall 234, and the left side wall 236 is a bottom wall 238 and a top wall 240, which together define the left side pod 230. The top wall 240 is shown by a schematic representation only to wallow for seeing inside the left side pod 230. In some embodiments, the top wall 240 is removably coupled to the rest of the left side pod 230 to allow a user access to the components within the left side pod 230.

The left side 108 and the walls of the left side pod 230 (e.g., front wall 232, rear wall 234, left side wall 236, bottom wall 238, and top wall top wall 240) define a void, cavity, or volume shown as left side pod interior 242 to house one or more components of the lift device 10. Specifically, the left side pod interior 242 includes one or more components of the electric system 202 of the lift device 10. The electric system 202 includes charging ports, on-board chargers, inverters, and batteries, amongst other components, to drive and/or power one or more components of the lift device 10 (e.g., motor 154, auxiliary motor 160, motors 52, etc.).

Extending through the left side wall 236 are a set of charging ports 204, shown as charging port 204a, 204b, and 204c. Charging port 204a is electrically coupled to a charger, shown as 220V charger 206. The 220 charger 206 is configured to receive up to 220V AC power through the charging port 204a and provides the power as DC current to the batteries 64 and/or the LV battery 216. The charging port 204b is configured to provide power-to-platform, wherein direct power from a remote source can be provided directly to the platform assembly 16. The power across the charging port 204b may be 100-120V AC or 220-240V AC power for operating one or more components of the lift device 10 directly. The charging port 204c is electrically coupled to a second charger, shown as 380V charger 208. The 380V charger 208 may operate independent of the charger 206. In some embodiments, both the charger 206 and the charger 208 may operate in together to decrease the time it takes the charge the lift device 10. In some embodiments, the charger 206 receives power within a first voltage range, such as between 0 and 220 volts. In some embodiments, the charger 208 receives power within a second voltage range different than the first voltage range. For example, the second voltage range may be between 0 and 380 volts, or between 220 and 380 volts.

The charger 206 is positioned adjacent the rear wall 234 of the left side pod 230 behind the lateral axis 80. The charger 208 extends from adjacent the charger 206 towards the front wall 232. On top of the charger 208 is positioned a filter shown as filter 210. The filter 210 is configured to stabilize the power provided to the charger 208 via the charging port 204c. Extending through the front wall 232 are one or more breakers 212 of the electric system 202. The breakers 212 are positioned beneath a cover 213 rotatably coupled to the front wall 232 to allow user to access the breakers 212 from outside of the left side pod 230. The breakers 212 are coupled to one or more electric wires within the electric system 202 and are configured to trip or break at a threshold value (e.g., voltage level, current level, etc.) to protect one or more electronic components of the lift device 10. The breakers 212 may then be easily replaced by an operator via the cover 213. Also extending through the front wall 232 is a switch, shown as switch 215. Switch 215 may be configured to electrically couple one or more components of the lift device 10 such as the batteries 64 and the charger 206, charger 208, etc. In some embodiments, the switch 215 has a plurality of positions such as off, standby, and on. In some embodiments, the left side 108 has a hole or aperture, shown as aperture 109, to allow for electrical cables to pass from the left side area 200 to the central area 250 and therefrom to other parts of the lift device 10.

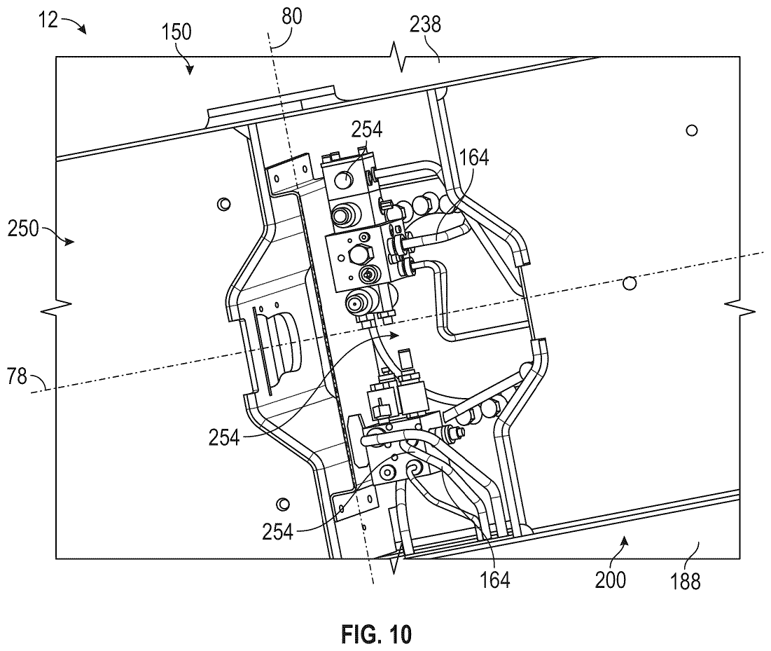

Referring now to FIG. 10, a bottom of the base assembly 12 is shown according to an exemplary embodiment. The bottom 110 of the center frame member 102 is shown extending from either side of a central cavity, shown as hydraulic valve locker 252. In some embodiments, the hydraulic valve locker 252 includes a bottom 253 to enclose the hydraulic valve locker 252 and protect the components within it during operation of the lift device 10. Hydraulic valve locker 252 is positioned within the central area 250, between the right side 106 and the left side 108 of the center frame member 102. Extending from the right side pod 180 in the right side area 150 are a plurality of hydraulic lines 164 which are fluidly coupled to a plurality of hydraulic control valves 254. The plurality of hydraulic control valves 254 selectively provide pressurized hydraulic fluid to one or more hydraulic components of the lift device 10 (e.g., actuators 34, extension actuator 35, steering system 94, etc. As shown in FIG. 10, the plurality of hydraulic lines 164, downstream of one or more of the plurality of hydraulic control valves 254 extend rearwards towards the rear 60 of the lift device 10. In some embodiments, the plurality of hydraulic lines 164 provide pressurized fluid to a steering actuator 95 of the steering system 94 to control the angle of the rear tractive elements 82.

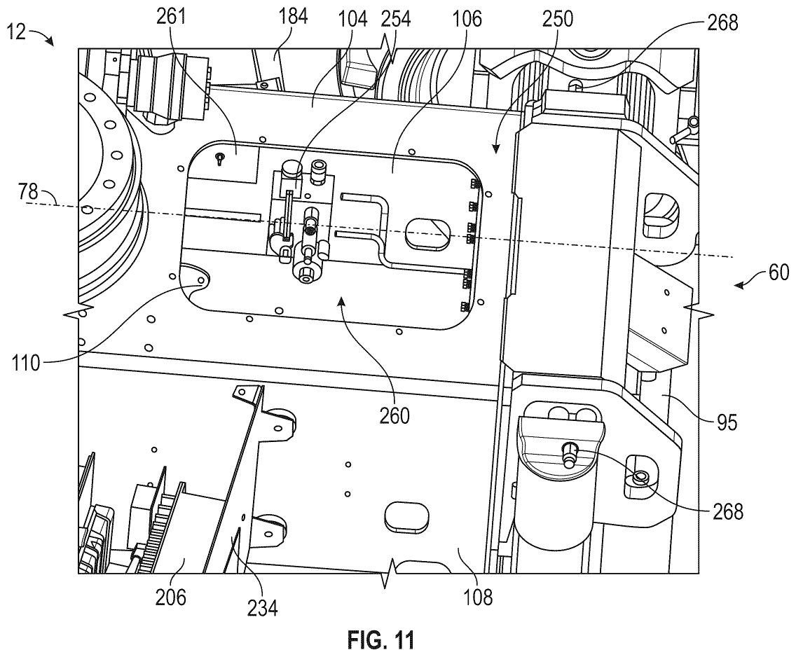

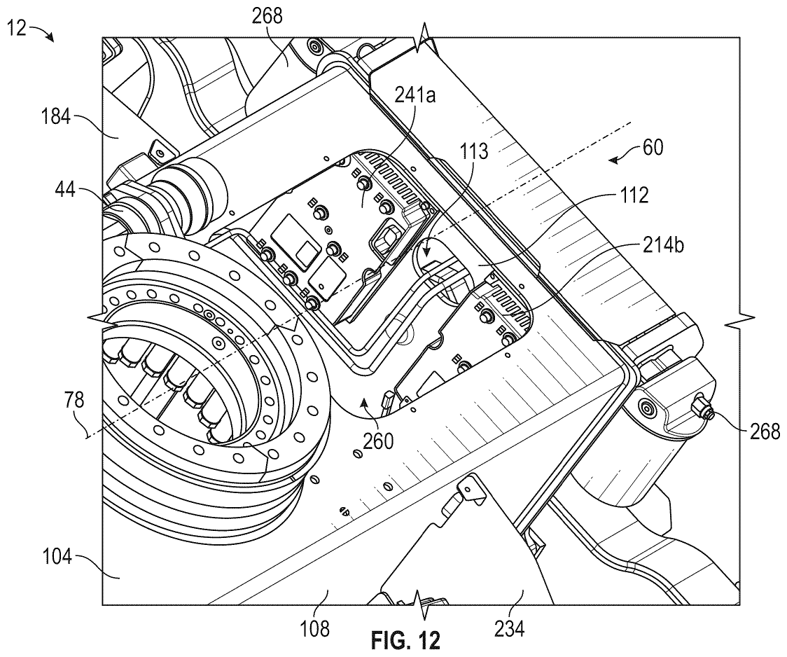

Referring now to FIGS. 11 and 12, a top perspective view of the base assembly 12 of the lift device 10 is shown, according to an exemplary embodiment. The center frame member 102 is shown with a section removed to reveal an internal cavity or void, shown as rear section 260. Within the rear section 260 is positioned one of the plurality of hydraulic control valves 254, which is coupled to the right side 106. In the rear section 260 may also be one or more electrical connections, shown as connections 261 coupled to the right side 106. In some embodiments, there may be additional connections 261 coupled to other parts of the center frame member 102 such as the bottom 110. Referring now specifically to FIG. 12, a rear of the rear section 260 is shown with a rear wall 112 of the center frame member 102 extending between the right side 106 and the left side 108. Coupled to the rear wall 112 are inverters 214 of the electric system 202, shown as a first inverter 214a and a second inverter 214b. The first inverter 214a and the second inverter 214b are positioned on either side of the longitudinal axis 78, and are each coupled, respectively, to an electric motor 268 of the traction system for driving and steering the lift device 10. In the rear wall 112 is also an hole or aperture, shown as aperture 113 to allow conduits such as electrical wiring and/or hydraulic fluid lines to pass from rear section 260 to the rear 60 of the lift device 10.

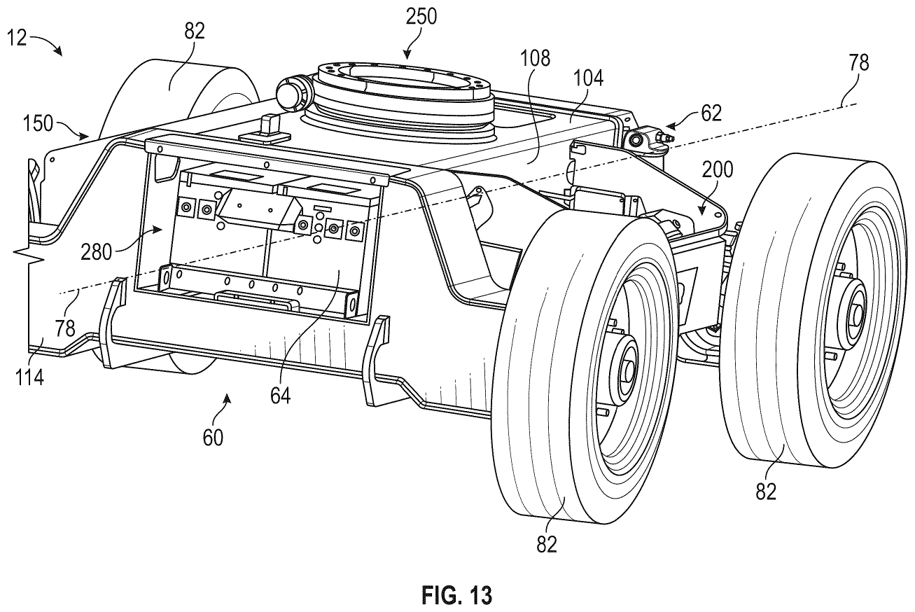

Referring now to FIG. 13, a front of the base assembly 12 of the lift device 10 is shown, according to exemplary embodiments. The center frame member 102 includes a front wall 114, shown with a section removed to reveal an internal void, or area, shown as front section 280. Within front section 280, supported by the bottom 100, are the batteries 64. The batteries 64 may be electrically coupled to the electric system 202 and the controller 300 amongst other components of the lift device 10.

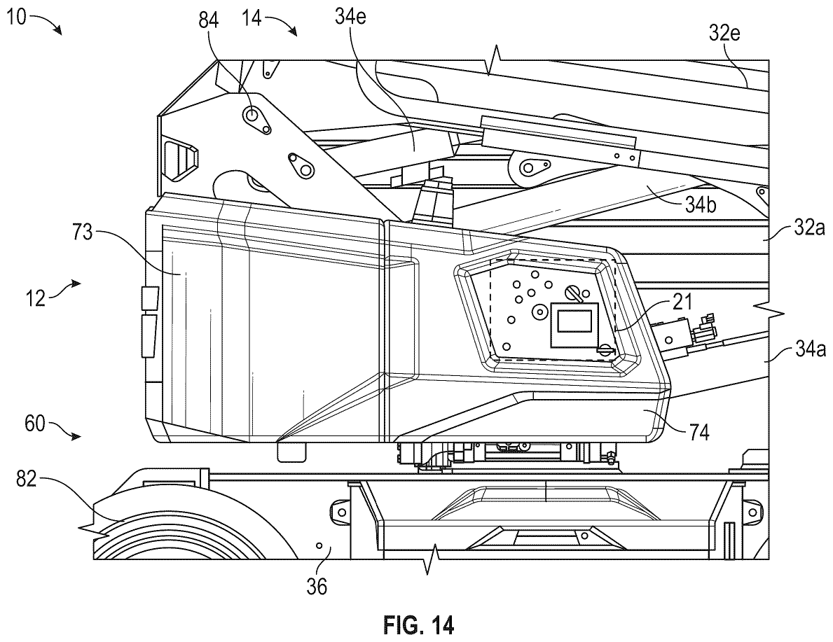

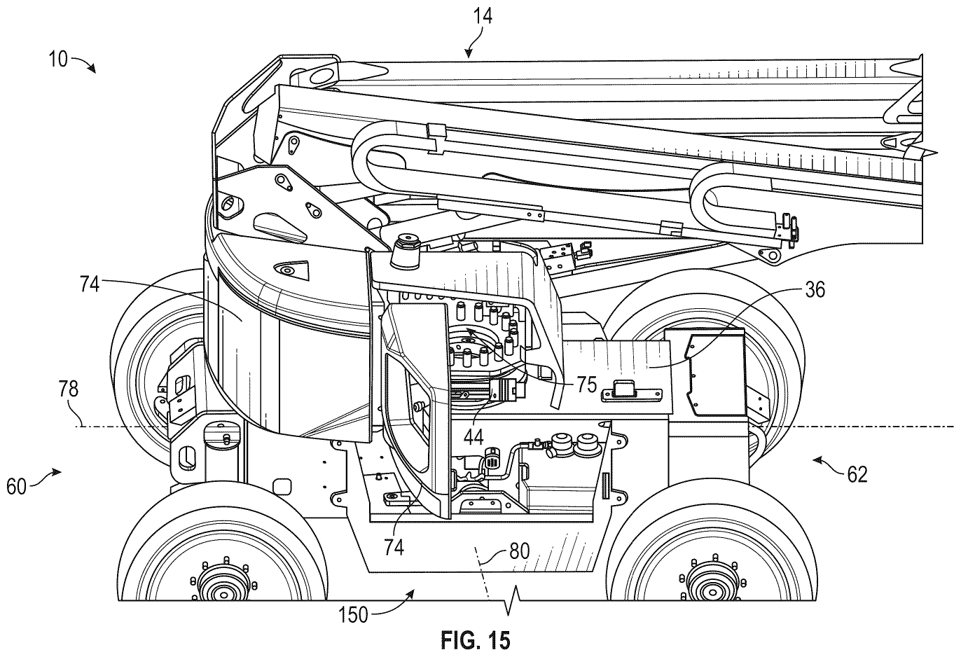

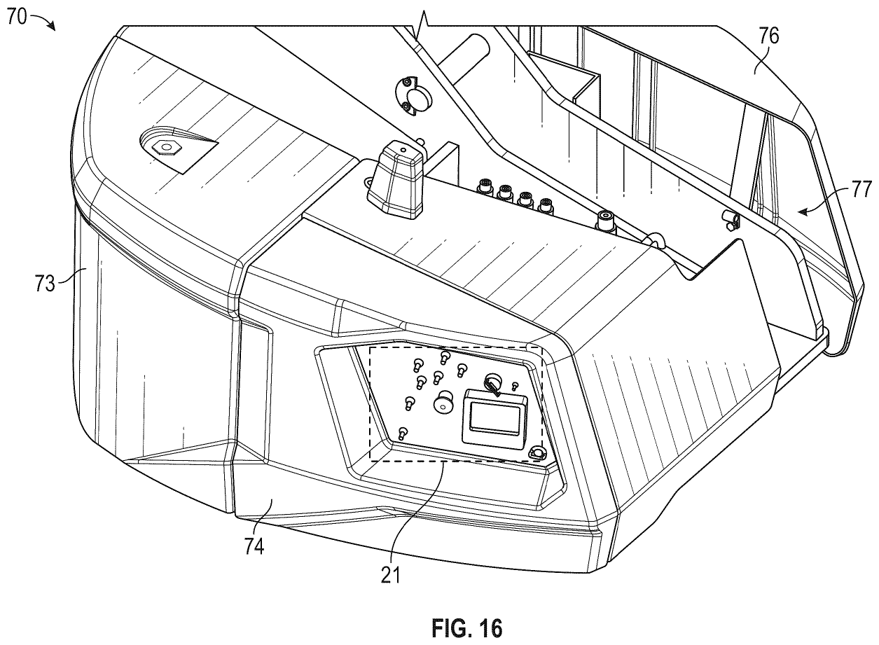

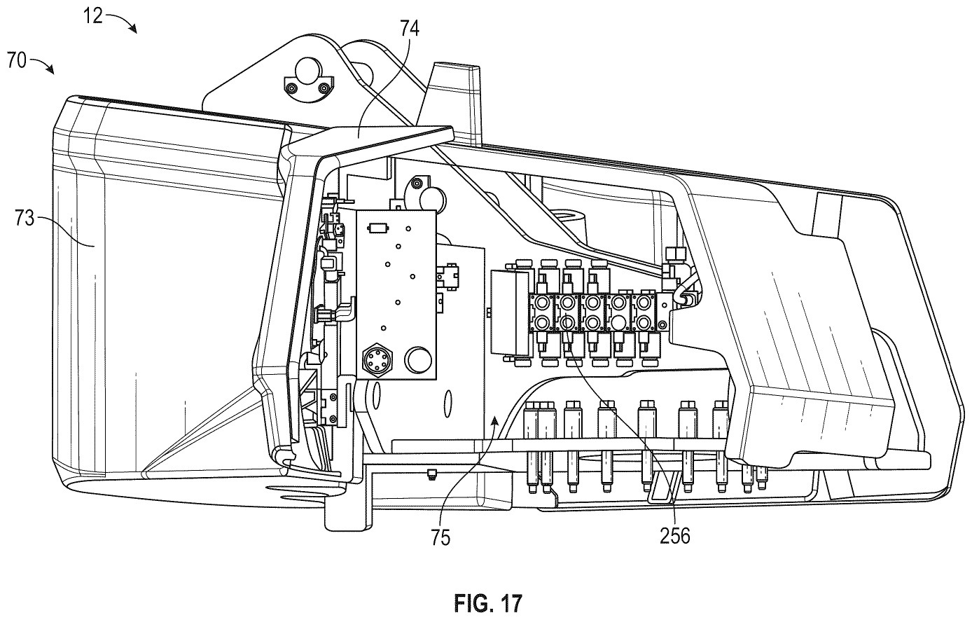

Referring now to FIGS. 14-17, the turntable 70 of the lift device 10 is shown. The turntable 70 includes a counterweight 73 on the same side of the turntable 70 as the pivot point 84 of the boom lift arm 32e, and acts to stabilize the turntable 70 of the lift device 10 as the boom lift arm 32e is extended. On the opposite side of the turntable 70 towards the front 62 of the lift device 10 is a left side hood 74. The left side hood 74 includes the user interface 21. The user interface 21 is coupled to the controller 300 and allows a user on the ground to operate the lift device 10. The hood 74 is rotatably coupled to the turntable 70 and defines within it a first compartment, shown as first compartment 75. The first compartment 75 includes a plurality of turntable valves 256 of the hydraulic system 152. The plurality of turntable valves 256 are fluidly coupled to the first hydraulic pump 156a and/or the second hydraulic pump 156b to receive pressurized hydraulic fluid and provide it to one or more of the actuators 34, extension actuator 35, platform assembly 16, etc. The user may access the plurality of turntable valves 256 via the left side hood 74. Opposite the left side hood 74 is a right side hood 76 which defines a second compartment 77 laterally opposite (e.g., across the longitudinal axis 78). In some embodiments, the second compartment 77 also a set of turntable valves 256. In some embodiments, the second compartment 77 includes additionally batteries are electrical contactors, breakers, switches for operation of the electric system 202. The hoods 74, 76 are generally smaller than the hoods on state-of-the-art lift devices because a majority of the components of the electric system 202 and the hydraulic system 152 are positioned in the base 36. In some embodiments as an electric vehicle, the lift device 10 also does not need to fit a ICE engine the turntable 70, allowing the size of the hoods 74, 76 to be reduced.

In some embodiments, a boom lift includes a chassis defining a first side area, a second side area, and a central area between the first side area and the second side area; a turntable supported by the chassis and configured to rotate relative to the chassis; a lift apparatus supported by the turntable and configured to raise and lower a platform, wherein the lift apparatus includes: a tower boom coupled to the turntable; a boom arm coupled to the tower boom and the platform; and a plurality of actuators configured to adjust a positioned of at least one of the tower boom or the boom arm; wherein the first side area includes at least one of: an electric motor coupled to the chassis; one or more hydraulic pumps, wherein the one or more hydraulic pumps are configured to be driven by the electric motor; a hydraulic reservoir fluidly coupled to the one or more hydraulic pumps; an auxiliary motor coupled to the chassis; an auxiliary hydraulic pump, wherein the auxiliary hydraulic pump is configured to be driven by the auxiliary motor; and a low-voltage battery, wherein the low-voltage battery is configured to power the auxiliary motor; wherein the second side area includes at least one of, a first charging part coupled to a first charger configured to receive power at a first voltage range; a second charging port coupled to a second charger configured to receive power at a second voltage range, wherein the first voltage range is different than the second voltage range; a third charging port configured to provide power to at least one of the platform, the electric motor, or the auxiliary motor; a filter coupled between at least one of the first charging port and the first charger or the second charging port and the second charger; and a plurality of breakers configured to trip at a predetermined threshold; wherein the central area includes at least one of: a high-voltage battery, wherein the high-voltage battery is configured to provide power to the electric motor; a plurality of hydraulic valves coupled to at least one of the one or more hydraulic pumps or the auxiliary pumps; and one or more inverters electrically coupled to the batteries.

In some embodiments of the boom lift, the chassis includes a first side panel laterally offset from the second side panel, wherein the first side area is laterally adjacent the first side panel, the second side area is laterally adjacent the second side panel, and the first side panel and the second side panel define the central area.

### Tower Boom

Referring generally to the FIGURES, a lift device includes a tower boom that raises and lowers a platform supporting an operator. The tower boom includes a lower linkage including a first lift arm and a second lift arm and an upper linkage including a third lift arm and a fourth lift arm. A hydraulic cylinder extends between the first lift arm and a chassis of the lift device (e.g., a frame of a turntable). To raise the tower boom, the hydraulic cylinder presses upward on the first lift arm, and a timing link connected between the first and third lift arms causes the third lift arm to rotate upward. The first and third lift arms have a first cross sectional size, and the second and fourth lift arms have a second cross sectional size smaller than the first cross sectional size.

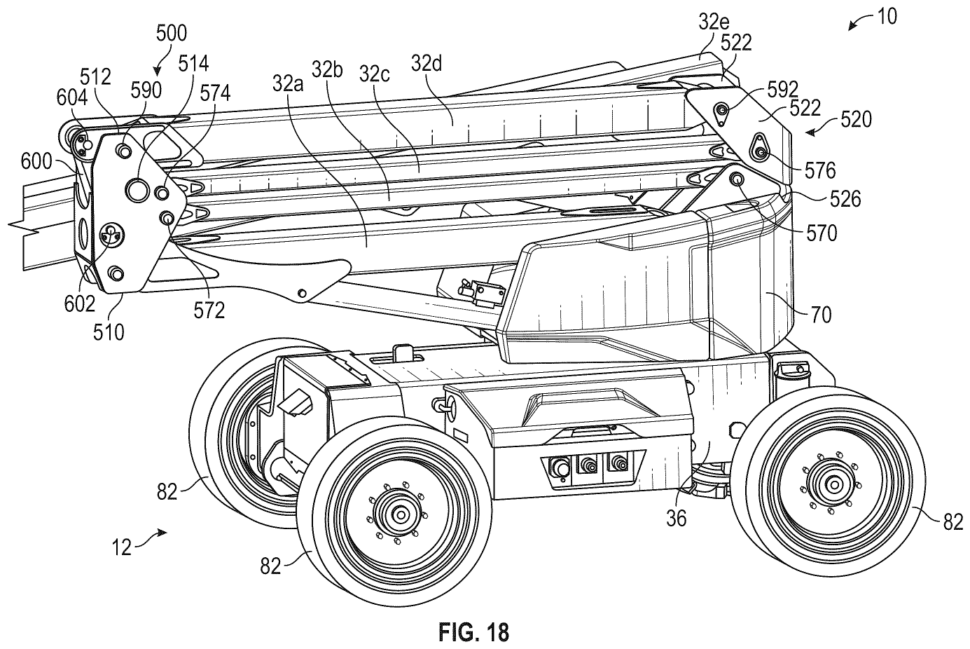

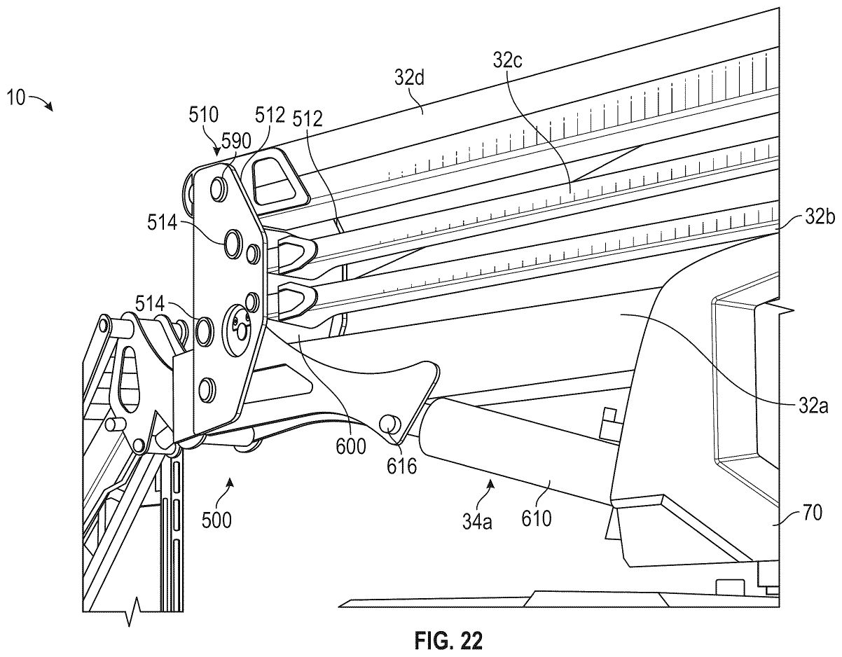

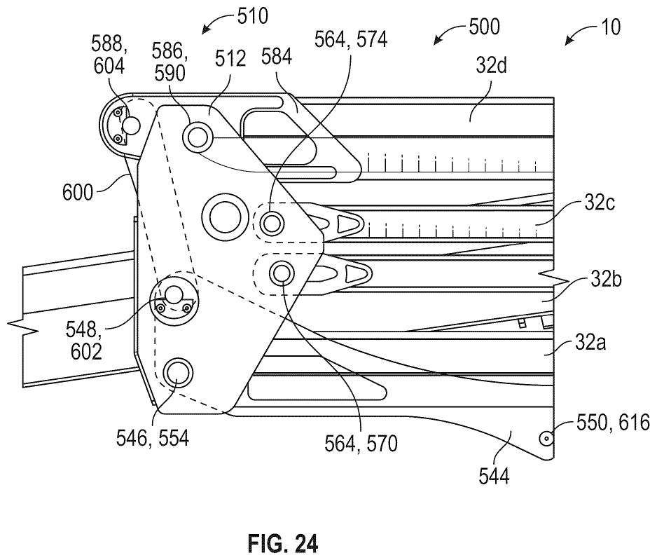

Referring now to FIGS. 18-24, the lift assembly 14 of the lift device 10 includes a boom subassembly assembly or lift assembly, shown as tower boom 500. The tower boom 500 couples the telescoping boom (e.g., the boom lift arm 32e and the intermediate lift arm 32f) to the turntable 70. The tower boom 500 may be an articulated portion of the lift assembly 14 and may be operable independent of the other portions of the lift assembly 14. The tower boom 500 includes the lower lift arm 32a, the lower middle lift arm 32b, the upper middle lift arm 32c, and the upper lift arm 32d.

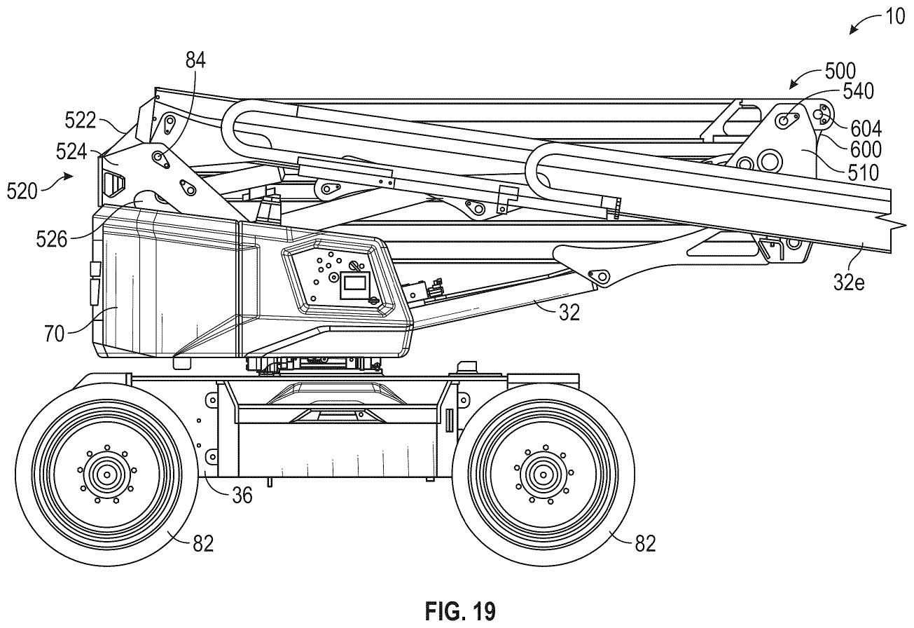

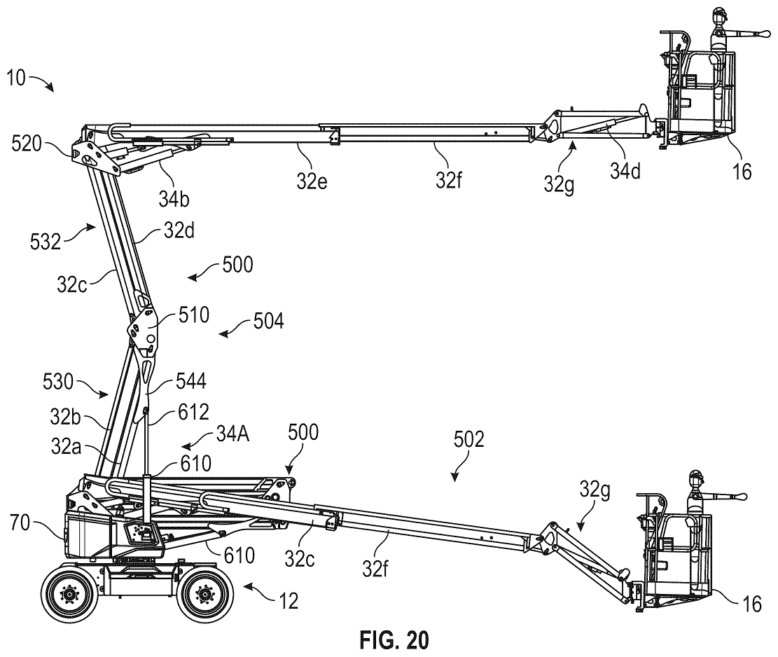

The tower boom 500 is reconfigurable between a lowered configuration, shown in FIGS. 18-19, and a raised configuration, shown in FIG. 20. Specifically, in FIG. 20, a lowered configuration 502 is shown and a raised configuration 504 is shown. By moving between the lowered configuration and the raised configuration, the tower boom 500 may raise or lower the platform assembly 16 as desired by an operator.

The tower boom 500 includes a first intermediate frame assembly, subframe, frame member, coupler, bracket, or upright, shown as bottom upright 510. The bottom upright 510 includes a pair of structural members, shown as side plates 512. The side plates 512 each extend in a different vertical and longitudinal plane and are laterally offset from one another. A cross member, shown as support tube 514, extends laterally between the side plates 512. The support tube 514 is fixedly coupled to the side plates 512 and maintains a desired lateral spacing between the side plates 512.

The tower boom 500 further includes a second intermediate frame assembly, subframe, frame member, coupler, bracket, or upright, shown as top upright 520. The top upright 520 defines an upper end portion of the tower boom 500 and supports the boom lift arm 32e. The top upright 520 includes a pair of structural members, shown as side plates 522. The side plates 522 each extend in a different vertical and longitudinal plane and are laterally offset from one another. An additional structural member, shown as side plate 524, extends in a vertical and longitudinal plane. The side plate 524 is laterally offset from the side plates 522 and is fixedly coupled to the side plates 522. The intermediate lift arm 32f is received between the side plate 524 and one of the side plates 522. A pin extends through the side plate 524 and one of the side plates 522 to pivotably couple the proximal end of the boom lift arm 32e to the top upright 520 and define a pivot point 84 about which the boom lift arm 32e rotates.

The turntable 70 includes a pair of structural members, shown as side plates 526. The side plates 526 each extend in a different vertical and longitudinal plane and are laterally offset from one another. The side plates 526 are fixedly coupled to one another to form a portion of a frame of the turntable 70.

The tower boom 500 includes a first portion or assembly (e.g., a four-bar linkage), shown as lower linkage 530, and a second portion or assembly (e.g., a four-bar linkage) shown as upper linkage 532. The lower linkage 530 includes a portion of the turntable 70 (e.g., the side plates 526), the lower lift arm 32a, the lower middle lift arm 32b, and a portion of the bottom upright 510. The lower lift arm 32a and the lower middle lift arm 32b each extend between the turntable 70 and the bottom upright 510 to form the lower linkage 530. The upper linkage 532 includes a portion of the bottom upright 510, the upper middle lift arm 32c, the upper lift arm 32d, and the top upright 520. The upper middle lift arm 32c and the upper lift arm 32d each extend between the bottom upright 510 and the top upright 520 to form the upper linkage 532. Each of the lower linkage 530 and the upper linkage 532 form a four-bar linkage that extends or retracts as the tower boom 500 moves between the lowered configuration and the raised configuration.

The lower lift arm 32a and the lower middle lift arm 32b are each received between the side plates 512 of the bottom upright 510 and between the side plates 526 of the turntable 70. The upper middle lift arm 32c and the upper lift arm 32d are each received between the side plates 512 of the bottom upright 510 and between the side plates 522 of the top upright 520. Accordingly, the lower lift arm 32a, the lower middle lift arm 32b, the upper middle lift arm 32c, and the upper lift arm 32d all extend within a common vertical plane.

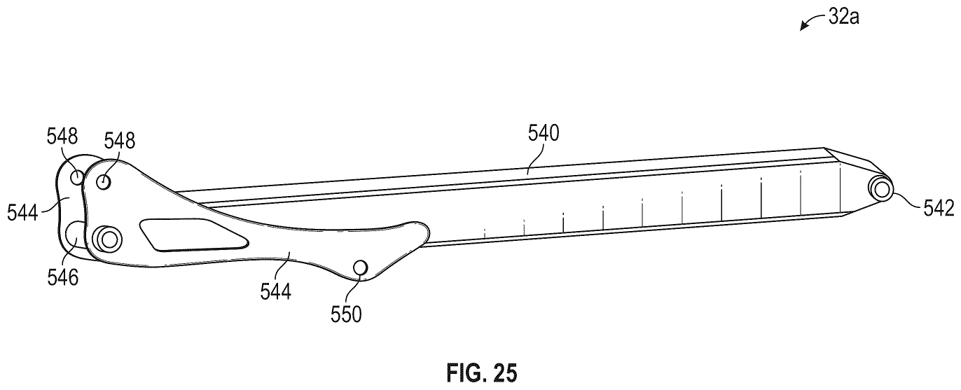

Referring to FIG. 25, the lower lift arm 32a is shown according to an exemplary embodiment. The lower lift arm 32a includes a tubular member, support, lengthwise member, structural member, base member, or bar, shown as tube 540. The tube 540 extends along a length of the lower lift arm 32a from a first end (e.g., a lower end) to a second end (e.g., an upper end). The lower lift arm 32a includes a first support, shown as bushing 542, that is positioned at the first end and fixedly coupled to the tube 540. The bushing 542 extends laterally through the tube 540 and defines a passage sized to receive a pin therethrough.

The lower lift arm 32a further includes a pair of supports or structural members, shown as side plates 544, fixedly coupled to opposite sides of the tube 540. The side plates 544 each extend in a corresponding vertical and longitudinal plane and are laterally offset from one another. A second support, shown as bushing 546, is positioned at the second end of the tube 540 and fixedly coupled to the tube 540. The bushing 546 extends laterally through the tube 540 and both of the side plates 544 and defines a passage sized to receive a pin therethrough. Each side plate 544 defines a first lateral aperture, shown as passage 548, and a second aperture, shown as passage 550. The passages 548 align with one another, and the passages 550 align with one another.

Referring to FIGS. 18 and 21-25, the lower lift arm 32a is pivotably coupled to the turntable 70 and the bottom upright 510. A first pin or shear member (e.g., one of the pivot points 84), shown as pin 552, pivotably couples the first end of the lower lift arm 32a to the turntable 70. Specifically, the pin 552 extends laterally through the bushing 542 and through apertures defined by the side plates 526. Each end of the pin 552 engages and is supported by one of the side plates 526 of the turntable 70. Accordingly, the lower lift arm 32a is rotatable relative to the turntable 70 about a lateral axis that is centered about the pin 552.

A second pin or shear member (e.g., one of the pivot points 84), shown as pin 554, pivotably couples the second end of the lower lift arm 32a to the bottom upright 510. Specifically, the pin 554 extends laterally through the bushing 546 and the side plates 512. Accordingly, the lower lift arm 32a is rotatable relative to the bottom upright 510 about a lateral axis that is centered about the pin 556.

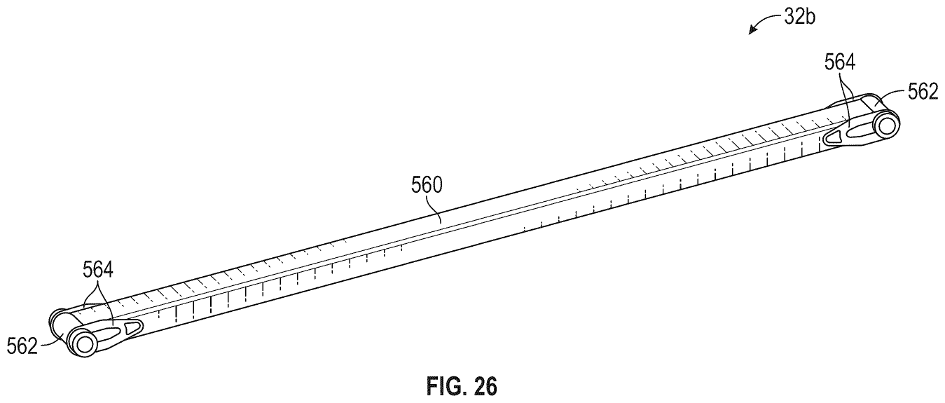

Referring to FIG. 26, the lower middle lift arm 32b is shown according to an exemplary embodiment. The lower middle lift arm 32b includes a tubular member, support, lengthwise member, structural member, base member, or bar, shown as tube 560. The tube 560 extends along a length of the lower middle lift arm 32b from a first end (e.g., a lower end) to a second end (e.g., an upper end). Each end of the lower middle lift arm 32b includes a support, shown as bushing 562, that is positioned adjacent to an end of the tube 560. The bushing 542 extends laterally and defines a passage sized to receive a pin therethrough. Each bushing 542 is fixedly coupled to the tube 560 by a pair of supports or plates, shown as side plates 564. Each pair of side plates 564 includes a first side plate 564 on a first side of the tube 560 and a second side plate 564 on an opposing second side of the tube 560, and the side plates 564 are fixedly coupled to the tube 560.

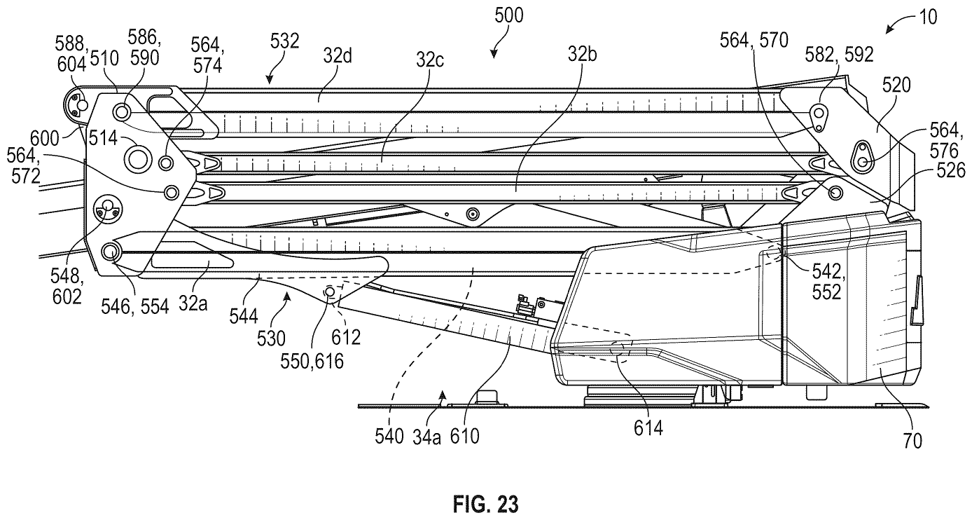

The upper middle lift arm 32c may be substantially similar to the lower middle lift arm 32b except as otherwise specified herein. The upper middle lift arm 32c includes a pair of bushings 562 fixedly coupled to a tube 560 by a series of side plates 564, similar to the lower middle lift arm 32b. However, the tube 560 of the upper middle lift arm 32c may be longer than the tube 560 of the lower middle lift arm 32b (e.g., as shown in FIG. 23). Accordingly, the upper middle lift arm 32c may be longer than the lower middle lift arm 32b.

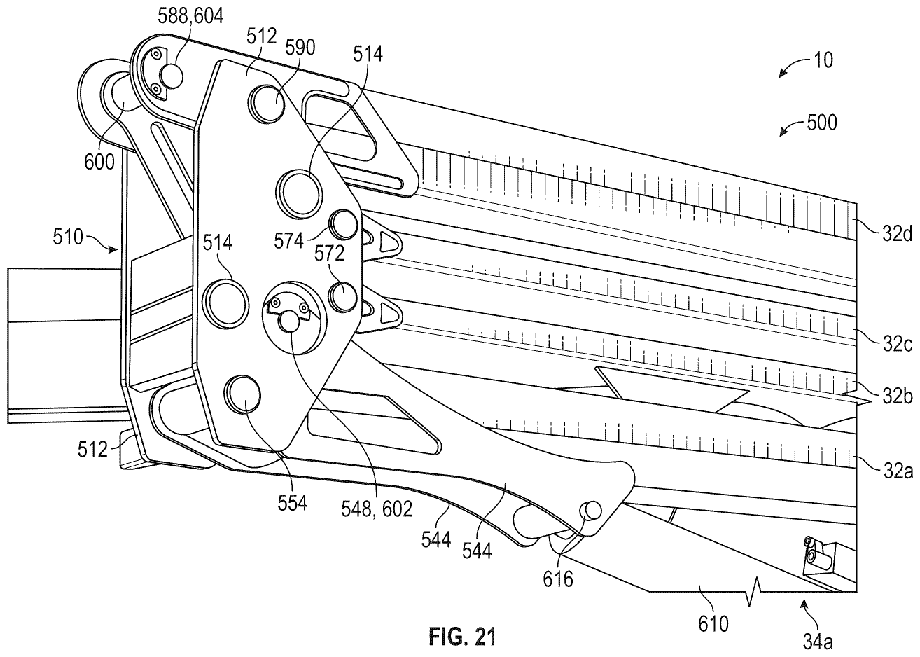

Referring to FIGS. 21-24 and 26, the lower middle lift arm 32b is pivotably coupled to the turntable 70 and the bottom upright 510. A first pin or shear member (e.g., one of the pivot points 84), shown as pin 570, pivotably couples the first end of the lower middle lift arm 32b to the turntable 70. Specifically, the pin 570 extends laterally through one of the bushings 562 and through apertures defined by the side plates 526. Each end of the pin 570 engages and is supported by one of the side plates 526 of the turntable 70. Accordingly, the lower middle lift arm 32b is rotatable relative to the turntable 70 about a lateral axis that is centered about the pin 570.

A second pin or shear member (e.g., one of the pivot points 84), shown as pin 572, pivotably couples the second end of the lower middle lift arm 32b to the bottom upright 510. Specifically, the pin 572 extends laterally through one of the bushings 562 and the side plates 512. Accordingly, the lower middle lift arm 32b is rotatable relative to the bottom upright 510 about a lateral axis that is centered about the pin 572.

Referring to FIGS. 21-24 and 26, the upper middle lift arm 32c is pivotably coupled to the bottom upright 510 and the top upright 520. A third pin or shear member (e.g., one of the pivot points 84), shown as pin 574, pivotably couples the first end of the upper middle lift arm 32c to the bottom upright 510. Specifically, the pin 574 extends laterally through one of the bushings 562 and through apertures defined by the side plates 512. Each end of the pin 574 engages and is supported by one of the side plates 512 of the bottom upright 510. Accordingly, the upper middle lift arm 32c is rotatable relative to the bottom upright 510 about a lateral axis that is centered about the pin 574.

A fourth pin or shear member (e.g., one of the pivot points 84), shown as pin 576, pivotably couples the second end of the upper middle lift arm 32c to the top upright 520. Specifically, the pin 576 extends laterally through one of the bushings 562 and the side plates 522. Accordingly, the upper middle lift arm 32c is rotatable relative to the top upright 520 about a lateral axis that is centered about the pin 576.

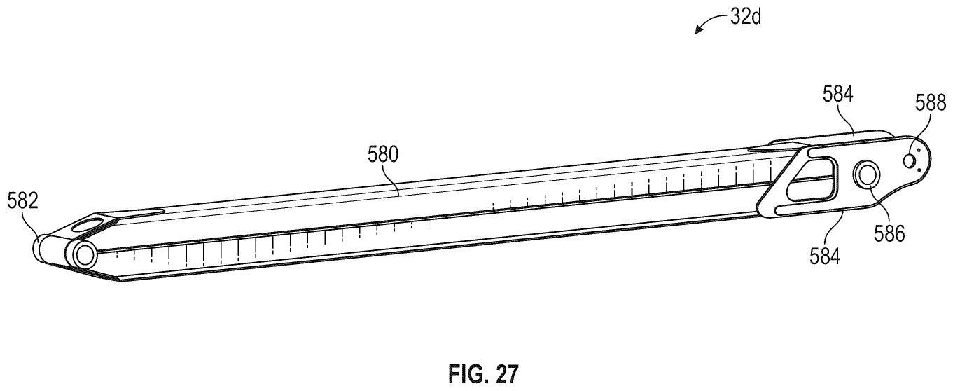

Referring to FIG. 27, the upper lift arm 32d is shown according to an exemplary embodiment. The upper lift arm 32d includes a tubular member, support, lengthwise member, structural member, base member, or bar, shown as tube 540. The tube 580 extends along a length of the upper lift arm 32d from a first end (e.g., a lower end) to a second end (e.g., an upper end). The upper lift arm 32d includes a first support, shown as bushing 582, that is positioned at the first end and fixedly coupled to the tube 580. The bushing 582 extends laterally through the tube 580 and defines a passage sized to receive a pin therethrough.

The upper lift arm 32d further includes a pair of supports or structural members, shown as side plates 584, fixedly coupled to opposite sides of the tube 580. The side plates 584 each extend in a corresponding vertical and longitudinal plane and are laterally offset from one another. A second support, shown as bushing 586, is positioned at the second end of the tube 580 and fixedly coupled to the tube 580. The bushing 586 extends laterally through the tube 580 and both of the side plates 584 and defines a passage sized to receive a pin therethrough. Each side plate 584 defines a lateral aperture, shown as passage 588. The passages 588 align with one another.

Referring to FIGS. 21-26 and 27, the upper lift arm 32d is pivotably coupled to the bottom upright 510 and the top upright 520. A first pin or shear member (e.g., one of the pivot points 84), shown as pin 590, pivotably couples the first end of the upper lift arm 32d to the bottom upright 510. Specifically, the pin 590 extends laterally through the bushing 586 and through apertures defined by the side plates 512. Each end of the pin 590 engages and is supported by one of the side plates 512 of the bottom upright 510. Accordingly, the upper lift arm 32d is rotatable relative to the bottom upright 510 about a lateral axis that is centered about the pin 590.

A second pin or shear member (e.g., one of the pivot points 84), shown as pin 592, pivotably couples the second end of the upper lift arm 32d to the top upright 520. Specifically, the pin 592 extends laterally through the bushing 582 and the side plates 522. Accordingly, the upper lift arm 32d is rotatable relative to the top upright 520 about a lateral axis that is centered about the pin 592.

Referring to FIGS. 18, 19, and 21-24, the tower boom 500 further includes a link, member, coupler, bar, or boom section, shown as timing link 600. The timing link 600 connects the lower linkage 530 to the upper linkage 532, limiting motion of the lower linkage 530 relative to the upper linkage 532 and facilitating coordinated and simultaneous extension of the lower linkage 530 and the upper linkage 532. Specifically, the timing link 600 causes each position of the lower linkage 530 to have a corresponding position of the upper linkage 532 (e.g., such that if the lower linkage 530 is held stationary, the upper linkage 532 is also held stationary).

The timing link 600 extends (a) between the side plates 512, (b) between the side plates 544, and (c) between the side plates 584. A first pin or shear member, shown as pin 602, extends through a lower end portion of the timing link 600 and is received by the passages 548 of the side plates 544, pivotably coupling the timing link 600 to the lower lift arm 32a. Accordingly, the timing link 600 is rotatable relative to the lower lift arm 32a about a lateral axis that is centered about the pin 602. A second pin or shear member, shown as pin 604, extends through an upper end portion of the timing link 600 and is received by the passages 588 of the side plates 584, pivotably coupling the timing link 600 to and end of the upper lift arm 32d. Accordingly, the timing link 600 is rotatable relative to the upper lift arm 32d about a lateral axis that is centered about the pin 604.

Referring to FIGS. 20-23, the actuator 34a is configured as a linear actuator including a first portion, shown as body 610, and a second portion, shown as rod 612. The rod 612 is received within the body 610, such that the rod 612 is slidably coupled to the body 610. The rod 612 is movable linearly relative to the body 610 to extend and retract the actuator 34a. In some embodiments, the actuator 34a is as hydraulic cylinder, such that extension of the actuator 34a is controlled by adding or removing hydraulic oil to the body 610.

The actuator 34a is pivotably coupled to the turntable 70 and to the lower lift arm 32a. A lower end portion of the body 610 is received between the side plates 526 of the turntable 70. A first pin or shear member, shown as pin 614, extends through the lower end portion of the body 610 and engages (e.g., is received by passages of) the side plates 526, pivotably coupling the body 610 to the turntable 70. Accordingly, the body 610 is rotatable relative to the turntable 70 about a lateral axis that is centered about the 614. As shown in FIG. 23, an upper end portion of the rod 612 is received between the side plates 544, such that the upper end portion of the rod 612 is positioned below a bottom surface of the tube 540. A second pin or shear member, shown as pin 616, extends through the upper end portion of the rod 612 and is received by the passages 550 of the side plates 544, pivotably coupling the rod 612 to the lower lift arm 32a. Accordingly, the rod 612 is rotatable relative to the lower lift arm 32a about a lateral axis that is centered about the pin 616. This placement of the actuator 34a may reduce the forces required to raise the tower boom 500 relative to an alternative arrangement in which the actuator 34a is supported entirely by the tower boom 500. Accordingly, this placement of the actuator 34a may reduce the required strength and weight of the lift arms 32.

Referring to FIGS. 20 and 23, during operation of the tower boom 500, the actuator 34a may be extended to raise the tower boom 500. By extending the actuator 34a, the pin 616 is forced away from the pin 616, causing the lower lift arm 32a to rotate about the pin 552 (e.g., clockwise as shown in FIG. 23). This rotation moves the pin 554 upward, which raises the bottom upright 510. As the bottom upright 510 is elevated, the lower middle lift arm 32b limits rotation of the bottom upright 510 to maintain the orientation of the bottom upright 510 substantially constant. Throughout this motion, the lower middle lift arm 32b remains substantially parallel to the lower lift arm 32a, rotating the lower middle lift arm 32b about the pin 572 and the pin 570. Accordingly, the lower lift arm 32a and the lower middle lift arm 32b cause the lower linkage 530 to act as a four-bar linkage to raise the bottom upright 510 while maintaining a desired orientation of the bottom upright 510.

As the bottom upright 510 is raised, the lower lift arm 32a rotates about the pin 554, pulling the pin 602 downward relative to the bottom upright 510. This pulls the timing link 600 downward, which in turn pulls the pin 604 downward. Due to the position of the pin 604 forward of the pin 590, the downward force of the timing link 600 on the pin 604 imparts a moment effect that causes the upper lift arm 32d to rotate about the pin 590 (e.g., counterclockwise as shown in FIG. 23). Accordingly, the timing link 600 causes the lower lift arm 32a and the upper lift arm 32d to rotate in opposite directions, raising the upper lift arm 32d.

The rotation of the upper lift arm 32d moves the pin 592 upward, which raises the top upright 520. As the top upright 520 is elevated, the upper middle lift arm 32c limits rotation of the top upright 520 to maintain the orientation of the top upright 520 substantially constant. Throughout this motion, the upper middle lift arm 32c remains substantially parallel to the upper lift arm 32d, rotating the upper middle lift arm 32c about the pin 574 and the pin 576. Accordingly, the upper lift arm 32d and the upper middle lift arm 32c cause the upper linkage 532 to act as a four-bar linkage to raise the top upright 520 while maintaining a desired orientation of the top upright 520. A similar process may occur in reverse when the actuator 34a is retracted to lower the tower boom 500.

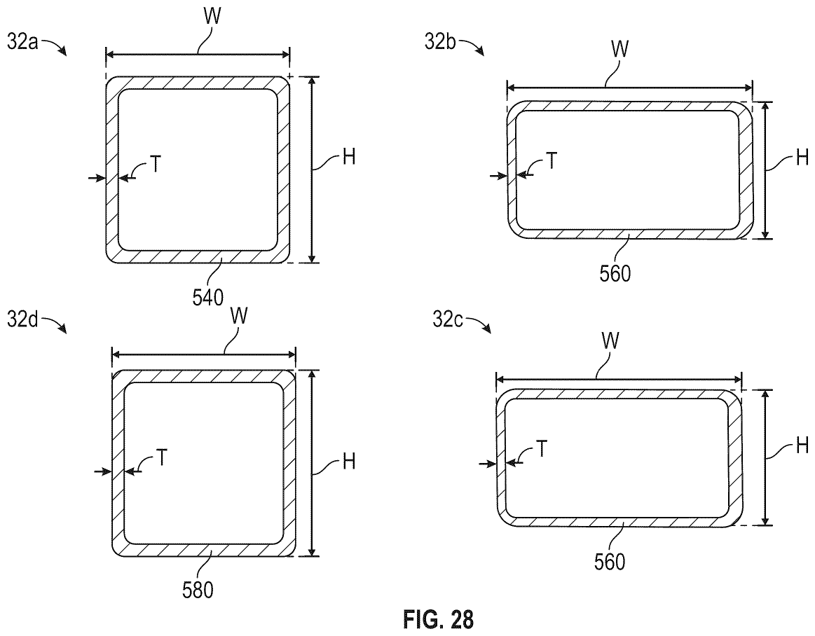

Referring to FIG. 28, the cross-sectional dimensions (e.g., cross-sectional sizes) of the tube 540, the tubes 560, and the tube 580 are shown according to an exemplary embodiment. Each cross-sectional dimension is measured in a plane extending perpendicular to a length of the tube. Each tube has a height H measured vertically, a width W measured laterally, and a wall thickness T measured between the interior and exterior surfaces of the tube. As shown, the tubes each have a rectangular cross section. In some embodiments, the height H and the width W of one or more of the tubes are substantially equal, such that the tube has a square cross section.

As shown in FIG. 28, the height H, the width W, and the wall thickness T of the tube 540 of the lower lift arm 32a and the tube 580 of the upper lift arm 32d are substantially equal. In some embodiments, the tube 540 and the tube 580 are formed using the same type of tube (e.g., same cross-sectional shape, size, and material), but cut to different lengths. By way of example, the tube 540 and the tube 580 may each be extruded as a single piece, or may be formed from a pair of U-shaped members welded together. By using two components having the same or identical sections, production of the lower lift arm 32a and the upper lift arm 32d may be simplified as opposed to having two tubes of different sections.

Referring still to FIG. 28, the height H, the width W, and the wall thickness T of the tube 540 of the lower middle lift arm 32b and the tube 580 of the upper middle lift arm 32c are substantially equal. Accordingly, the lower lift arm 32a and the lower middle lift arm 32b may also benefit from the simplified production discussed with respect to the lower lift arm 32a and the upper lift arm 32d. In some embodiments, the lower lift arm 32a and the upper lift arm 32d support a majority of a load on the tower boom 500 (e.g., the weight of the platform assembly 16). Accordingly, the height H and/or the wall thickness T of the lower middle lift arm 32b and the upper middle lift arm 32c may be less than that of the lower lift arm 32a and the upper lift arm 32d to reduce the weight of the tower boom 500.

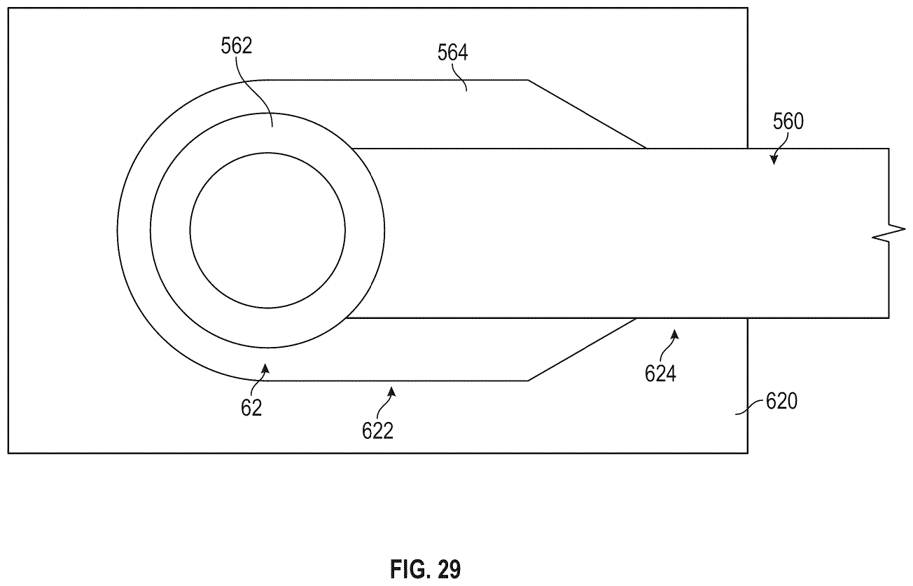

Referring to FIG. 29, a jig or fixture is shown as welding fixture 620 according to an exemplary embodiment. The welding fixture 620 is sized to hold the components of an end of the lower middle lift arm 32b and/or the upper middle lift arm 32c. The welding fixture 620 defines a first channel, groove, or recess, shown as plate recess 622, that is sized and shaped to receive one of the side plates 564. Specifically, the shape and size of the plate recess 622 may match an outer perimeter of one of the side plates 564. The welding fixture 620 further defines a groove, recess, or passage, shown as tube recess 624, extends inward from two sides of the welding fixture 620 and intersects the plate recess 622. The tube recess 624 is sized to receive the tube 560. The welding fixture 620 further defines a passage or recess, shown as bushing passage 626, that is sized and shaped to receive one of the bushings 562.

During manufacturing of the lower middle lift arm 32b or the upper middle lift arm 32c, the welding fixture 620 holds various components in a desired spatial relationship to one another (e.g., desired position and orientation) to facilitate assembly (e.g., welding) of the lift arm. A side plate 564 may be placed into the plate recess 622, and a bushing 562 may be inserted through the side plate 564 and into the bushing passage 626. The tube 560 may inserted through the tube recess 624 and forced to abut the bushing 562. These components may then be welded to one another with the welding fixture 620 preventing unwanted movement of the components during the welding operation. In some embodiments, the welding fixture 620 is placed having a known position and orientation to an automated welding machine (e.g., a welding robot), such that the lift arm may be welded autonomously and accurately.

In some embodiments, a vehicle includes a frame and a boom assembly coupled to the frame. The boom assembly includes a first upright, a second upright, a first lift arm having a first end portion pivotably coupled to the frame and a second end portion pivotably coupled to the first upright, a second lift arm having a first end portion pivotably coupled to the frame and a second end portion pivotably coupled to the first upright, a third lift arm having a first end portion pivotably coupled to the first upright and a second end portion pivotably coupled to the second upright, and a fourth lift arm having a first end portion pivotably coupled to the first upright and a second end portion pivotably coupled to the second upright. The boom assembly further includes a linear actuator coupled to the frame and the first lift arm and configured to extend to raise the first upright relative to the frame.

In some embodiments, the vehicle includes a timing link pivotably coupled to the first lift arm and the third lift arm and configured to cause rotation of the third lift arm relative to the first upright in response to the linear actuator raising the first upright.

In some embodiments, a pair of plates and a tubular member extend between the plates. The plates pivotably couple the linear actuator to the tubular member, and an end portion of the linear actuator extends between the plates.

In some embodiments, an end portion of the linear actuator is positioned below the tubular member.

In some embodiments, the linear actuator is a hydraulic cylinder including a body that receives a rod, and the rod defines the end portion of the linear actuator.

In some embodiments, the first lift arm includes a first tubular member having a first height, the second lift arm includes a second tubular member having a second height, and the first height is greater than the second height.

In some embodiments, the first lift arm includes a first tubular member having a first height, the third lift arm includes a second tubular member having a second height, and the first height and the second height are substantially equal.

In some embodiments, the second lift arm includes a third tubular member having a third height, and the third height is less than the first height.

In some embodiments, the fourth lift arm includes a fourth tubular member having a fourth height, and the third height and the fourth height are substantially equal.

In some embodiments, the vehicle includes a chassis and a turntable rotatably coupled to the chassis, and the turntable includes the frame such that the frame is rotatable relative to the chassis.

### Compact Fly Boom

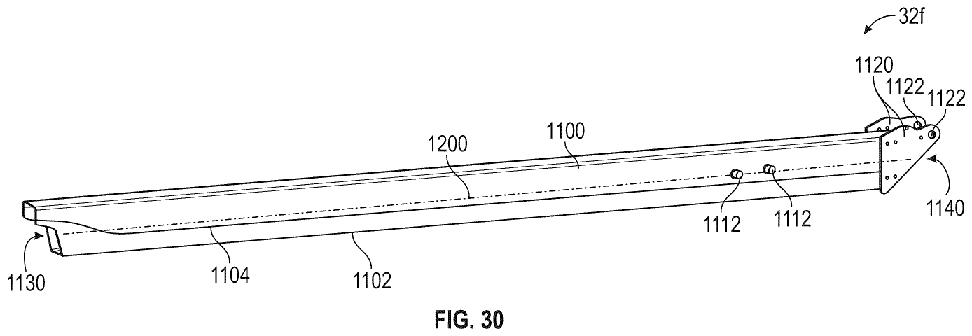

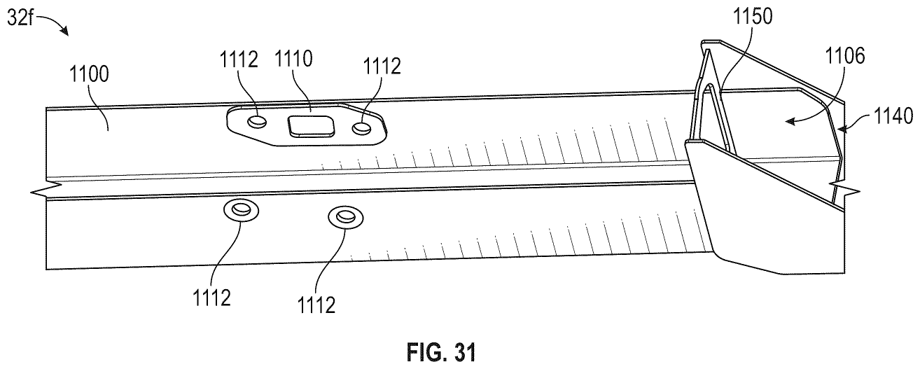

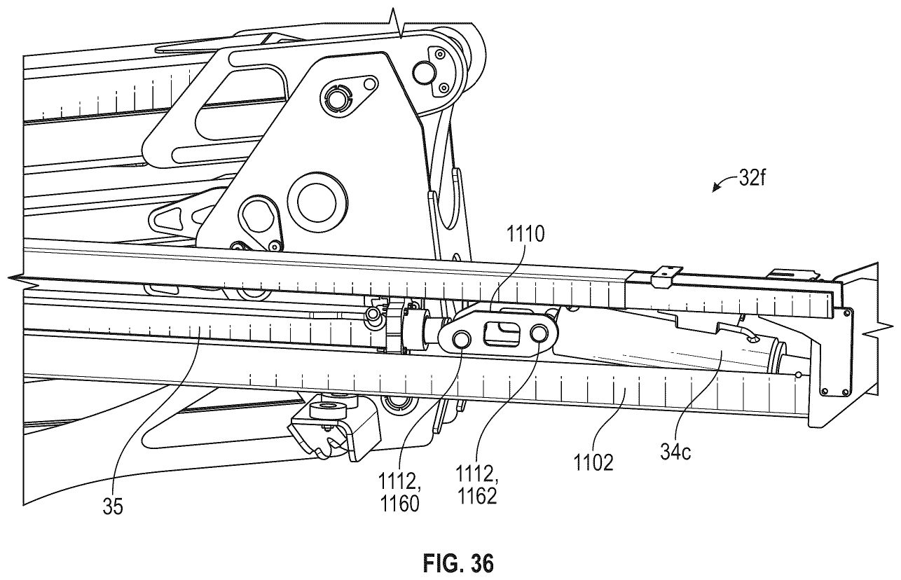

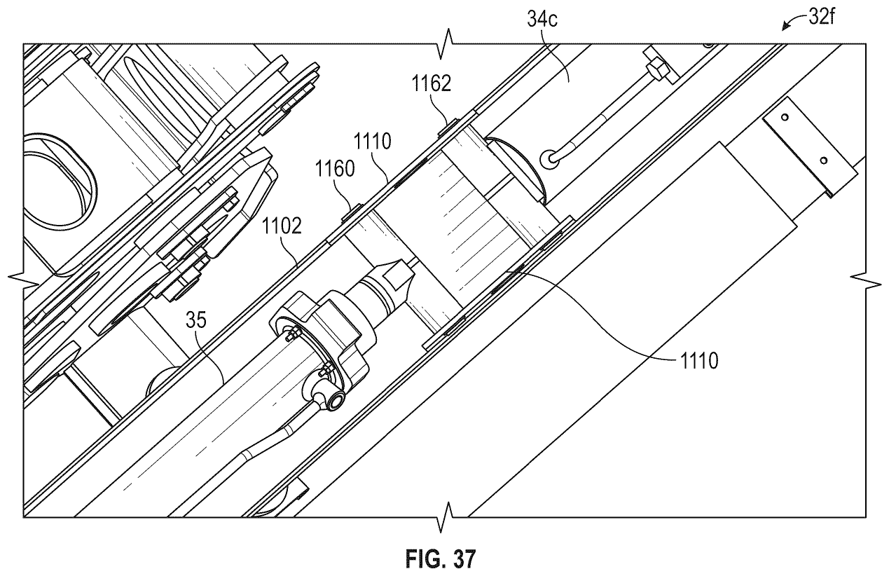

Referring generally to FIGS. 30-37, a lift device (e.g., a boom, an articulated boom, a lift, a MEWP, a telehandler, etc.) includes a lift apparatus (e.g., a telescoping arm, an articulated arm, a boom arm, a boom, etc.) and a base supporting the lift apparatus. The lift apparatus is coupled to a platform (e.g., cabinet, container, base, structural member, etc.). The platform can include a plurality of couplings for power, high pressure air, hydraulics, and communication, etc., to connect the platform with the lift device.

According to an exemplary embodiment, the lift device and lift apparatus assembly of the present disclosure include an intermediate lift arm. The intermediate lift arm is configured to be stored within a boom arm of the lift apparatus and selectively extend outward from the boom arm. In some embodiments, the lift device includes a control system configured to operate controllable elements of the lift device. The control system includes one or more controllers configured to operate the lift device and the lift apparatus. In some embodiments, a single controller controls both the lift device and the stabilizing bar attachment. In other embodiments, there are dedicated controllers for each of the lift device and the lift apparatus.

Referring now to FIGS. 30-33, the intermediate lift arm 32f (i.e., the fly boom) is shown, according to an exemplary embodiment. The intermediate lift arm 32f includes a top component or upper component, shown as top shell 1100, and a bottom component or lower component, shown as bottom shell 1102. As shown, the top shell 1100 and the bottom shell 1102 are fixedly coupled to one another to form the intermediate lift arm 32f. Specifically, the top shell 1100 and the bottom shell 1102 are welded to one another at a seam 1104 that extends along the length of the lift arms 32 on the left and right sides of the intermediate lift arm 32f. The top shell 1100 and the bottom shell 1102 define and enclose a space or volume, shown as internal volume 1106, that extends along the length of the intermediate lift arm 32f.

The top shell 1100 and the bottom shell 1102 extend along a length of the boom lift arm 32e between a first or proximal end, shown as proximal end 1130, and a second or distal end, shown as distal end 1140. The proximal end 1130 is received within the boom lift arm 32e. The distal end 1140 extends away from the boom lift arm 32e. As shown, the internal volume 1106 is open at the proximal end 1130 and the distal end 1140 to permit external access to the internal volume 1106. Specifically, the top shell 1100 and the bottom shell 1102 define an aperture, shown as cylinder port 1150, near the distal end 1140. The cylinder port 1150 permits the actuator 34c to pass into the internal volume 1106 from the distal end 1140.

The intermediate lift arm 32f further includes one or more backing plates, gussets, guide plates, or strengthening plates, shown as doubling plates 1110. The doubling plates 1110 are positioned within the internal volume 1106 and fixedly coupled to the top shell 1100 and the bottom shell 1102 (e.g., by welding to an internal surface thereof). As shown, the doubling plate 1110 each extend along an internal surface of the top shell 1100. The doubling plates 1110 may strengthen the intermediate lift arm 32f at locations where various actuators are attached. As shown, each doubling plate 1110 defines a pair of interfaces (e.g., apertures, passages, couplings, etc.), shown as actuator apertures 1112. Each actuator aperture 1112 is sized to receive a fastener or pin to pivotably couple an actuator to the doubling plate 1110. The doubling plates 1110 may be positioned such that the actuator apertures 1112 align with one another. The top shell 1100 and the bottom shell 1102 may each define corresponding passages that align with the actuator apertures 1112 to provide clearance for pins entering the actuator apertures 1112.

The intermediate lift arm 32f further includes on or more jib assembly couplings or side plates, shown as jib coupling plates 1120. The jib coupling plates 1120 are each fixedly coupled (e.g., welded) to the top shell 1100 and the bottom shell 1102. The jib coupling plates 1120 extend along the left and right external sides of the top shell 1100 and the bottom shell 1102 and extend longitudinally outward beyond the top shell 1100 and the bottom shell 1102. Each of the jib coupling plates 1120 defines an aperture or passage, shown as jib aperture 1122, that is positioned to receive a fastener or pin to couple the jib assembly 32g to the intermediate lift arm 32f. The jib coupling plates 1120 may be positioned such that the jib apertures 1122 align with one another.

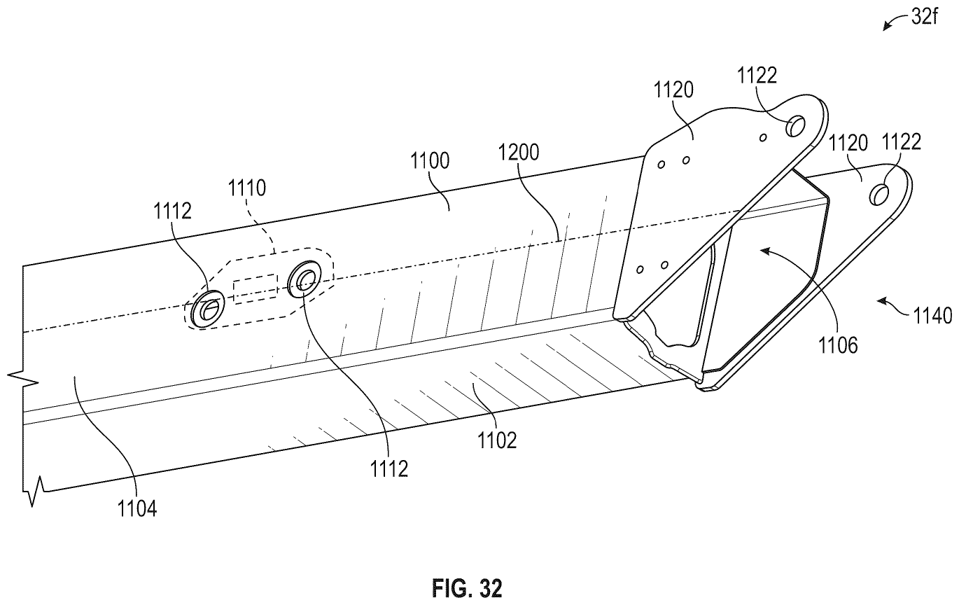

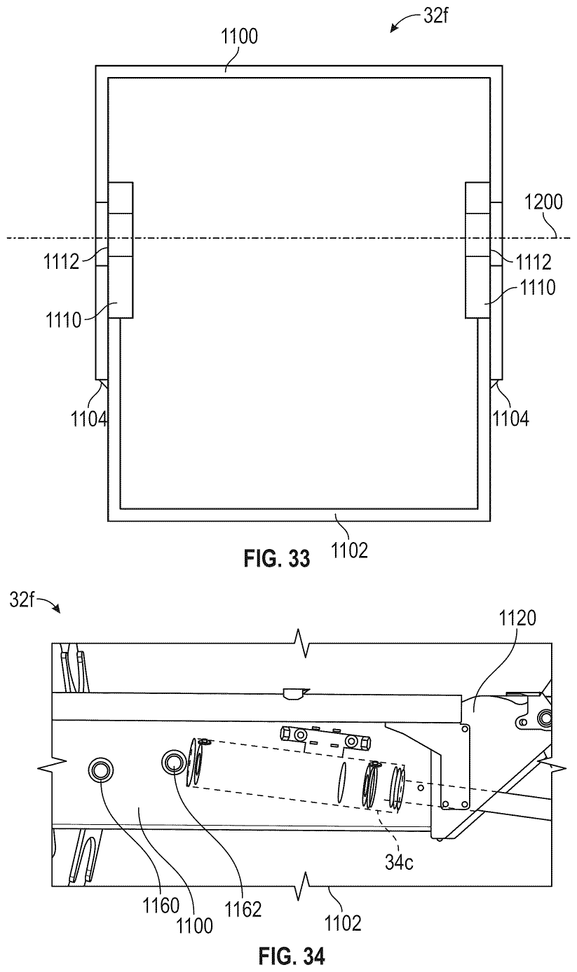

During operation, the intermediate lift arm 32f experiences bending stresses due to a downward force on the distal end of the intermediate lift arm 32f (e.g., from supporting the platform assembly 16). FIG. 33 illustrates a section view of the intermediate lift arm 32f perpendicular to a length of the intermediate lift arm 32f. As shown, each section along the length of the intermediate lift arm 32f has an axis, shown as neutral axis 1200, that extends perpendicular to the length of the intermediate lift arm 32f. The neutral axis 1200 may represent a point where, when the intermediate lift arm 32f experiences a downward load that imparts bending stresses, all points above the neutral axis 1200 are in tension and all points below the neutral axis 1200 are in compression. The intermediate lift arm 32f may experience no longitudinal stresses along the neutral axis 1200. FIGS. 30 and 32 illustrate the locations of the neutral axes 1200 at different points along the length of the intermediate lift arm 32f. In some embodiments, the neutral axes 1200 all extend within a common plane.

As shown in FIGS. 32 and 33, the top shell 1100 and the bottom shell 1102 are sized such that the seam 1104 is offset from the neutral axis 1200. Accordingly, the portion of the bottom shell 1102 that is overlapped by the top shell 1100 is also offset from the neutral axis 1200. This offset provides space for the doubling plates 1110 to be placed near the neutral axis 1200. Specifically, the neutral axis 1200 passes through the doubling plates 1110, locating the actuator apertures 1112 near the neutral axis 1200. While the passages passing through the top shell 1100 to provide clearance for the actuator apertures 1112 would normally decrease the strength of that portion of the intermediate lift arm 32f, placing the actuator apertures 1112 near the neutral axis 1200 reduces the forces experienced near the actuator apertures 1112, thereby reducing the stresses on the intermediate lift arm 32f.

Referring now to FIGS. 34-37, the intermediate lift arm 32f is shown to house various components of the lift device 10, including the extension actuator 35, the actuator 34c, and the doubling plate 1110. The extension actuator 35 extends longitudinally into the internal volume 1106 from the proximal end 1130. In some embodiments, the extension actuator 35 is contained completely within the boom lift arm 32e and the intermediate lift arm 32f throughout the range of motion of the extension actuator 35. The actuator 34c extends longitudinally into the internal volume 1106 from the distal end 1140. An end (e.g., a rod end) of the actuator 34c extends outside of the internal volume 1106 through the cylinder port 1150 to couple to the jib assembly 32g. By inserting the actuator 34c into the intermediate lift arm 32f, the telescoping boom may be reduced in size compared to other telescoping booms while maintaining a desired range of motion of the jib assembly 32g relative to the intermediate lift arm 32f.

As shown in FIGS. 34-37, the extension actuator 35 and the actuator 34c are pivotably coupled to the doubling plate 1110 by a pair of fasteners (e.g., lead screws, threaded nuts, threaded bolts, etc.), shown as pin 1160 and pin 1162. The pin 1160 extends laterally through a first set of the actuator apertures 1112 and through a corresponding passage on a distal end of the extension actuator 35. The pin 1160 pivotably couples the extension actuator 35 to the doubling plate 1110, such that the extension actuator 35 is pivotable about the pin 1160. The pin 1162 extends laterally through a second set of the actuator apertures 1112 and through a corresponding passage on a proximal end of the actuator 34c. The pin 1162 pivotably couples the actuator 34c to the doubling plate 1110, such that the actuator 34c is pivotable about the pin 1162.

By coupling both the extension actuator 35 and the actuator 34c to the doubling plate 1110, the connection of the doubling plate 1110 to the intermediate lift arm 32f causes the assembly to act as one, extending and retracting in the same manner. As the extension actuator 35 is extended, the doubling plate 1110, and thus, the intermediate lift arm 32f are acted on, extending the intermediate lift arm 32f outwards from the boom lift arm 32e. As the extension actuator 35 is retracted, the doubling plate 1110 and the intermediate lift arm 32f are acted on, retracting the intermediate lift arm 32f inwards and into the boom lift arm 32e.

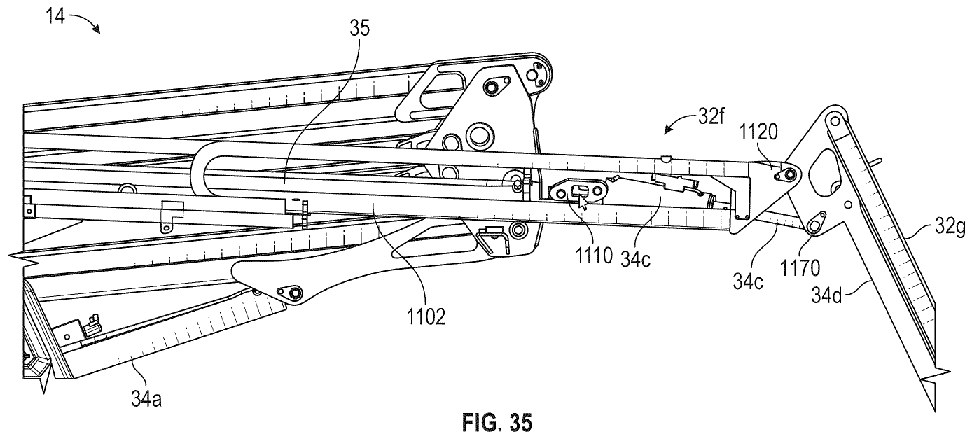

As shown in FIG. 35, the distal end 1140 of the intermediate lift arm 32f includes the jib coupling plates 1120. The jib coupling plates 1120 pivotably couple the jib assembly 32g to the intermediate lift arm 32f. As shown in FIG. 35, the jib assembly 32g is received between the jib coupling plates 1120. A first fastener (e.g., screw, threaded nut, threaded bolt, etc.), shown as pin 1170, pivotably couples the jib assembly 32g to the jib coupling plates 1120. Specifically, the pin 1170 extends through the jib apertures 1122 and corresponding apertures of the jib assembly 32g. A second fastener, shown as pin 1172, extends through apertures defined by the jib assembly 32g and the distal end of the actuator 34c to pivotably couple the distal end of the actuator 34c to the jib assembly 32g. Accordingly, the actuator 34c extends through the cylinder port 1150 to engage with the jig assembly 32g.

### Compact Platform Assembly

Referring generally to the 38-46, a lift device includes a lift assembly and a platform assembly coupled to the lift assembly. The platform assembly includes a substructure. The substructure includes one or more lateral members and a plurality of longitudinal members coupled to the one or more lateral members. One or more tapered support beams are also coupled to the one or more lateral members and the plurality of longitudinal members. A controls support structure is cantilevered upwards from one or more of the plurality of longitudinal members. A load cell is positioned between the lift assembly and the platform assembly, and the load cell is coupled to the substructure. The load cell is coupled beneath the platform assembly, and at least a portion of the platform assembly is cantilevered over the load cell. Beneficially, the position of the load cell beneath the platform assembly allows the platform assembly to be positioned closer to a jib assembly of the lift device and thereby reduce an overall length of the lift device.

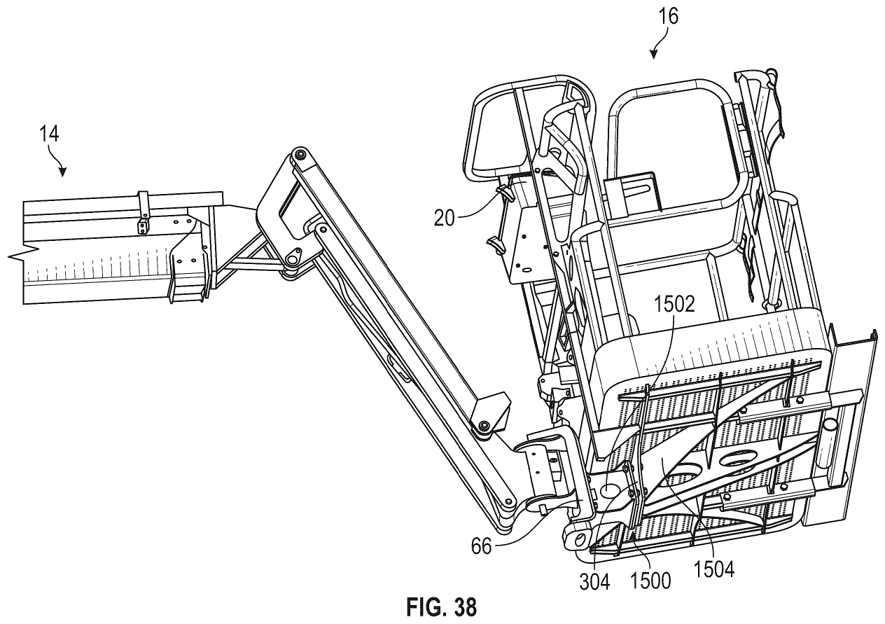

Referring now to FIG. 38, the lift device 10 may include a compact platform mount 1500 including a load cell 1502 (e.g., a load sensor, etc.) and the platform mount 66. When an operator, occupants, and/or equipment is within the platform assembly 16, the load cell 1502 measures a load on the platform assembly 16 and may send one or more signals to the controller 38 (e.g., a control system, a computer system, etc.) indicating the measured load. The controller 38 may then evaluate the load against an available platform capacity (e.g., a rated capacity, etc.) and determine if the lift device 10 can continue to operate under the load. As the position of the platform assembly 16 changes, the signals may be repeatedly compared to the available platform capacity. If the platform assembly 16 is moved into a new position, and the platform load exceeds the new available platform capacity, the compact platform mount 1500 may recognize an overload condition and respond to the overload condition by activating lights or alarms, and/or interrupting one or more functions of the lift device 10. To clear an overload condition, an operator may remove weight from the platform assembly 16 at a current height of the platform assembly 16, or the operator can boom down the platform assembly 16 into an allowable operating height zone or to the ground to remove weight.

The load cell 1502 may be positioned generally beneath the user interface 20 on the platform assembly 16 and between the platform mount 66 of the lift assembly 14 and the platform assembly 16. The load cell 1502 may be coupled to a substructure 1504 (e.g., a support structure, a frame, an exoskeleton, a mount, etc.) of the platform assembly 16 via one or more bolts, as shown in FIG. 38. The substructure 1504 may include a load cell brace 304 (e.g., a mount, a plate, etc.) (shown in FIG. 5) which is configured to couple to the load cell 1502 and may include one or more bolt holes to receive one or more bolts coupling the load cell 1502 to the substructure 1504. The load cell brace 304 may be coupled to one or more other components comprising the substructure 1504.

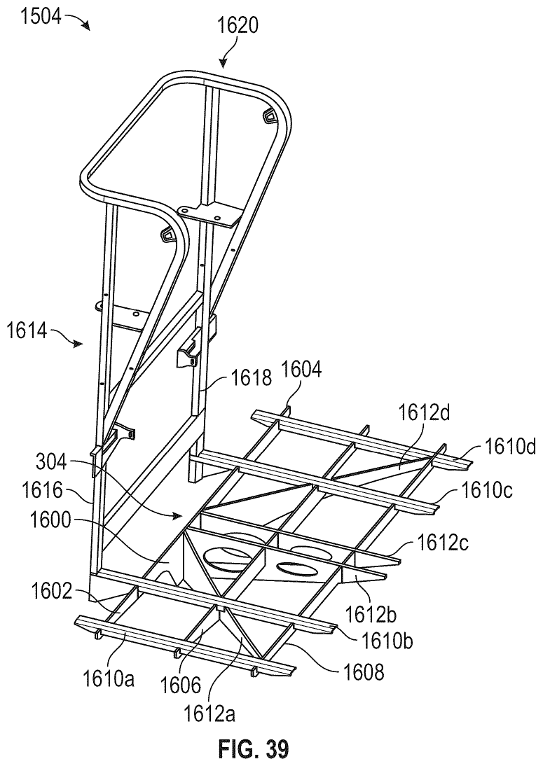

Turning now to FIG. 39, the substructure 1504 is shown according to an embodiment. The substructure 1504 may generally support a platform, for example, including a standing surface, a shelf, a work platform, a floor, the deck 18, a platform railing assembly, guardrails, etc. (e.g., a platform 2000). of the platform assembly 16. Some or all of the components of the substructure 1504 discussed further herein may be bolted together and may be made from aluminum. In general, the components of the substructure 1504 form a cantilevered or L-shape. In other embodiments, the substructure 1504 may be shaped differently.

As shown in FIGS. 5 and 39, the load cell brace 304 may form a central plate 1600 with a first arm 1602 protruding from a first side of the central plate and a second arm 1604 protruding from a second side of the central plate. The load cell brace 304 may be structured as a lateral member extending substantially from a first lateral side of the platform assembly 16 to a second lateral side of the platform assembly 16. Similarly, the substructure 1504 may include a first lateral member 1606 and a second lateral member 1608 extending substantially from the first lateral side of the platform assembly 16 to the second lateral side of the platform assembly 16. The first lateral member 1606 and the second lateral member 1608 may be positioned substantially parallel to the load cell brace 304. The first lateral member 1606 and the second lateral member 1608 may not include a central plate and may instead be configured as a substantially straight beam or a tapered beam. Some embodiments may not include the first lateral member 1606 and/or the second lateral member 1608.

Positioned at intervals along the lengths of and coupled to one or more of the load cell brace 304, the first lateral member 1606, and the second lateral member 1608 may be one or more longitudinal members 1610 such as longitudinal member 1610a, longitudinal member 1610b, longitudinal member 1610c, and longitudinal member 1610d. The longitudinal members 1610 may generally be configured as substantially straight beams extending from a first end of the substructure 1504 to a second end of the substructure 1504 and may perpendicularly intersect one or more of the load cell brace 304, the first lateral member 1606, and the second lateral member 1608. Some embodiments may include a greater or fewer number of the longitudinal members 1610 than shown in FIG. 39.

The substructure 1504 may also include tapering support beams 1612, such as support beam 1612a, support beam 1612b, support beam 1612c, and support beam 1612d. The support beams 1612 may be coupled to the load cell brace 304 on an opposite side of the central plate 1600 relative to the load cell 1502. The support beams 1612 may protrude from the load cell brace 304 at one or more angles. For example, the support beam 1612a and the support beam 1612d may protrude from the load cell brace 304 at approximately 45-degree angles, while the support beam 1612b and the support beam 1612c may protrude from the load cell brace 304 at approximately 90-degree angles. As such, the support beams 1612 may intersect one or more of the first lateral member 1606, the second lateral member 1608, and/or the longitudinal members 1610 at various angles. The support beams 1612 may be configured to taper (e.g., decrease in size) from a portion adjacent to the load cell brace 304 to a distal end of each of the support beams 1612. One or more of the support beams 1612 may also include one or more apertures which may help to decrease the weight of the substructure 1504. In other embodiments, the support beams 1612 may configured or positioned in another manner.

At an end of the substructure 1504 proximate the platform mount 66, the substructure 1504 may include a controls support structure 1614. The controls support structure 1614 may support a control system of the platform assembly 16 such as the user interface 20, and electrical and hydraulic components of the lift device 10. The user interface 20 and the electrical and hydraulic components of the lift device 10 may be coupled to the controls support structure 1614.

The controls support structure 1614 may include a first arm 1616 and a second arm 1618. The first arm 1616 and the second arm 1618 may be coupled to one end of a longitudinal member. For example, the first arm 1616 may be coupled to an end of the longitudinal member 1610b, while the second arm 1618 may be coupled to an end of the longitudinal member 1610c. The first arm 1616 and the second arm 1618 are cantilevered upwards at a substantially 90-degree angle from the longitudinal members 1610. The controls support structure 1614 may include one or more additional components, such as cross bars or other supporting components of the control system of the platform assembly 16, the user interface 20, and/or the electrical and hydraulic components of the lift device 10. The controls support structure 1614 may also include a railing assembly 1620 (e.g., handles, guardrails, etc.) which wraps around the top of the controls support structure 1614 and may be coupled to the first arm 1616 and the second arm 1618 at one or more points. The railing assembly 1620 may provide a structure for an operator or occupant of the platform assembly 16 to grip the platform assembly 16.

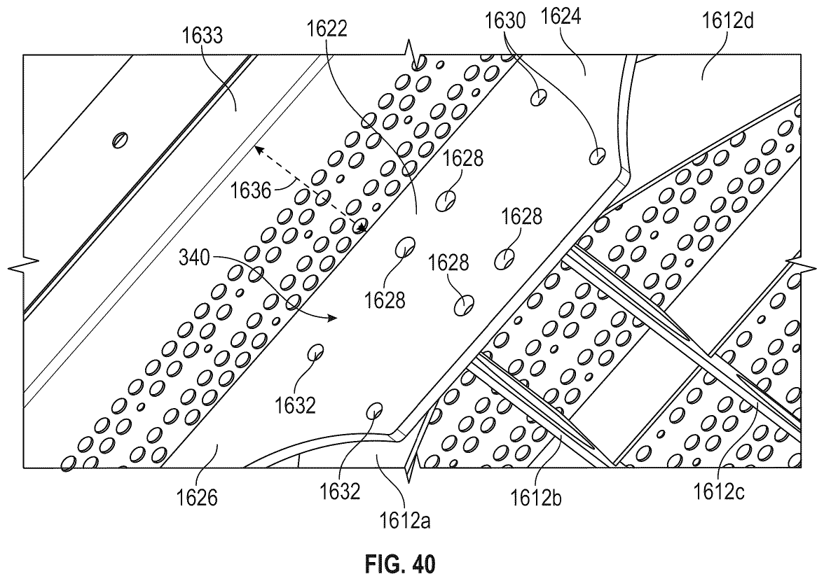

Referring now to FIG. 40 the load cell brace 304 includes a center mounting section 1622. Extending from a left side of the center mounting section 1622 (as view from the front 62 of the lift device 10) is a left wing 1624. Extending from a right side of the center mounting section 1622 opposite the left wing 1624 is a right wing 1626. The left wing 1624 and the right wing 1626 extend laterally away from the center mounting section 1622 to the lateral edges of the platform assembly 16, and support the deck 18. Extending from front of the load cell brace 304 are the support beams 1612a-1612d. The support beams 1612a-1612d may be bolted, welded, or otherwise secured to the load cell brace 304. The center mounting section 1622 includes a plurality of mounting holes, shown as the center apertures 1628. There are four center apertures 1628 arranged in a rectangular formation, however there may be more or fewer apertures 1628 and they may be arranged in other patterns. In the left wing 1624 are a plurality of apertures or mounting holes, shown as left mounting holes 1630, and opposite the left mounting holes 1630 in the right wing 1626 are a plurality of right mounting holes 1632. The four center apertures 1628, left mounting holes 1630, and plurality of right mounting holes 1632 of the load cell brace 304 coupled to the load cell 1502 and the platform mount 66 to thereby couple the platform assembly 16 to the lift assembly 14. The load cell brace 304 is offset from the rear 1633 of the deck 18 of the platform assembly 16 by a cantilever distance 1636. The cantilever distance 1636 indicates the amount of the deck 18 of the platform assembly 16 which overhangs the load cell 1502 when the platform assembly 16 is coupled to the lift assembly 14. The cantilever distance 1636 is measured from the rear face 1660 of the load cell brace 304 to the rearmost edge of the deck 18.

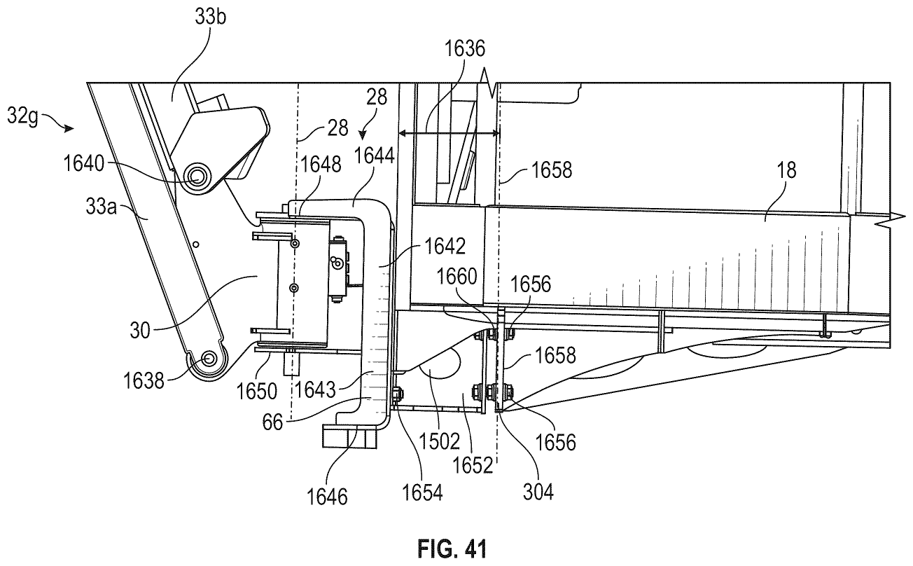

Referring now to FIG. 41, the platform assembly 16 is shown coupled to the jib assembly 32g of the lift assembly 14. The links 33a and 33b of the jib assembly 32g are coupled at an end to the platform rotator 30. Specifically, the link 33a is coupled at pivot point 1638 to a bottom of the platform rotator 30 and the link 33b is coupled at pivot point 1640 to a top of the platform rotator 30. The platform rotator 30 is rotatably coupled to the platform mount 66, and configured to rotate the platform mount 66 about the axis 28. The platform mount 66 includes a center vertical potion shown as the riser 1642. At a first end of the riser 1642 is an upper flange 1644. The upper flange 1644 is approximately perpendicular to the riser 1642 and extends longitudinally rearwards towards the jib assembly 32g. At a second end of the riser 1642 opposite the first end is a lower flange 1646. The lower flange 1646 is approximately perpendicular to the riser 1642 and is substantially parallel to the upper flange 1644. The lower flange 1646 extends longitudinally rearward towards the jib assembly 32g. Between the upper flange 1644 and the lower flange 1646 is a medial flange 1650. The medial flange is approximately perpendicular to the riser 1642 and is substantially parallel to the upper flange 1644 and the lower flange 1646. The medial flange 1650 extends longitudinally rearwards towards the jib assembly 32g. The platform rotator 30 is rotatably coupled to the platform mount 66 via a mounting plate 1648 of the upper flange 1644 and the medial flange 1650. In some embodiments, the edges of the platform mount 66 extend perpendicular to the main faces of the platform mount 66 to strengthen the platform mount 66 against bending.

At a load cell mounting point 1643 of the platform mount 66 a load cell support 1652 is coupled to the platform mount 66. The load cell support 1652 is coupled to the platform mount 66 at a first end (i.e., a rear end) via a plurality of fasteners, shown as fasteners 1654. In some embodiments, the fasteners 1654 include pairs of bolts and nuts to releasably secure the load cell support 1652 to the platform mount 66. The load cell support 1652 at least partially surrounds the load cell 1502. At a second end of the load cell support 1652 opposite the first end (i.e., a front end) the load cell support 1652 is coupled to the load cell brace 304 by a plurality of fasteners, shown as fasteners 1656. The load cell support 1652 is coupled to the load cell brace 304 within a plane defined by the front face 1658. The front face 1658 is substantially parallel with the lateral axis 80 and extends laterally across the platform assembly 16. The cantilevered distance 1636 is the distance between the rearmost edge of the deck 18 and the front face 1658. When mounted, the rearmost edge of the platform assembly 16 is substantially adjacent the riser 1642 of the platform mount 66 and is cantilevered over the load cell support 1652. As the platform assembly 16 is coupled to the load cell support 1652 at the front face 1658, the portion of the platform assembly 16 that extends rearwards (i.e. towards the jib assembly 32g) of the front face 1658 is not in direct contact with the platform mount 66 and is instead cantilevered over the load cell support 1652 of the platform mount 66. In some embodiments, the controller 38 is provided the distance 1636 indicating how much of the platform assembly 16 extends rearwards of the front face 1658 so the remote device 308 can accurately determine the moment caused by the cantilevered portion of the platform assembly 16 and account for that moment in the load calculation. In some embodiments, the load calculation is therefore based on the cantilever distance 1636, which can be predetermined and saved memory of the controller 38 or provided to the controller 38 by a user via a user input.

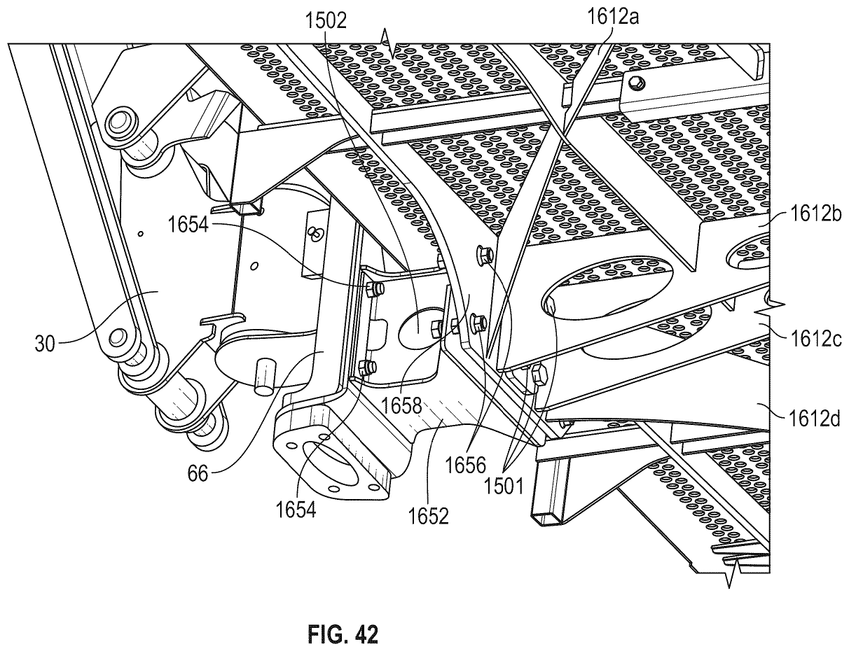

Referring now to FIG. 42, the front face 1658 of the load cell brace 304 is shown with a plurality of fasteners 1656 extending through the load cell brace 304 to couple the platform assembly 16 to the lift assembly 14. Laterally between the support beam 1612b and the support beam 1612c are positioned a first plurality of load cell fasteners 1601. The load cell fasteners 1601 directly couple the load cell 1502 to the load cell brace 304 such that the 1502 bears the weight of the platform assembly 16. In this way, the load or weight of the platform assembly 16 is carried by the load cell 1502 and thereby the load cell 1502 can sense the load on the platform assembly 16.

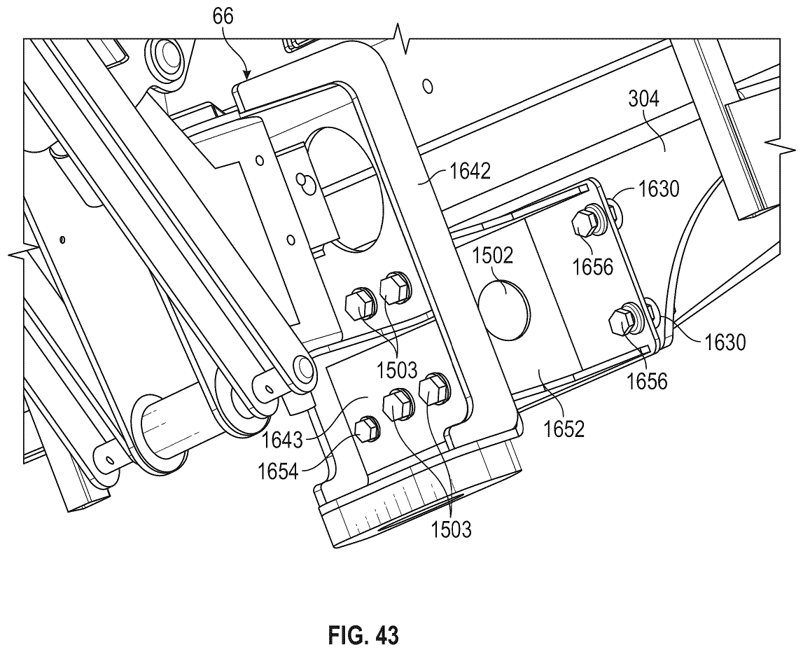

Referring now to FIG. 43, opposite the first plurality of load cell fasteners 1501 of the load cell 1502 are a second plurality of load cell fasteners 1503. The second plurality of load cell fasteners 1503 couples the load cell 1502 to the riser 1642 of the platform mount 66 at the load cell mounting point 1643. The first plurality of load cell fasteners 1501 and the second plurality of load cell fasteners 1503 directly couple the platform mount 66 and the load cell brace 304, and are configured such that in normal operation the load cell 1502 bears the entire load or weight of the platform assembly 16. The load cell 1502 may be any type of load cell such as a bending beam load cell. The second plurality of load cell fasteners 1503 each include strain gauges to measures the load of the platform assembly 16. In some embodiments the first plurality of load cell fasteners 1501 additionally and/or alternatively includes strain gauges to measure the load on the platform assembly 16.

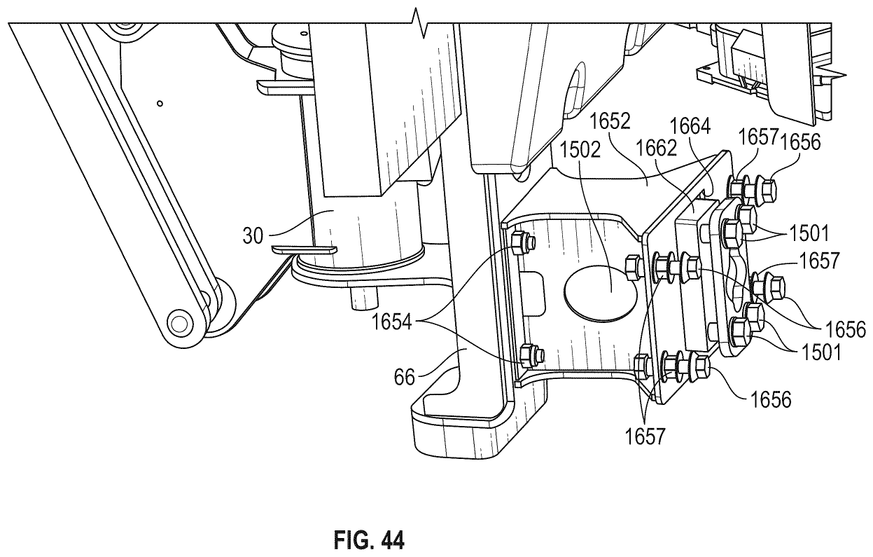

Referring now to FIG. 44 a front of the load cell 1502 is shown uncoupled from the load cell brace 304. The first plurality of load cell fasteners 1501 extend from the front of the load cell 1502 laterally between the pair of fasteners 1656. A front portion 1662 of the load cell 1502 extends through an opening 1664 in the front of the load cell support 1652 and is coupled to the first plurality of load cell fasteners 1501. Each of the fasteners 1656 also include a spacer or seal, shown as spacer 1657, adjacent the front of the load cell support 1652. The spacers 1657 and the front portion 1662 reduces the amount of surface area that is in contact between the load cell brace 304 and the load cell support 1652 when coupled together. The resulting gap between the load cell brace 304 and the load cell support 1652 and reduction in surface area ensures that the load forces are transferred through the first plurality of load cell fasteners 1501 and not, for example, via friction forces between the load cell brace 304 and the load cell support 1652. The gap may be seen in FIGS. 41-43.

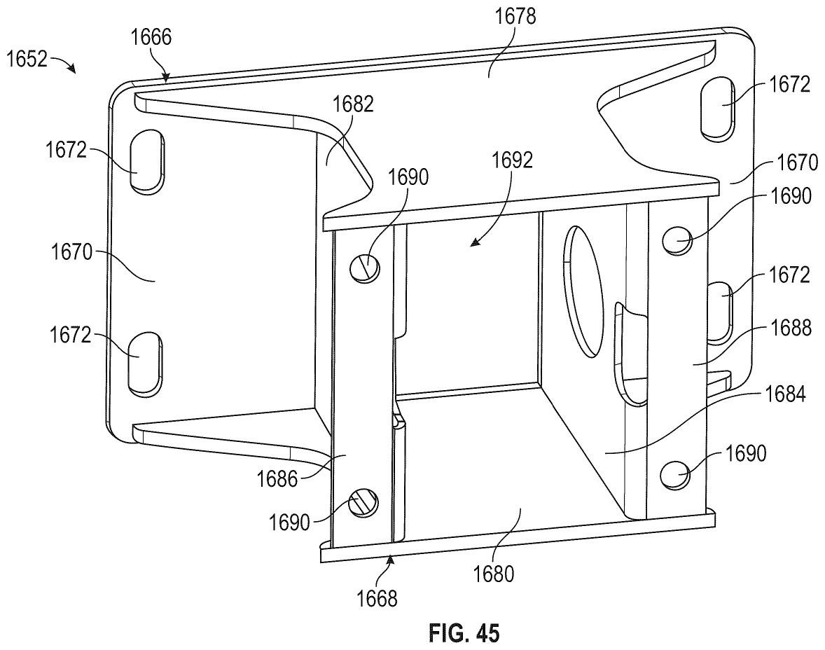

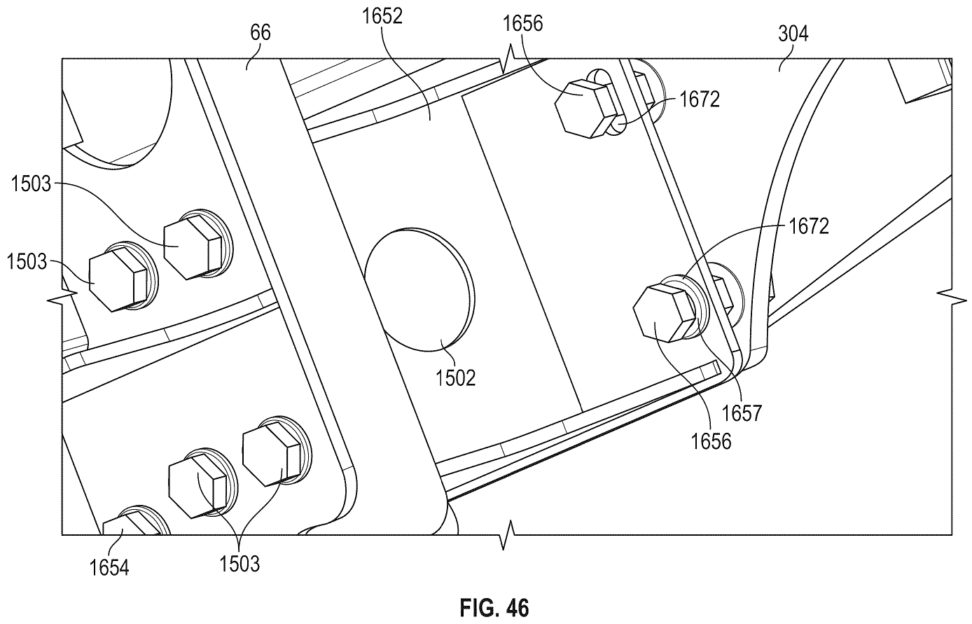

Referring now to FIG. 45, the load cell support 1652 is shown. The load cell support 1652 includes a front face 1666 opposite a rear face 1668. The front face 1666 is longitudinally forwards of the rear face 1668 and engages with the load cell brace 304. At front face 1666 is a front plate 1670 of the load cell support 1652. The front plate 1670 is a substantially flat member extending along a plan parallel to the load cell brace 304 and front face 1658 as shown in FIGS. 9-11. In the front plate 1670 are a plurality of holes or apertures shown as apertures 1672. The apertures 1672 are oblong slots which extend vertically in the directions 46 and 48. The apertures 1672 are configured to receive the fasteners 1656. Referring now to FIG. 46, In normal operation, the fasteners 1656 are secured in positioned but are not tightened enough to bind the front plate 1670 to the load cell brace 304. Rather, the fasteners 1656 can freely translate along the lengths of the apertures 1672. If, during use, the load cell 1502 is no longer able to bear the load applied to the platform assembly 16 the load cell 1502 has failed. For example one or more of the first plurality of load cell fasteners 1501 may be sheared or broken such that they can no longer transfer the weight of the platform assembly 16 through the load cell 1502 and through the second plurality of load cell fasteners 1503 to the platform mount 66. In such cases, the apertures 1672 and fasteners 1656 act as a failsafe to ensure the platform assembly 16 does not separate from the lift assembly 14. When the load cell 1502 fails, the platform assembly 16 begins to fall due to the force of gravity, causing the fasteners 1656 to move downwards within the apertures 1672. At a certain point, the fasteners 1656 engage with the bottoms of the apertures 1672 which inhibits further downward movement of the fasteners 1656, thereby arresting the fall of the platform assembly 16. In some embodiments, one or more spacers or seals shown as spacers 1657 are positioned in the apertures 1672 to fill the excess space apertures 1672 and to cushion the impact between the shafts of the fasteners 1656 and the 1672 in cases where the load cell 1502 fails. While only shown in a single aperture 1672, there may be spacers 1657 in each of the apertures 1672.

Referring again to FIG. 45, extending perpendicularly rearwards from the front plate 1670 are a top plate 1678 and a bottom plate 1680. The top plate 1678 and the bottom plate 1680 are substantially parallel. Extending between the top plate 1678 and the bottom plate 1680 is a left side plate 1684 and opposite the left side plate 1684 a right side plate 1682. Together the top plate 1678, bottom plate 1680, right side plate 1682, and left side plate 1684 define a void 1692 for the load cell 1502. The load cell support 1652 thereby at least partially surrounds the load cell 1502. At the rear face 1668 of the load cell support 1652 are a first flange 1686 and a second flange 1688. Each of the first flange 1686 and the second flange 1688 include a pair of apertures 1690. The apertures 1690 are configured to receive the fasteners 1654 and allow the load cell support 1652 to be releasably coupled to the platform mount 66 as shown in FIG. 44.

In some embodiments, a substructure for a platform assembly of a lift device includes a load cell brace configured to couple to a load cell of the lift device; a plurality of longitudinal members coupled to the load cell brace; one or more tapered support beams coupled to the load cell brace and one or more of the plurality of longitudinal members; and a controls support structure cantilevered upwards from one or more of the plurality of longitudinal members, the controls support structure configured to support a control system of the platform assembly.

In some embodiments of the substructure, the plurality of longitudinal members are perpendicularly coupled to the load cell brace.

In some embodiments of the substructure, at least one of the tapered support beams protrudes from the load cell brace at a substantially 45-degree angle and at least one of the tapered support beams protrudes from the load cell brace at a substantially 90-degree angle.

In some embodiments of the substructure further includes at least one of the tapered support beams protrudes from the load cell brace at a substantially 45-degree angle and at least one of the tapered support beams protrudes from the load cell brace at a substantially 90-degree angle.

In some embodiments a lift device includes a lift assembly; a platform assembly coupled to the lift assembly and including a substructure, the substructure including: one or more lateral members; a plurality of longitudinal members coupled to the one or more lateral members; one or more tapered support beams coupled to the one or more lateral members and the plurality of longitudinal members; and a controls support structure cantilevered upwards from one or more of the plurality of longitudinal members; and a load cell positioned between the lift assembly and the platform assembly, the load cell coupled to the substructure.

In some embodiments of the lift device, the one or more lateral members includes a load cell brace configured to couple to the load cell.

In some embodiments of the lift device, the controls support structure is configured to support a control system of the platform assembly.

In some embodiments a boom lift includes: a chassis; a turntable supported by the chassis and configured to rotate relative to the chassis; a lift assembly coupled to the turntable, wherein the lift assembly includes a first end coupled to the turntable a second end couple to a platform via a load sensing mount, wherein the load sensing mount includes: a first bracket coupled to the lift assembly; a load cell bracket coupled to the first backet; a load cell coupled to the first bracket, wherein the load cell is positioned at least partially within the load cell bracket; and a load cell brace coupled to both the load cell bracket and the load cell, wherein the load cell brace is further coupled to the platform, wherein, in normal operation, a weight of the platform is transferred to the lift assembly entirely through the load cell.

In some embodiments of the boom lift, when the weight of the platform is above a threshold value, the weight of the platform is transferred to the lift assembly entirely through the load cell bracket.

In some embodiments of the boom lift, the load cell bracket includes a plurality of slotted apertures.

In some embodiments of the boom lift, the load cell bracket is coupled to the load cell brace by a plurality of fasteners extending through the plurality of slotted apertures.

In some embodiments of the boom lift, during normal operation the plurality of fasteners are not under tension.

In some embodiments of the boom lift, in normal operation the plurality of fasteners are configured to freely move within the plurality of slotted apertures.

In some embodiments of the boom lift, in normal operation the plurality of fasteners do not transfer the weight of the platform to the lift assembly.

In some embodiments of the boom lift, when the weight of the platform is above a threshold value, the plurality of fasteners move along a length of the plurality of slotted apertures until the plurality of fasteners engage with an end of the plurality of slotted apertures and transfer the weight of the platform to the lift assembly.

In some embodiments of the boom lift, when the weight of the platform is above a threshold value, the plurality of fasteners move along a length of the plurality of slotted apertures until the plurality of fasteners engage with an end of the plurality of slotted apertures and transfer the weight of the platform to the lift assembly.

In some embodiments of the boom lift, when the weight of the platform is above a threshold value, the plurality of fasteners move along a length of the plurality of slotted apertures until the plurality of fasteners engage with an end of the plurality of slotted apertures and transfer the weight of the platform to the lift assembly.

In some embodiments of the boom lift, the coupling between the load cell and the load cell brace is beneath the platform.

In some embodiments of the boom lift, the platform extends over the coupling towards the first bracket, such that at least a portion of the platform is cantilevered over the load cell.

In some embodiments of the boom lift, the platform is cantilevered over the load cell by a distance D, and wherein the controller is further configured to determine the weight of the platform at least partially based on the distance D.

In some embodiments of the boom lift, the distance D is predetermined.

### Removable Platform

Referring generally to the FIGURES, a lift device includes a lift assembly and a platform assembly coupled to the lift assembly. The platform assembly includes a substructure and a platform. The substructure includes a plurality of rails and user interface for the lift device. The platform includes a deck, a plurality of upright supports coupled to the deck, and a railing coupled to the plurality of upright supports. The platform is configured to removably couple to a substructure of the platform assembly. When replacing the platform, the substructure and the user interface remain coupled to the lift device, allowing for the platform to be repair or replaced without needing to remove or adjust the user interface connections.

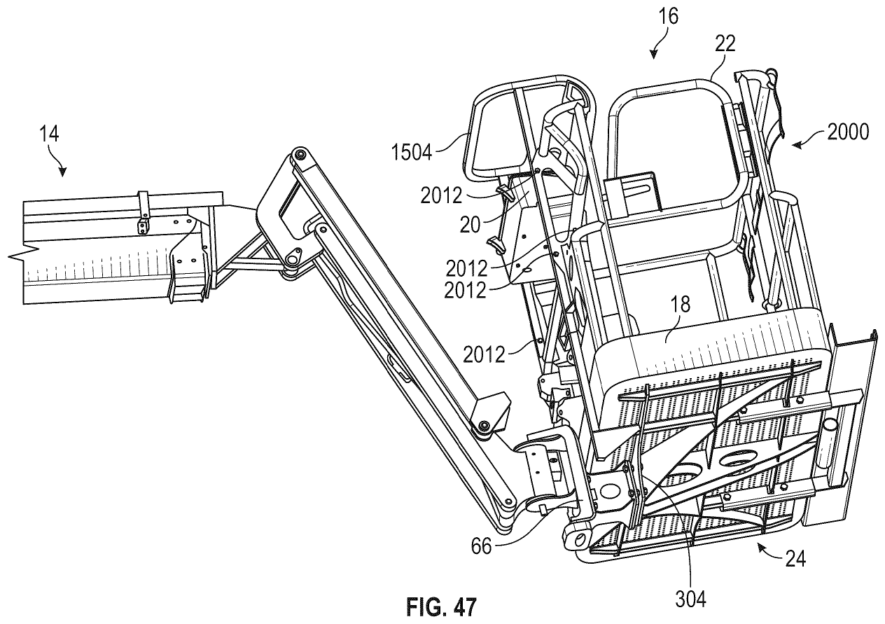

Referring now to FIG. 47, the lift device 10 may include a platform mount 66 to couple the platform assembly 16 to the lift assembly 14. The platform assembly 16 is composed primarily of two components—a substructure 1504 and an platform 2000. The substructure 1504 and the platform 2000 are selectively coupled to each other via a plurality of fasteners 2012. The fasteners 2012 may be bolts, screws, latches, buckles, or any similar fastening device configured to allowed the platform 2000 to be separated from the substructure 1504.

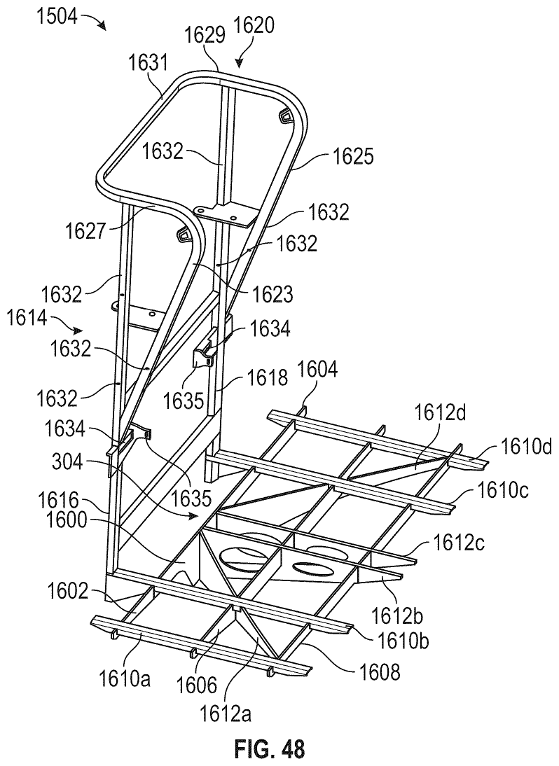

Turning now to FIG. 48, the substructure 1504 is shown according to an embodiment. The substructure 1504 may generally support a platform, for example, including a standing surface, a shelf, a work platform, a floor, the deck 18, a platform railing assembly, guardrails, etc. (e.g., a platform 2000), of the platform assembly 16. Some or all of the components of the substructure 1504 discussed further herein may be bolted together and may be made from aluminum. In general, the components of the substructure 1504 form a cantilevered or L-shape. In other embodiments, the substructure 1504 may be shaped differently.

As shown in FIGS. 5 and 48, the load cell brace 304 may form a central plate 1600 with a first arm 1602 protruding from a first side of the central plate and a second arm 1604 protruding from a second side of the central plate. The load cell brace 304 may be structured as a lateral member extending substantially from a first lateral side of the platform assembly 16 to a second lateral side of the platform assembly 16. Similarly, the substructure 1504 may include a first lateral member 1606 and a second lateral member 1608 extending substantially from the first lateral side of the platform assembly 16 to the second lateral side of the platform assembly 16. The first lateral member 1606 and the second lateral member 1608 may be positioned substantially parallel to the load cell brace 304. The first lateral member 1606 and the second lateral member 1608 may not include a central plate and may instead be configured as a substantially straight beam or a tapered beam. Some embodiments may not include the first lateral member 1606 and/or the second lateral member 1608.

Positioned at intervals along the lengths of and coupled to one or more of the load cell brace 304, the first lateral member 1606, and the second lateral member 1608 may be one or more longitudinal members 1610 such as longitudinal member 1610a, longitudinal member 1610b, longitudinal member 1610c, and longitudinal member 1610d. The longitudinal members 1610 may generally be configured as substantially straight beams extending from a first end of the substructure 1504 to a second end of the substructure 1504 and may perpendicularly intersect one or more of the load cell brace 304, the first lateral member 1606, and the second lateral member 1608. Some embodiments may include a greater or fewer number of the longitudinal members 1610 than shown in FIG. 48.

The substructure 1504 may also include tapering support beams 1612, such as support beam 1612a, support beam 1612b, support beam 1612c, and support beam 1612d. The support beams 1612 may be coupled to the load cell brace 304 on an opposite side of the central plate 1600 relative to the load cell 1502. The support beams 1612 may protrude from the load cell brace 304 at one or more angles. For example, the support beam 1612a and the support beam 1612d may protrude from the load cell brace 304 at approximately 45-degree angles, while the support beam 1612b and the support beam 1612c may protrude from the load cell brace 304 at approximately 90-degree angles. As such, the support beams 1612 may intersect one or more of the first lateral member 1606, the second lateral member 1608, and/or the longitudinal members 1610 at various angles. The support beams 1612 may be configured to taper (e.g., decrease in size) from a portion adjacent to the load cell brace 304 to a distal end of each of the support beams 1612. One or more of the support beams 1612 may also include one or more apertures which may help to decrease the weight of the substructure 1504. In other embodiments, the support beams 1612 may configured or positioned in another manner.

At an end of the substructure 1504 proximate the platform mount 66, the substructure 1504 may include a controls support structure 1614. The controls support structure 1614 may support a control system of the platform assembly 16 such as the user interface 20, and electrical and hydraulic components of the lift device 10. The user interface 20 and the electrical and hydraulic components of the lift device 10 may be coupled to the controls support structure 1614.

The controls support structure 1614 may include a first arm 1616 and a second arm 1618. The first arm 1616 and the second arm 1618 may be coupled to one end of a longitudinal member. For example, the first arm 1616 may be coupled to an end of the longitudinal member 1610b, while the second arm 1618 may be coupled to an end of the longitudinal member 1610c. The first arm 1616 and the second arm 1618 are cantilevered upwards at a substantially 90-degree angle from the longitudinal members 1610. The controls support structure 1614 may include one or more additional components, such as cross bars or other supporting components of the control system of the platform assembly 16, the user interface 20, and/or the electrical and hydraulic components of the lift device 10.

The controls support structure 1614 may also include a railing assembly 1620 (e.g., handles, guardrails, etc.) which wraps around the top of the controls support structure 1614 and may be coupled to the first arm 1616 and the second arm 1618 at one or more points. The railing assembly 1620 may provide a structure for an operator or occupant of the platform assembly 16 to grip the platform assembly 16. The railing assembly 1620 includes an angled support member shown as first angled support 1623 coupled to the first arm 1616. The first angled support 1623 extends upwards and longitudinally forwards from the first arm 1616. The interior angle formed between the first arm 1616 and the first angled support 1623 may an acute angle, such that the first angled support 1623 also extends upwards away from the load cell brace 304. Opposite the first angled support 1623 is a second angled support 1625. The second angled support 1625 is coupled to the second arm 1618 and extends upwards and longitudinally forwards from the second arm 1618. The interior angle formed between the second arm 1618 and the second angled support 1625 is an acute angle, such that the second angled support 1625 extends upwards away from the load cell brace 304.

A top of the first arm 1616 and a top of the first angled support 1623 are coupled by a first lateral rail 1627. The first lateral rail 1627 may continuous with the first angled support 1623 such that the first angled support 1623 bends until it is substantially perpendicular to the first arm 1616. In some embodiments, the first lateral rail 1627 is a discrete component that is attached, such as by welding or other fixing methods. A top of the second arm 1618 and a top of the second angled support 1625 are coupled by a second lateral rail 1629. The second lateral rail 1629 is similar to the first lateral rail 1627. The first lateral rail 1627 and the second lateral rail 1629 are coupled by a center lateral rail 1631. The center lateral rail 1631 extends between the first lateral rail 1627 and the second lateral rail 1629, indirectly coupling the tops of the first arm 1616 and the second arm 1618. The controls support structure 1614 also includes a plurality of holes or apertures, shown as apertures 1632. For example, the first arm 1616 includes two apertures 1632 and the first angled support 1623 includes an aperture 1632 positioned vertically between the two apertures 1632 of the first arm 1616. Similarly, the second arm 1618 includes two apertures 1632 and the second angled support 1625 includes an aperture 1632 positioned vertically between the two apertures 1632 of the second arm 1618. The apertures 1632 are configured to receive a plurality of fasteners to secure the controls support structure 1614 to the platform 2000 as described in greater detail below with reference to FIGS. 42 and 43.

Coupled to the first arm 1616 and the second arm 1618 are a pair of mounting brackets 1634. The mounting brackets 1634 are coupled to the first arm 1616 and the second arm 1618, respectively, vertically below the first angled support 1623 and the second angled support 1625. Each of the mounting brackets 1634 extend laterally inwards towards the other of the first arm 1616 or the second arm 1618. The mounting brackets 1634 include a flange, bend, or tab, shown as flange 1635, which extends longitudinally forward from the mounting brackets 1634. The mounting brackets 1634 are configured to at least partially secure the control unit such as the user interface 20 with the controls support structure 1614.

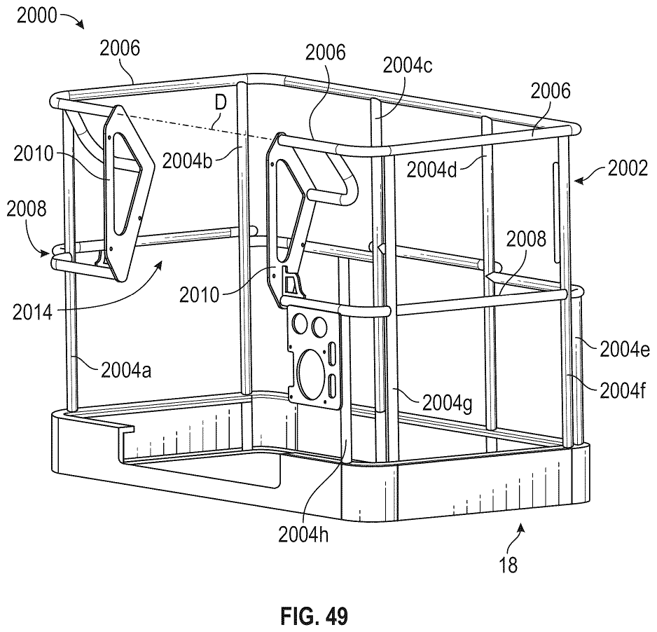

Referring now to FIG. 49, the platform 2000 is shown. The platform 2000 may be made from aluminum and the platform 2000 may be removably coupled to the substructure 1504. For example, the platform 2000 may be coupled to the substructure via one or more bolts, or by another removably coupling manner such that in normal condition the platform 2000 can be removed from the substructure 1504 without damage to either of the substructure 1504 or the platform 2000.

The platform 2000 may include the deck 18 as a base of the platform 2000, upon which an operator or occupant of the platform assembly 16 may be supported. Coupled to a protruding upwards from the deck 18 may be an enclosure 2002 (e.g., rails 22, a railing assembly, handles, guardrails, etc.). The rails 22 of the enclosure 2002 may include a plurality of upright supports 2004, such as upright support 2004a, upright support 2004b, upright support 2004c, upright support 2004d, upright support 2004e, upright support 2004f, upright support 2004g, and upright support 2004h. The upright supports 2004 protrude substantially perpendicularly upwards from the deck 18. One or more of the upright supports 2004 may be configured to support and couple to a door. In some embodiments, the door may be alternatively coupled to the substructure 1504.

Disposed around an upper outer perimeter of the enclosure 2002 may be an upper railing 2006. The upper railing 2006 may be configured to partially enclose the enclosure 2002 and provide a grip or support rail for an operator or occupant of the platform assembly 16 to grasp or lean against. The enclosure 2002 may also include a lower railing 2008 positioned between the deck 18 and the upper railing 2006. The lower railing 2008 may be configured as a series of linked support rail portions intersecting one or more of the upright supports 2004. The lower railing 2008 may provide additional enclosure or support for an operator or occupant of the platform assembly 16. The upper railing 2006 and the lower railing 2008 partially enclose the perimeter of the deck 18. Each of the upper railing 2006 and the lower railing 2008 terminate at an interface 2010. The interfaces 2010 thus define a gap 2014 of width D. The gap 2014 is configured to receive the controls support structure 1614 of the substructure 1504, as shown in FIGS. 5, 47 and 43.

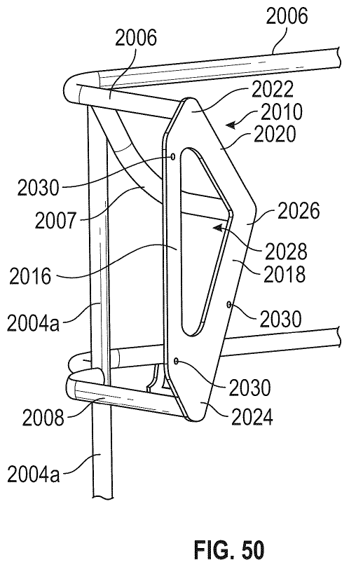

Referring now to FIG. 50, the a close up of the interface 2010. The interface 2010 is shown as flat plate of material such as plate aluminum. The interface 2010 is generally triangular with a first side extending vertically substantially parallel with the upright supports 2004 shown as the first side 2016. The interface 2010 includes a second side 2018 coupled to the first side at nexus 2024. Extending between the first side 2016 and the second side 2018 is a third side 2020. The third side 2020 is coupled to the first side 2016 at the nexus 2022, wherein the angle defined between the first side 2016 and the third side 2020 is less than 90 degrees. The second side 2018 is coupled to the third side 2020 at a nexus 2026, wherein the angle define defined between the second side 2018 and the third side 2020 is greater than 90 degrees. The first side 2016 is coupled to the second side 1018 at the nexus 2024, wherein the angle defined between the first side 2016 and the second side 2018 is less than 90 degrees. The first side 2016, the second side 2018, and the third side 2020 thus form a substantially triangular shaped with a gap 2023 in the middle. The The second side 2018 extends substantially upwards and longitudinal forwards from the nexus 2024 to the nexus 2026.

The interface 2010 is coupled to the rails 22 of the platform 2000 at each of the nexuses 2022, 2024, and 2026. The interface 2010 is coupled at the nexus 2022 to the upper railing 2006, at the nexus 2024 to the lower railing 2008, and at the nexus 2026 to the handle 2007. The handle 2007 extends downwards and longitudinally forwards from the upper railing 2006. While only a single interface 2010, it should understand that in some embodiments the second interface 2010 is arranged in a similar manner. The interface 2010 further includes a plurality of apertures shown as interface apertures 2030. The interface apertures 2030 are positioned to align with apertures 1632 of the substructure 1504 to facilitate the removable coupling of the substructure 1504 to the platform 2000.

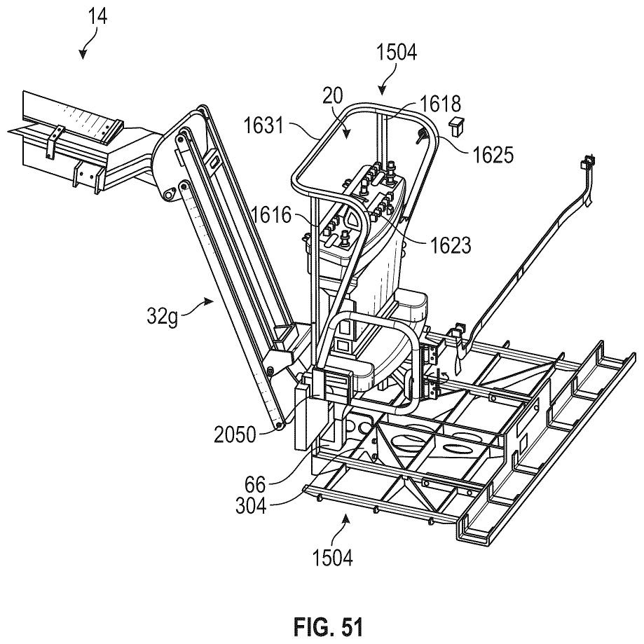

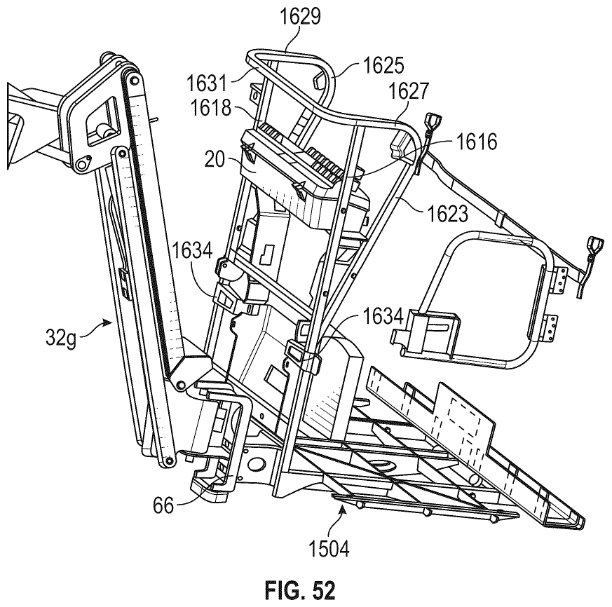

As shown in FIG. 51, the substructure 1504 may be coupled to the lift device 10 independent of the platform 2000. The load cell brace 304 of the substructure 1504 is coupled to the platform mount 66 thereby coupling the substructure 1504 to the lift device 10. The user interface 20 is also coupled to the substructure 1504. The user interface 20 is positioned laterally between the first arm 1616 and the second arm 1618. The foremost point of the first angled support 1623 and the second angled support 1625 extends longitudinally forward of the user interface 20. The first lateral rail 1627, second lateral rail 1629, and center lateral rail 1631 are positioned vertically above the user interface 20. In some embodiments, it may be beneficial to remove the platform 2000 from the platform assembly 16. For example, the platform 2000 may experience wear or damage due to the nature of the use of the platform 2000. The platform 2000 may become dirty, bent, torn, cut, etc. from a high amount of traffic and interaction with and support of people, components, and machines. It may be desirable to replace the platform 2000, but it may not be desirable to replace other components or assemblies of the lift device 10 due to difficulty or cost. As such, the platform 2000 is configured to be removable from the platform assembly 16 and replaceable. The platform 2000 may be entirely replaced, or components of the platform 2000 may be repaired or replaced. In some embodiments, a replacement platform configured for installation in the platform assembly 16 may be provided.

In an embodiment in which the platform 2000 may need to be removed from the platform assembly 16, the platform 2000 may be separated from other components of the lift device 10 such as the substructure 1504, the control system of the platform assembly 16 such as the user interface 20, and the electrical and hydraulic components of the lift device 10. The substructure 1504 may remain coupled to the lift assembly 14, which lowers downtime and cost during repair of the lift device 10. The control system of the platform assembly 16 such as the user interface 20, and the electrical and hydraulic components of the lift device 10, may also remain coupled to the substructure 1504. As such, operation of the control system of the platform assembly 16 and the electrical and hydraulic components of the lift device 10 is not disrupted and the control system of the platform assembly 16 and the electrical and hydraulic components of the lift device 10 may remain connected to the lift device 10.

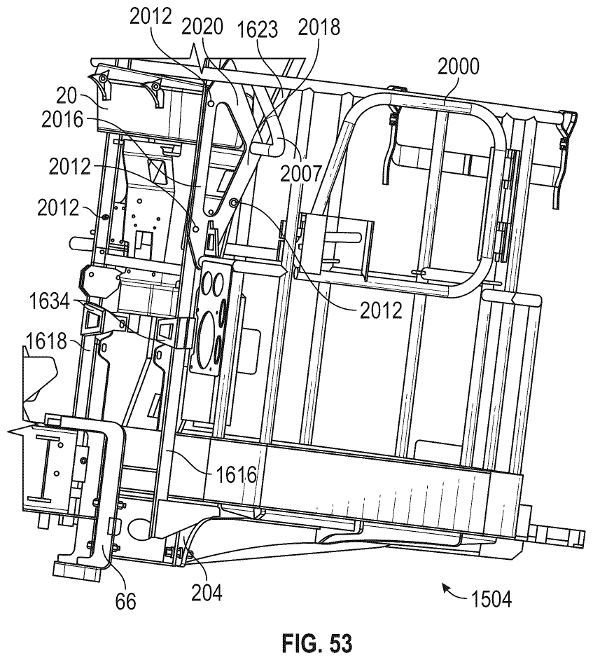

Referring now to FIGS. 42 and 43, the user interface 20 is coupled to the substructure 1504 via the mounting brackets 1634. The mounting brackets 1634 may be bolted, screwed, threaded, or otherwise fastened to the user interface 20. Referring specifically to FIG. 53, the platform 2000 is coupled to the substructure 1504 via the interfaces 2010. Specifically, each of the interfaces 2010 are coupled to the substructure 1504 via the plurality of fasteners 2012. When coupled, the first side 2016 is positioned adjacent the first arm 1616, the second side 2018 is adjacent the first angled support 1623 and the 2020 extends substantially parallel with the handle 2007. The plurality of fasteners 2012 extend through the interface apertures 2030 and the apertures 1632 to releasably couple the substructure 1504 to the platform 2000.

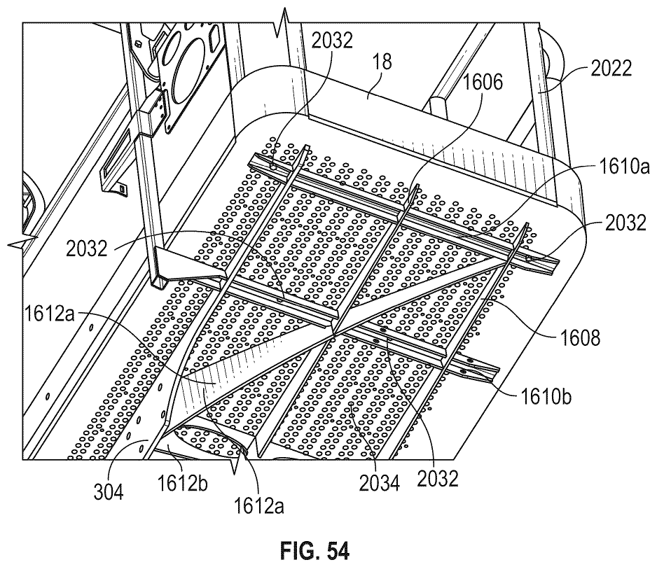

Referring now to FIG. 54, the substructure 1504 is coupled to the deck 18 of the platform 2000 by a plurality of fasteners 2032. The fasteners 2032 may be bolts, screws, or other types of removable fasteners. The fasteners 2032 may engage one or more of the components of the substructure 1504 (e.g., longitudinal members 1610, support beams 1612, first arm 1602, second arm 1604, first lateral member 1606, or second lateral member 1608) to the deck 18 of the platform 2000. The deck 18 may include a plurality of holes 2034 extending through the deck 18. The holes 2034 may extend entirely across, or in some embodiments partially across, the deck 18. In some embodiments, the fasteners 2032 are each configured to engage a hole 2034 to secure the substructure 1504 to the platform 2000.

In some embodiments, a lift device includes a chassis; a turntable coupled to the chassis, wherein the turntable is configured to rotate relative to the chassis; a lift assembly; and a platform assembly removably coupled to the lift assembly, the platform assembly including: a plurality of rails forming a perimeter around the platform assembly; a substructure coupled to the lift assembly via a load cell, wherein the substructure is configure to support a user interface of the lift device and includes a first subset of rails of the plurality of rails to form at least a portion of the perimeter; and a platform removably coupled to the substructure, wherein the platform includes a second subset of rails of the plurality of rails, the first subset of rails and the second subset of rails together forming the plurality of rails around the perimeter of the platform assembly.

In some embodiments of the lift device, the lift device further includes further including the load cell positioned between the lift assembly and the platform assembly.

In some embodiments of the lift device, the lift device further includes one or more interfaces configured to interface with one or more of a control system of the platform assembly, electrical components of the lift device, or hydraulic components of the lift device.

In some embodiments, a method of manufacturing a lift device includes providing a lift assembly; providing a platform assembly including: a user interface; one or more electrical components; one or more hydraulic components; and a platform configured to be removable from the platform assembly and separated from the user interface, the one or more electrical components, and the one or more hydraulic components; and coupling the platform assembly to the lift assembly.

In some embodiments of the method, the method further includes positioning a load cell between the lift assembly and the platform assembly.

In some embodiments of the method, providing a replacement platform configured for installation in the platform assembly.

### Configuration of the Exemplary Embodiments

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the lift device 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A vehicle comprising:
a chassis defining a first side area, a second side area, and a central area between the first side area and the second side area;
a turntable supported by the chassis and configured to rotate relative to the chassis;
a lift apparatus supported by the turntable and configured to raise and lower a platform;
wherein the first side area comprises:
an electric motor coupled to the chassis;
one or more hydraulic pumps, wherein the one or more hydraulic pumps are configured to be driven by the electric motor; and
a hydraulic reservoir fluidly coupled to the one or more hydraulic pumps;
wherein the second side area comprises;
a first charging port coupled to a first charger configured to receive power at a first voltage range;
a second charging port configured to provide power to at least one of the platform or the electric motor;
wherein the central area comprises:
a high-voltage battery, wherein the high-voltage battery is configured to provide power to the electric motor.

2. The vehicle of claim 1, wherein the lift apparatus comprises:
a tower boom coupled to the turntable;
a boom arm coupled to the tower boom and the platform; and
a plurality of actuators configured to adjust a positioned of at least one of the tower boom or the boom arm.

3. The vehicle of claim 1, wherein the chassis comprises a center frame member with a top wall, a bottom wall, a first side wall, and a second side wall, the center frame member defining the central area.

4. The vehicle of claim 3, wherein the first side area extends laterally away from the first side wall and is defined by the first side wall and a first plurality of walls, and wherein the second side area extends laterally away from the second side wall and is defined by the second side wall and a second plurality of walls.

5. The vehicle of claim 3, further comprising a first side aperture in the first side wall connecting the first side area to the center area, wherein a plurality of hydraulic lines extend from the one or more hydraulic pumps in the first side area through the first side aperture and into the central area.

6. The vehicle of claim 4, further comprising at least one of a first side aperture in the first side wall connecting the first side area to the center area or a second side aperture in the second side wall connecting the second side area to the central area.

7. The vehicle of claim 1, wherein the first side area further comprises:
an auxiliary motor coupled to the chassis; and
an auxiliary hydraulic pump, wherein the auxiliary hydraulic pump is configured to be driven by the auxiliary motor.

8. The vehicle of claim 7, wherein the first side area further comprises a low-voltage battery configured to power the auxiliary motor.

9. The vehicle of claim 1, wherein the second side area further comprises a third charging port coupled to a second charger and configured to receive power at a second voltage range, wherein the first voltage range is different than the second voltage range.

10. The vehicle of claim 9, further comprising a filter coupled between at least one of the first charging port and the first charger or the third charging port and the second charger.

11. The vehicle of claim 1, wherein the second side area further comprises a plurality of breakers.

12. The vehicle of claim 1, wherein the central area further comprises a plurality of hydraulic valves coupled to the one or more hydraulic pumps.

13. The vehicle of claim 12, wherein the central area further comprises a dividing wall between the high-voltage battery and the plurality of hydraulic valves.

14. The vehicle of claim 1, wherein the central area further comprises or one or more inverters electrically coupled to the batteries.

15. A vehicle comprising:
a base comprising:
a center frame member defining a central area;
a right side pod coupled to a right side of the center frame member; and
a left side pod coupled to a left side of the center frame member;
a plurality of tractive elements coupled to the base;
a turntable supported by the base and configured to rotate relative to the base; and
a lift apparatus supported by the turntable and configured to raise and lower a platform;
wherein the right side pod comprises:
a first motor;
a first hydraulic pump, wherein the first hydraulic pump is configured to be driven by the first motor; and
a hydraulic reservoir fluidly coupled to the first hydraulic pump;
an second motor; and
a second hydraulic pump, wherein the second hydraulic pump is configured to be driven by the second motor;
wherein the left side pod comprises;
a first charging port coupled to a first charger configured to receive power at a first voltage range;
a second charging port coupled to a second charger configured to receive power at a second voltage range different than the first voltage range;
a second charging port configured to provide power to at least one of the platform, the first motor, or the second motor;
wherein the central area comprises:
a plurality of hydraulic valves coupled to at least one of the first hydraulic pump or the second hydraulic pump.

16. The vehicle of claim 15, wherein the plurality of hydraulic valves are coupled to the at least one of the first hydraulic pump or the second hydraulic pump through a first aperture connecting the central area to the right side pod.

17. The vehicle of claim 15, wherein the central area further comprises a high-voltage electric battery coupled to at least one of the first charger or the second charger.

18. The vehicle of claim 17, wherein the high-voltage electric battery is coupled to the at least one of the first charger or the second charger through a second aperture connecting the central area to the left side pod.

19. The vehicle of claim 15, wherein at least one of the right side pod or the left side pod comprises a removable top wall to provide access to an interior of the at least one of the right side pod or the left side pod.

20. A vehicle comprising:
a chassis defining a first side area, a second side area, and a central area between the first side area and the second side area, wherein the chassis further comprises:
a first aperture connecting the first side area to the central area; and
a second aperture connecting the second side area to the central area;
a turntable supported by the chassis and configured to rotate relative to the chassis;
a lift apparatus supported by the turntable and configured to raise and lower a platform, wherein the lift apparatus comprises:
a tower boom coupled to the turntable;
a boom arm coupled to the tower boom and the platform; and
a plurality of actuators configured to adjust a positioned of at least one of the tower boom or the boom arm;
wherein the first side area comprises:
an electric motor coupled to the chassis;
one or more hydraulic pumps, wherein the one or more hydraulic pumps are configured to be driven by the electric motor;
a hydraulic reservoir fluidly coupled to the one or more hydraulic pumps;
an auxiliary motor coupled to the chassis;
an auxiliary hydraulic pump, wherein the auxiliary hydraulic pump is configured to be driven by the auxiliary motor; and
a low-voltage battery, wherein the low-voltage battery is configured to power the auxiliary motor;
wherein the second side area comprises;
a first charging part coupled to a first charger configured to receive power at a first voltage range;
a second charging port coupled to a second charger configured to receive power at a second voltage range, wherein the first voltage range is different than the second voltage range;
a third charging port configured to provide power via the second aperture to at least one of the platform, the electric motor, or the auxiliary motor;
a filter coupled between at least one of the first charging port and the first charger or the second charging port and the second charger; and
a plurality of breakers configured to trip at a predetermined threshold;
wherein the central area comprises:
a high-voltage battery, wherein the high-voltage battery is configured to provide power via the first aperture to the electric motor;
a plurality of hydraulic valves coupled to at least one of the one or more hydraulic pumps or the auxiliary pumps through the first aperture; and
one or more inverters electrically coupled to the batteries.

21-100. (canceled)
